(19) United States
(12) Patent Application Publication
(10) Pub. No.: US 2001/0053008 A1
(43) Pub. Date: Dec. 20, 2001

(54) Optical pulse generating apparatus and optical signal apparatus using the same

(76) Inventor: Yoshiyasu Ueno, Tokyo (JP)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/793,505

(22) Filed: Feb. 27, 2001

Related U.S. Application Data
(63) Continuation-in-part of application No. 09/653,368, filed on Aug. 31, 2000, now abandoned.

(30) Foreign Application Priority Data
Sep. 1, 1999 (JP) 246843/1999
Dec. 8, 1999 (JP) 348269/1999

(51) Int. Cl. H04B 10/00; H04B 10/12

(52) U.S. Cl. 359/158; 359/173

(57) ABSTRACT

An optical pulse signal generating apparatus include a circular optical waveguide, a first optical combiner, an optical converter, and a first optical splitter. A circulating optical signal can circulate in the circular optical waveguide in a direction. The first optical combiner is provided in the circular optical waveguide and inputs an externally inputted optical signal to combine the externally inputted optical signal and the circulating optical signal in the circular optical waveguide to produce a combination optical signal. The optical converter is provided in the circular optical waveguide and has a semiconductor optical amplifier which amplifies the combination optical signal and emits an amplified optical signal including an amplified spontaneous emission (ASE) optical signal. The optical converter outputs an optical pulse sequence signal from the combination optical signal via the amplified optical signal. The first optical splitter outputs the optical pulse sequence signal from the circular optical waveguide. A portion of the generated optical pulse sequence signal circulates in the circular optical waveguide to reach the first optical combiner, and the generated optical pulse sequence signal finally has a specific pulse width and a specific repetition frequency.

### Background of the Invention

1. Field of the Invention

The present invention generally relates to an optical pulse generation apparatus, and an optical clock apparatus using the same. More specifically, the present invention relates to an optical pulse generation apparatus and an optical clock apparatus and an optical clock which are suitable for very high speed time division multiple optical communication systems.

2. Description of the Related Art

In large-capacity optical communication systems available in near future, time division multiplexed optical signals may be possibly transmitted at the data rate of 160 to 640 Gbps. To realize such very high speed time division multiple optical communications, the optical pulse generation apparatus is necessarily required which can generates very short optical pulse sequence. Such a very short optical pulse has the pulse width of which is shorter than or equal to 10 ps and the wavelength of 1300 to 1700 nm. Also, the optical pulse sequence has the repetitive frequency equal to or higher than 2 GHz.

For instance, in case that the time division multiple optical communication is carried out at the transmission rate of 160 Gbps, the optical pulse generation apparatus is necessarily required which can generate an optical pulse sequence having the pulse width of 1.2 ps and the repetitive frequency of 10 GHz. A digital modulation or a digital coding operation is carried out to a 10-GHz optical pulse sequence having a pulse width of 1.2 ps to generate a 10-Gbps digital signal pulse sequence. Then, when the time division multiplexing is carried out to the digital signal pulse sequences for 16 channels, a 160-Gbps digital signal optical pulse sequence is obtained.

A large number of very short optical pulse generation apparatuses have been proposed in the relevant technical field. As expectable optical pulse generating systems, the following three sorts of optical pulse generating systems and a hybrid techniques thereof are known.

As the first conventional system, there is known an optical pulse generation apparatus utilizing optical pulse compression. In the first conventional system, a semiconductor laser capable of generating continuous laser light and an electro-optic modulator are used, and an optical pulse having the pulse width of approximately 10 ps is generated. In the conventional optical pulse generating system, the optical pulse sequence having the repetitive frequency of about 10 to 20 GHz can be readily generated. Also, in the conventional optical pulse generating system, an optical pulse sequence having the pulse width of 10 ps and the repetition frequency of 20 GHz can be generated when a Q switch semiconductor laser is used.

Next, when an optical pulse sequence is compressed by use of a combination of an optical non-linear medium and a group velocity dispersion medium, an optical pulse sequence can be generated to have the pulse width of 60 fs to 2 ps. As the optical non-linear medium, an optical fiber is used in many cases, and as the group velocity dispersion medium, an optical fiber or a grating is used. The above-described pulse compressing technique is described in, for example, the publication (Jpn. Journal of Applied Physics, volume 35, 1996, pages L1330 to L1332) the publication (Electron. Letter, volume 34, No. 10, 1998, page 1009), and the publication (IEEE photonics Technol. Letters, volume 11, No. 3, 1999, pages 319 to 321).

As the second conventional system, there is a mode locked semiconductor laser. In the second conventional system, an optical pulse sequence is generated by use of a function of an over-saturated absorbing member provided inside the semiconductor laser to have the pulse width shorter than or equal to 2 ps and the repetition frequency equal to or higher than 10 GHz. The above mentioned mode locked semiconductor laser is described in, for example, the publication (IEEE photonics Technology Letters, volume 8, No. 5, 1996, pages 617 to 619) and the publication (Electronics Letters, volume 31, No. 14, 1995, pages 1165 to 1167).

The third conventional system is a mode locked fiber ring laser. In the third conventional system, an optical pulse sequence having the pulse width shorten than or equal to 2 ps and the repetition frequency equal to or higher than 10 GHz is outputted based upon the optical non-linear characteristic and group velocity dispersion of the optical fiber as a portion of an ring laser resonator. The above mentioned mode locked fiber ring laser is described in, for example, the publication (IEEE photonics Technology Letters, volume 11, No. 3, 1999, pages 319 to 321) and the publication (Electronics Letters, volume 35, No. 8, 1999, pages 645 to 646).

Similarly, an optical clock extraction apparatus and an optical clock frequency dividing apparatus are both important for the above described very high speed time division multiple optical communication. The function of the optical clock extraction apparatus is to generate an optical clock signal from a transmitted digital optical signal. The function of the optical clock frequency dividing apparatus is to generate a frequency-divided clock optical pulse sequence from a predetermined clock optical pulse sequence.

The conventional optical clock extraction apparatus and the conventional clock frequency-dividing apparatus are realized by combining a circuit for converting an optical signal into an electric signal, an electronic circuit for extracting a clock signal and frequency division of the clock signal, a circuit for converting an electric signal into an optical signal. This conventional system is referred to as the fourth conventional system.

On the other hand, very recently, as a new system of the optical clock extraction apparatus, one system using a mode locked semiconductor laser have been reported. This system is referred to as the fifth conventional system. The fifth conventional system is described in, for instance, (Technical Digest of the 25th European Conference on Optical Communication (ECOC '99), paper PD3-6, pages 56 to 57, Nice, France, Sep. 26-30, 1999).

Another new optical clock extracting system, which has been recently reported, is described in the publication (Electronics Letters, volume 35, No. 16, 1999, pages 1368 to 1370). This conventional system is referred to as the sixth conventional system. An optical clock extraction apparatus according to. the sixth conventional system is composed of a semiconductor optical amplifier, an optical loop circuit, a continuous-wave light source, and a band-pass wavelength filter. In the optical clock extraction apparatus of the sixth conventional system, effects of an all-optical wavelength converter are utilized, which is composed of the semiconductor optical amplifier, the continuous-wave light source, and a band-pass wavelength filter. In an operation example of the report, a 10-GHz optical clock is extracted from the 10-Gbps digital optical signal (Return-to-Zero signal, pulse width being approximately 25 ps).

In addition, very recently, three optical clock frequency dividing systems have been newly reported. Of these optical clock frequency dividing systems, one system is described in the publication (Optical Communication, volume 157, 1998, pages 45 to 51, (to be referred to as the seventh conventional system hereinafter)), another system is described in the publication (Electronics Letters, volume 35, No. 10, 1999, pages 827 to 829, (to be referred to as the eighth conventional system hereinafter)), and another system is described in the publication (IEEE PTL, volume 11, No. 4, 1999, pages 469 to 471, (to be referred to as the ninth conventional system hereinafter)). These optical clock frequency dividing apparatuses contain so-called “all-optical switch” and loop light circuit, which utilize the semiconductor optical amplifier. However, these optical clock frequency dividing apparatuses do not contain a continuous-wave light source.

The first conventional system has a problem that the optical pulse generation apparatus can be hardly made compact. The optical fiber having the length equal to or longer than 10 m is required to compress the optical pulses in the first conventional system. If the pulse compression is carried out by use of a short optical fiber, an optical pulse waveform would be distorted or an S/N ratio would be deteriorated. In general, when high input power is applied to a pulse compressing apparatus, the length of an optical fiber required for the pulse compressing apparatus can be shortened. In this case, however, a high power optical fiber amplifier is necessarily required. The high power optical fiber amplifier is provided with an Er doped optical fiber having the length equal to or longer than 10 m. As a result, in any of the above described optical pulse generation apparatuses, compactness thereof can be hardly realized.

Also, in order to carry out the electronic-optic modulation and the Q switching operation in the first conventional system, high frequency electric clock signal of 2 to 40 GHz with a high power in a high frequency precision is required to be inputted.

In case of the second conventional system, the following problem occurs at the present time. That is, a long-term stable operation reliability of the mode locked semiconductor laser can not be established. Also, in the second conventional system, the technique for the repetition frequency strictly coincident with a communication signal frequency specification is not established. In addition, the manufacturing methods for stably mass-generating the lasers with the complex structure cannot be established. Furthermore, in order to operate the mode locked semiconductor laser, a high frequency electric clock signal of 2 to 40 GHz is necessary to be inputted with a high power in a high frequency precision.

Similar to the first conventional system, the third conventional system has the problem that the mode locked fiber ring laser apparatus cannot be made compact. In order to give sufficient optical non-linear characteristic to the ring laser resonator, the optical fiber is required to have the length equal to or longer than 10 m. Also, in the third conventional system, the Er doped optical fiber having the length equal to or longer than 10 m is required so as to apply a laser gain to the ring laser resonator. Furthermore, in the third conventional system, the wavelength of the optical pulse is limited based on the gain bandwidth of 1530 to 1560 nm of the Er doped optical fiber. Therefore, there is a limitation in the wavelength multiplexing degree and the optical pulse width. Also, in the third conventional system, another problem is caused that the wider wavelength bandwidth is needed, when the pulse width of the signal optical pulse is narrowed.

Very recently, an optical fiber is coming in practice use, into which a rare earth metal having a gain in a wavelength region different from that of Er has been doped. However, the gain bandwidth of the optical fiber with the rare earth metal doped is narrower than the gain bandwidth of the semiconductor laser. Also, in order to drive the mode locked fiber ring laser, the high frequency electric clock signal of 2 to 40 GHz is required to inputted with a high power in a high frequency precision.

In the fourth conventional system as one of the conventional optical clock extracting/frequency-dividing apparatuses, there are various problems. That is to say, the long time is taken to extract an optical clock signal and to frequency-divide the optical clock signal. The optical clock having the short pulse width can be hardly generated. Also, the optical clock extracting/frequency-dividing apparatus becomes bulky and complex.

In the fifth conventional system as another of the conventional optical clock extraction apparatuses, a long time is necessarily required to extract an optical clock signal and to frequency-divide the optical clock signal. In addition, in the fifth conventional system, there are problems as to the long-term stable operation reliability and the manufacturing technique similar to those of the second conventional system.

In the sixth conventional system as another of the conventional optical clock extraction apparatuses, the direction in which the continuous wave light passes through the semiconductor optical amplifier (SOA) is opposite to the direction in which the optical pulse passes through the semiconductor optical amplifier. That is, a so-called “counter-propagation configuration” is established. As a result, in the fifth conventional system, an optical clock having a short pulse width cannot be generated, and therefore any optical clock having high repetition frequency cannot be generated. Supposing that the time duration required by that the optical pulse passes through the semiconductor optical amplifier is defined as “Ttr”, the optical clock extraction apparatus of the sixth conventional can hardly generate the optical pulse having a pulse width shorter than “Ttr.” In accordance with the report on the sixth conventional system using the semiconductor optical amplifier having the length of approximately 800 micrometers, the time duration is Ttr=8 ps. As a result, even when the optical clock signal having the pulse width of 25 ps and the repetition frequency of 10 GHz can be generated, the conventional optical clock extraction apparatus can hardly generate the optical pulse whose repetition frequency becomes equal to or higher than 100 GHz, (namely, the optical pulse width<2 ps).

Also, in the sixth conventional system, the optical pulse which has a better pulse quality and is approximated to the Fourier transformation limit can be hardly generated in a higher efficiency. In order to generate the optical pulse close to the Fourier transformation limit, the bandwidth of the band pass wavelength filter provided inside the optical clock extraction apparatus must be made narrow. However, when the bandwidth of the band pass wavelength filter is made narrow, the optical pulse generating efficiency, namely, transmission ratio in the all-optical switch is decreased. For this reason, when the bandwidth of the band pass wavelength filter is widened so as to improve the generating efficiency, the optical pulse would be shift from the Fourier transformation limit. This is because mutual phase modulation and mutual gain modulation are simultaneously carried out to the spectrum of the continuous wave light by the semiconductor optical amplifier so that chirping is caused over the wide spectrum range.

Similar to the sixth conventional system, in the seventh conventional system, two kinds of optical pulses, namely, input optical pulse and frequency divided clock pulse pass through the semiconductor optical amplifier in the opposing directions. That is, counter-propagation configuration is established. As a result, the high speed or high repetition frequency optical clock signal has a narrow pulse interval and cannot be processed. In the seventh conventional system, there is the limitation that the input optical clock signal to be frequency-divided must has the pulse interval sufficiently longer than the time duration during which the optical clock passes through the semiconductor optical amplifier. Also, in the seventh conventional system, a jitter component (phase noise) contained in each of the optical pulses of the input clock optical pulse sequence can not be removed. Furthermore, as apparent from the description of the above mentioned publication, in the seventh conventional system, the frequency division ratio is not limited to “2”. There is no description about the generation of the clock signal with the frequency division ratio equal to or more than 3. In addition, as described in the publication (IEEE PTL, volume 11, No. 4, 1999, pages 469 to 471), the frequency-dividing operation strongly depends upon the polarization orientation of the input optical signal.

Also, the eighth conventional system has no effect to remove a jitter component (phase noise) contained in each of the optical pulses of the input clock optical pulse sequence. Also, in the eighth conventional system, a clock signal having the frequency dividing ratio equal to or larger than to “3” can not be generated. Since the apparatus of the eighth conventional system is provided with a polarizer, the frequency-dividing operation strongly depends upon a polarization orientation of the input optical signal.

Similar to the seventh conventional system, the ninth conventional system can not process the high speed optical clock signal having a narrow interval or a high repetition frequency. Also, the ninth conventional system has the problem that this system has no effect to remove a jitter component (phase noise) contained in each of the optical pulses of the input clock optical pulse sequence. Furthermore, the clock having the frequency division ratio equal to or larger than “3” can not be generated. Also, similar to the clock extracting apparatus of the sixth conventional, the ninth conventional system has the trade-off relationship between the Fourier transformation limit characteristic and the efficiency. Therefore, the clock extracting apparatus of the ninth conventional system can hardly generate in a high efficiency, the better quality optical clock pulse signal which is approximated to the Fourier transformation limit. The spectrum of the frequency-divided clock pulse generated in the ninth conventional system chirps over the wide spectrum rage due to the self-phase modulation and the self-gain modulation received from the semiconductor optical amplifier. Similar to the sixth conventional system, it is necessary to make the band of the band pass wavelength filter narrow for the production of the better quality optical clock pulse signal near the Fourier transformation limit. In this case, when the bandwidth of the band pass wavelength filter is made narrow, the operation efficiency is decreased, whereas when the bandwidth of the band pass wavelength filter is made wide, the Fourier transformation limit characteristic of the frequency clock pulse signal is deteriorated.

In conjunction with the above description, a laser pulse oscillator is disclosed in Japanese Laid Open Patent Application (JP-A-Heisei 10-65249). In this reference, the laser pulse oscillator generates an optical pulse sequence having a high repetition frequency by a high harmonic mode synchronizing method. The bandwidth of an optical filter in a laser resonator is sufficiently wider than the bandwidth of the pulses generated from the laser. Also, the wavelength variance characteristic of a normal variance which is sufficiently strong is given in the inside of the laser resonator. A rare earth element added optical fiber B1, a light strength modulator B6 to which a modulation signal applying apparatus B8 is connected, a light branching B4 for taking out light, and an excitation light source B2 which excites a portion of the optical fiber are arranged in the laser resonator. The power of the light passing through the optical fiber is self-phase-modulated in the optical fiber. The wavelength variance of the optical fiber has a sufficiently high normal dispersion to the light passing through the optical fiber. An optical path length changing apparatus B7 is inserted in the laser resonator.

Also, a mode synchronous optical fiber laser apparatus is disclosed in Japanese Patent No. 2772360. In this reference, the mode synchronous optical fiber laser apparatus is composed of light modulating means for modulating a loss or phase of a light signal with a signal with a predetermined frequency, light amplifying means for amplifying the modulated optical pulse, light branching means for taking out said optical pulse, and an optical fiber which combines the above means with each other, to form a ring type optical resonator. The mode synchronous optical fiber laser apparatus contains means for giving the light amplifying means excitation light or an excitation electric current periodically. The light modulating means and the light amplifying means are formed of single light modulating and applying means. Moreover, all of the light modulating and amplifying means, the light branching means and the optical fiber have polarization dependence. Also, they are combined such that their optical main axes are coincident with each other. Here, all of the light modulating and amplifying means, the light branching means and the optical fiber may have no polarization dependence.

### SUMMARY OF THE INVENTION

Therefore, an object of the present invention is to provide a compact optical pulse generation apparatus having a wide wavelength bandwidth.

Another object of the present invention is to provide an optical pulse generation apparatus having long-term stable operation reliability.

Still another object of the present invention is to provide an optical pulse generation apparatus having suitable for a mass production method.

Yet still another object of the present invention is to provide an optical pulse generation apparatus, in which the required power of a high frequency electric signal clock signal to be inputted is relatively low.

It is an object of the present invention is to provide an optical clock extraction apparatus, which can generate in a high speed an optical clock pulse with a shorter pulse width and the high repetition frequency.

Another object of the present invention is to provide an optical clock extraction apparatus, which can generate an optical clock pulse signal approximated to the Fourier transformation limit in a high speed.

Still another object of the present invention is to provide an optical clock frequency dividing apparatus, which can remove a jitter component of an input optical clock signal.

Yet still another object of the present invention is to provide an optical clock frequency dividing apparatus, which can process a high speed optical clock signal at a high speed.

It is an object of the present invention is to provide an optical clock frequency dividing apparatus, which can carry out a frequency dividing operation in an optional frequency division ratio.

Another object of the present invention is to provide an optical clock frequency dividing apparatus, which can generate an optical clock signal approximated to the Fourier transformation limit in a high efficiency.

Still another object of the present invention is to provide an optical clock signal/extracting and frequency dividing apparatus, which can carry out an extracting operation and a frequency-dividing operation at a time.

In order to achieve an aspect of the present invention, an optical pulse signal generation apparatus include a circular optical waveguide, a first optical combiner, an optical converter, and a first optical splitter. A circulating optical signal can circulate in the circular optical waveguide in a direction. The first optical combiner is provided in the circular optical waveguide and inputs an externally inputted optical signal to combine the externally inputted optical signal and the circulating optical signal in the circular optical waveguide to produce a combination optical signal. The optical converter is provided in the circular optical waveguide and has a semiconductor optical amplifier which amplifies the combination optical signal and emits an amplified optical signal including an amplified spontaneous emission (ASE) optical signal. The optical converter outputs an optical pulse sequence signal from the combination optical signal via the amplified optical signal. The first optical splitter outputs the optical pulse sequence signal from the circular optical waveguide. A portion of the generated optical pulse sequence signal circulates in the circular optical waveguide to reach the first optical combiner, and the generated optical pulse sequence signal finally has a specific pulse width and a specific repetition frequency.

Here, the optical pulse signal generation apparatus may further include a continuous wave light source generating a continuous wave optical signal, and an optical signal supplying unit which polarizes the continuous wave optical signal and supplies the polarized continuous wave optical signal as the input optical signal to the first optical combiner. In this case, the optical pulse signal generation apparatus may further include a removing unit provided in the circular optical waveguide and removing a remaining portion of the generated optical pulse sequence signal other than the portion. Also, the remaining portion has a polarization direction orthogonal to a polarization direction of the polarized continuous wave optical signal outputted from the optical signal supplying unit.

Also, the optical converter may include the semiconductor optical amplifier, a first delay interferometer generating the optical pulse signal from the amplified optical signal outputted from the semiconductor optical amplifier, and a first optical filter filtering the optical pulse signal to generate the optical pulse sequence signal. In this case, the first delay interferometer is given a predetermined initial phase bias and accomplishes an optical phase adjusting function using the initial phase bias. In this case, the first optical filter removes the ASE optical signal to determine a center wavelength and width of a transmission spectrum of the optical pulse sequence signal such that the optical pulse sequence signal is outputted.

Also, the semiconductor optical amplifier may carry out phase modulation and intensity modulation to the combination optical signal.

Also, the first delay interferometer passes the amplified optical signal for a time period from when an optical component with a smaller delay of the amplified optical signal starts to rise to when anther optical component with a larger delay thereof starts to fall, to generate the optical pulse signal.

Also, the optical pulse signal generation apparatus may further include a time delay provided in the circular optical waveguide after the optical converter in the direction to adjust a circulating time of the circulating optical signal.

Also, the optical pulse signal generation apparatus may further include a second delay interferometer provided in the circular optical waveguide after the optical converter in the direction to uniformly distribute power of the optical pulse sequence signal between optical pulses, and to control a time interval between the optical pulses.

Also, an amplification of the semiconductor optical amplifier may be larger than an optical circulation loss in the circular optical waveguide. In this case, the optical pulse signal generation apparatus may further include an optical attenuator attenuating the optical pulse sequence signal such that the amplification of the semiconductor optical amplifier is equal to a sum of an attenuation by the optical attenuator and the optical circulation loss. Instead, an amplification of the semiconductor optical amplifier may be smaller than an optical circulation loss in the circular optical waveguide. In this case, the optical pulse signal generation apparatus may further include an optical amplifier having an amplification and provided in the circular optical waveguide, a sum of the amplification of the semiconductor optical amplifier and the amplification of the optical amplifier is larger than the optical circulation loss, and an optical attenuator attenuating the optical pulse sequence signal such that the sum of the amplification of the semiconductor optical amplifier and the amplification of the optical amplifier is equal to a sum of an attenuation by the optical attenuator and the optical circulation loss.

In the above, the optical pulse signal generation apparatus may further include an original signal optical combiner provided in the circular optical waveguide and combining an original optical signal to the circulating optical signal.

In this case, the optical pulse sequence signal outputted from the first optical splitter desirably has a same frequency as a frequency of the original optical signal.

Also, the optical converter may include the first delay interferometer provided in the circular optical waveguide and generating the optical pulse signal from the amplified optical signal outputted from the semiconductor optical amplifier, and the first delay interferometer has a delay time an integral times more than the frequency of the original optical signal. In this case, the optical pulse signal generation apparatus may further include the second delay interferometer provided in the circular optical waveguide to uniformly distribute power of the optical pulse sequence signal between optical pulses, and to control a time interval between the optical pulses, and the second delay interferometer has a delay time the integral times more than the frequency of the original optical signal.

In order to achieve another aspect of the present invention, an optical pulse signal generation apparatus includes a circular optical waveguide, a first optical combiner, a first optical converter, a first optical splitter, a second optical combiner, a second optical converter, and a second optical splitter. A traveling optical signal can circulate in the circular optical waveguide in a direction. The first optical combiner is provided in the circular optical waveguide and inputs a first externally inputted optical signal to combine the first externally inputted optical signal and a first optical pulse sequence signal as the traveling optical signal in the circular optical waveguide to produce a first combination optical signal. The first optical converter is provided in the circular optical waveguide and converts the first combination optical signal into a second optical pulse sequence signal with a first wavelength. The first optical splitter is provided in the circular optical waveguide and outputs the second optical pulse sequence signal from the circular optical waveguide. The second optical combiner is provided in the circular optical waveguide and combines a second externally inputted optical signal and the second optical pulse sequence signal as the traveling optical signal in the circular optical waveguide to produce a second combination optical signal. The second optical converter is provided in the circular optical waveguide and converts the second combination optical signal into the first optical pulse sequence signal with a second wavelength. The second optical splitter is provided in the circular optical waveguide and outputs the first optical pulse sequence signal from the circular optical waveguide.

In this case, the first optical converter may include a first semiconductor optical amplifier which amplifies the first combination optical signal and emits a first amplified optical signal including a first amplified spontaneous emission (ASE) optical signal. The first optical converter outputs the second optical pulse sequence signal from the first combination optical signal via the first amplified optical signal. The second optical converter may include a second semiconductor optical amplifier which amplifies the second combination optical signal and emits a second amplified optical signal including a second amplified spontaneous emission (ASE) optical signal, The second optical converter outputs the first optical pulse sequence signal from the second combination optical signal via the second amplified optical signal.

Also, the optical pulse signal generation apparatus may further include a first continuous wave light source generating a first continuous wave optical signal to supply to the first optical combiner as the first externally inputted optical signal, and a second continuous wave light source generating a second continuous wave optical signal to supply to the second optical combiner as the second externally inputted optical signal.

Also, the first optical converter may include the first semiconductor optical amplifier, a first delay interferometer generating a first optical pulse signal from the first amplified optical signal outputted from the first semiconductor optical amplifier, and a first optical filter filtering the first optical pulse signal to generate the second optical pulse sequence signal. Also, the second optical converter may include the second semiconductor optical amplifier, a second delay interferometer generating a second optical pulse signal from the second amplified optical signal outputted from the second semiconductor optical amplifier, and a second optical filter filtering the second optical pulse signal to generate the first optical pulse sequence signal.

Also, the first semiconductor optical amplifier may carry out phase modulation and intensity modulation to the first combination optical signal. The second semiconductor optical amplifier may carry out phase modulation and intensity modulation to the second combination optical signal.

Also, the first and second delay interferometers are given predetermined initial phase biases and accomplish optical phase adjusting functions using the initial phase biases, respectively.

Also, the first optical filter removes the first ASE optical signal from the second optical pulse sequence signal to determine the first wavelength and a width of a transmission spectrum of the second optical pulse sequence signal. Also, the second optical filter removes the second ASE optical signal from the first optical pulse sequence signal to determine the second wavelength and a width of a transmission spectrum of the first optical pulse sequence signal.

Also, the optical pulse signal generation apparatus may further include a time delay provided in the circular optical waveguide to adjust a circulating time of the traveling optical signal.

Also, a sum of amplifications of the first and second semiconductor optical amplifiers may be larger than an optical circulation loss in the circular optical waveguide. At this time, the optical pulse signal generation apparatus may further include an optical attenuator attenuating the fist or second optical pulse sequence signal such that the sum of the amplifications of the first and second semiconductor optical amplifiers is equal to a sum of an attenuation by the optical attenuator and the optical circulation loss.

Also, a sum of amplifications of the first and second semiconductor optical amplifiers is smaller than an optical circulation loss in the circular optical waveguide. In this case, the optical pulse signal generation apparatus may further include an optical amplifier having an amplification and provided in the circular optical waveguide, a sum of the sum of the amplifications of the first and second semiconductor optical amplifiers and the amplification of the optical amplifier is larger than the optical circulation loss, and an optical attenuator attenuating the first or second optical pulse sequence signal such that the sum of the amplification of the semiconductor optical amplifier and the amplification of the optical amplifier is equal to a sum of an attenuation by the optical attenuator and the optical circulation loss.

Also, the optical pulse signal generation apparatus may further include an original signal optical combiner provided in the circular optical waveguide and combining an original optical signal to the circulating optical signal. In this case, the second optical pulse sequence signal outputted from the first optical splitter has a same frequency as a frequency of the original optical signal, and the first optical pulse sequence signal outputted from the second optical splitter has the same frequency as the frequency of the original optical signal. Also, the first optical converter may include the first delay interferometer provided in the circular optical waveguide and generating the first optical pulse signal from the first amplified optical signal outputted from the first semiconductor optical amplifier. The first delay interferometer has a delay time integral times more than a frequency of the original optical signal. The second optical converter may include the second delay interferometer provided in the circular optical waveguide and generating the second optical pulse signal from the second amplified optical signal outputted from the second semiconductor optical amplifier. The second delay interferometer has a delay time the integral times more than the frequency of the original optical signal.

Also, the optical pulse signal generation apparatus may further include an original signal optical combiner combining an original optical signal and the second externally inputted optical signal into a combination optical signal to output the combination optical signal to the second optical combiner in place of the second externally inputted optical signal. In this case, the second optical pulse sequence signal outputted from the first optical splitter has a same frequency as a frequency of the original optical signal. Also, the first optical pulse sequence signal outputted from the second optical splitter has the same frequency as the frequency of the original optical signal.

Also, the first optical converter may include the first delay interferometer provided in the circular optical waveguide and generating the first optical pulse signal from the first amplified optical signal outputted from the first semiconductor optical amplifier. The first delay interferometer has a delay time integral times more than a frequency of the original optical signal. Also, the second optical converter may include the second delay interferometer provided in the circular optical waveguide and generating the second optical pulse signal from the second amplified optical signal outputted from the second semiconductor optical amplifier. The second delay interferometer has a delay time the integral times more than the frequency of the original optical signal.

In order to achieve still another aspect of the present invention, an optical pulse signal generation apparatus may include an optical waveguide, a total reflection mirror, an optical circulator, a first optical filter, a semiconductor optical amplifier, a second optical filter and a delay interferometer. A traveling optical signal can travel in the optical waveguide in either direction. The total reflection mirror is provided at one end of the optical waveguide. The optical circulator is provided at the other end of the optical waveguide, supplies an external input optical signal to the optical waveguide as a first traveling optical signal traveling in a first direction from the optical circulator to the total reflection mirror. Also, the optical circulator outputs an optical pulse sequence signal on the optical waveguide as a second traveling optical signal traveling in a second direction from the total reflection mirror to the optical circulator. The first optical filter passes the first traveling optical signal, and removes an amplified spontaneous emission (ASE) optical signal from the second traveling optical signal to supply to the optical circulator. The semiconductor optical amplifier emits an amplified spontaneous emission (ASE) optical signal, and amplifies the first and second traveling optical signals and outputting amplified optical signals including the ASE optical signals into the first and second directions. The second optical filter passes the second traveling optical signal to the semiconductor optical amplifier, and removes the amplified spontaneous emission (ASE) optical signal from the first traveling optical signal. The delay interferometer generates the optical pulse sequence signal from the first traveling optical signal traveling from the semiconductor optical amplifier in the first direction and the second traveling optical signal traveling from the total reflection mirror in the second direction.

In this case, the optical pulse signal generation apparatus may further include a continuous wave light source generating and supplying a continuous wave optical signal as the external input optical signal to the optical circulator.

Also, the semiconductor optical amplifier carries out phase modulation and intensity modulation to the first and second optical signals.

Also, the delay interferometer is given a predetermined initial phase bias and accomplishes an optical phase adjusting function using the initial phase bias. Also, the delay interferometer passes the first traveling optical signal for a time period from when an optical component with a smaller delay of the first traveling optical signal starts to rise to when anther optical component with a larger delay thereof starts to fall, and passes the second traveling optical signal for a time period from when an optical component with a smaller delay of the second traveling optical signal starts to rise to when anther optical component with a larger delay thereof starts to fall, to generate the optical pulse sequence signal.

Also, the optical pulse signal generation apparatus may further include a time delay provided in the optical waveguide to adjust raveling times of the first and second traveling optical signals.

Also, the optical pulse signal generation apparatus may further include an optical adjusting unit provided between the total reflection mirror and the delay interferometer and adjusting a phase and delay time of the first traveling optical signal.

Also, the optical pulse signal generation apparatus may further include another optical waveguide, an additional total reflection mirror connected to one end of the another optical waveguide, and an optical splitting and combining unit connected to the optical adjusting unit, the another optical waveguide and the delay interferometer, and splitting the first traveling optical signal to two components, which are traveled to the total reflection mirror through the optical adjusting unit and to the additional total reflection mirror, and combining optical signals reflected by the total reflection mirror and the additional total reflection mirror.

Also, the optical pulse signal generation apparatus may further include an original signal optical combiner combining an original optical signal and the external input optical signal to produce a combination optical signal and outputting the combination optical signal to the optical circulator in place of the external input optical signal. In this case, the optical pulse sequence signal outputted from the optical circulator has a same frequency as a frequency of the original optical signal. Also, the delay interferometer has a delay time integral times more than a frequency of the original optical signal.

Also, the optical pulse signal generation apparatus may further include an original signal optical combiner combining an original optical signal into the optical waveguide. In this case, the optical pulse sequence signal outputted from the optical circulator has a same frequency as a frequency of the original optical signal. Also, the delay interferometer has a delay time integral times more than a frequency of the original optical signal.

In order to achieve yet still another aspect of the present invention, an optical pulse signal generation apparatus includes a first optical waveguide, a circular optical waveguide, a semiconductor optical amplifier, a first optical circulator, a first delay interferometer and a first optical filter. A traveling optical signal can travel in the first optical waveguide. A circulating optical signal can circulate in the circular optical waveguide in a direction. The semiconductor optical amplifier is provided in the first optical waveguide and amplifies an input optical signal traveling in a first direction to the circular optical waveguide to emit a first amplified optical signal including an amplified spontaneous emission (ASE) optical signal. Also, the semiconductor optical amplifier amplifies an output optical signal traveling in a second direction from the circular optical waveguide to emit a second amplified optical signal including an amplified spontaneous emission (ASE) optical signal. The first optical circulator is connected to the first optical waveguide and the circular optical waveguide and outputs the first amplified optical signal to the circular optical waveguide as the circulating optical signal and outputting the circulating optical signal to the first optical waveguide as the output optical signal. The first delay interferometer is provided in the circular optical waveguide and generates an optical pulse signal from the circulating optical signal. The first optical filter is provided in the circular optical waveguide and filters the optical pulse signal to generate the optical pulse sequence signal as the circulating optical signal.

In this case, the optical pulse signal generation apparatus may further include a second optical waveguide, a second optical circulator provided in the optical waveguide in the second direction from the semiconductor optical amplifier and connected to the second optical waveguide. The second optical circulator outputs the input optical signal to the semiconductor optical amplifier and the second amplified optical signal to the second optical waveguide, and a second optical filter provided in the second optical waveguide and filtering the second amplified optical signal to produce a first output optical pulse sequence signal. In this case, the second optical filter removes the ASE optical signal from the second amplified optical signal.

Also, the optical pulse signal generation apparatus may further include an optical splitter provided in the circular optical waveguide and outputting the circulating optical signal as a second output optical pulse sequence signal.

Also, the optical pulse signal generation apparatus may further include a continuous wave light source generating a continuous wave optical signal to output to the first optical waveguide.

Also, the semiconductor optical amplifier carries out phase modulation and intensity modulation to the combination optical signal.

Also, the first delay interferometer is given a predetermined initial phase bias and accomplishes an optical phase adjusting function using the initial phase bias.

Also, the first delay interferometer passes the amplified optical signal for a time period from when an optical component with a smaller delay of the amplified optical signal starts to rise to when anther optical component with a larger delay thereof starts to fall, to generate the optical pulse signal.

Also, the first optical filter removes the ASE optical signal from the circulating optical signal.

Also, the optical pulse signal generation apparatus may further include a time delay provided in the circular optical waveguide to adjust a circulating time of the circulating optical signal.

Also, the optical pulse signal generation apparatus may further include a second delay interferometer provided in the circular optical waveguide to uniformly distribute power of the optical pulse sequence signal between optical pulses, and to control a time interval between the optical pulses.

Also, an amplification of the semiconductor optical amplifier is larger than an optical circulation loss in the circular optical waveguide. In this case, the optical pulse signal generation apparatus may further include an optical attenuator attenuating the optical pulse sequence signal such that the amplification of the semiconductor optical amplifier is equal to a sum of an attenuation by the optical attenuator and the optical circulation loss.

Alternatively, an amplification of the semiconductor optical amplifier may be smaller than an optical circulation loss in the circular optical waveguide. In this case, the optical pulse signal generation apparatus may further include an optical amplifier having an amplification and provided in the circular optical waveguide, a sum of the amplification of the semiconductor optical amplifier and the amplification of the optical amplifier is larger than the optical circulation loss, and an optical attenuator attenuating the optical pulse sequence signal such that the sum of the amplification of the semiconductor optical amplifier and the amplification of the optical amplifier is equal to a sum of an attenuation by the optical attenuator and the optical circulation loss.

Also, the optical pulse signal generation apparatus may further include an original signal optical combiner provided in the circular optical waveguide and combining an original optical signal to the circulating optical signal, a second optical waveguide, a second optical circulator provided in the optical waveguide in the second direction from the semiconductor optical amplifier and connected to the second optical waveguide, and a second optical filter provided in the second optical waveguide and filtering the second amplified optical signal to produce a first output optical pulse sequence signal. The second optical circulator outputs the input optical signal to the semiconductor optical amplifier and the second amplified optical signal to the second optical waveguide.

Also, the first output optical pulse sequence signal has a same frequency as a frequency of the original optical signal.

Also, the first delay interferometer has a delay time integral times more than a frequency of the original optical signal.

Also, the when the optical pulse signal generation apparatus includes the second delay interferometer, the second delay interferometer has a delay time the integral times more than the frequency of the original optical signal.

In order to achieve an object of the present invention, an all-optical pulse signal regeneration apparatus includes a delay delaying an input optical pulse signal, an optical pulse signal generating unit generating an optical pulse sequence signal from the input optical pulse signal, and an all-optical gate gating the optical pulse sequence signal using the delayed optical pulse signal as a control signal.

In this case, the optical pulse signal generating unit may include a circular optical waveguide in which a circulating optical signal can circulate in a direction, a first optical combiner provided in the circular optical waveguide and inputting an externally inputted optical signal to combine the externally inputted optical signal and the circulating optical signal in the circular optical waveguide to produce a combination optical signal. The optical pulse signal generating unit may further include an original signal optical combiner provided in the circular optical waveguide and combining the input optical pulse signal as an original optical signal to the circulating optical signal, an optical converter provided in the circular optical waveguide and having a semiconductor optical amplifier which amplifies the combination optical signal and emits an amplified optical signal including an amplified spontaneous emission (ASE) optical signal, and a first optical splitter provided outputting the optical pulse sequence signal from the circular optical waveguide. The optical converter outputs an optical pulse sequence signal from the combination optical signal via the amplified optical signal. A portion of the generated optical pulse sequence signal circulates in the circular optical waveguide to reach the first optical combiner, and the generated optical pulse sequence signal finally has a specific pulse width and a specific repetition frequency. In this case, the optical pulse signal generating unit further may include a continuous wave light source generating a continuous wave optical signal, and an optical signal supplying unit which polarizes the continuous wave optical signal and supplies the polarized continuous wave optical signal as the input optical signal to the first optical combiner. Also, the optical pulse signal generating unit further may include a removing unit provided in the circular optical waveguide and removing a remaining portion of the generated optical pulse sequence signal other than the portion.

Also, the optical pulse signal generating unit may include a circular optical waveguide in which a traveling optical signal can circulate in a direction, and a first optical combiner provided in the circular optical waveguide and inputting a first externally inputted optical signal to combine the first externally inputted optical signal and a first optical pulse sequence signal as the traveling optical signal in the circular optical waveguide to produce a first combination optical signal. The optical pulse signal generating unit may further include an original signal optical combiner provided in the circular optical waveguide and combining the optical pulse signal as an original optical signal into the circulating optical signal, a first optical converter provided in the circular optical waveguide and converting the first combination optical signal into a second optical pulse sequence signal with a first wavelength, a first optical splitter provided in the circular optical waveguide and outputting the second optical pulse sequence signal from the circular optical waveguide. The optical pulse signal generating unit may further include a second optical combiner provided in the circular optical waveguide and combining a second externally inputted optical signal and the second optical pulse sequence signal as the traveling optical signal in the circular optical waveguide to produce a second combination optical signal, a second optical converter provided in the circular optical waveguide and converting the second combination optical signal into the first optical pulse sequence signal with a second wavelength, and a second optical splitter provided in the circular optical waveguide and outputting the first optical pulse sequence signal from the circular optical waveguide, one of the first and second optical pulse sequence signal being outputted as the optical pulse sequence signal.

Also, the optical pulse signal generating unit may include an optical waveguide in which a traveling optical signal can travel in either direction, a total reflection mirror provided at one end of the optical waveguide, an original signal optical combiner combining the optical pulse signal as an original optical signal and an external input optical signal to produce a combination optical signal and outputting the combination optical signal, and an optical circulator provided at the other end of the optical waveguide, supplying the combination optical signal to the optical waveguide as a first traveling optical signal traveling in a first direction from the optical circulator to the total reflection mirror, and outputting the optical pulse sequence signal on the optical waveguide as a second traveling optical signal traveling in a second direction from the total reflection mirror to the optical circulator. The optical pulse signal generating unit may further include a first optical filter passing the first traveling optical signal, and removing an amplified spontaneous emission (ASE) optical signal from the second traveling optical signal to supply to the optical circulator, and a semiconductor optical amplifier emitting an amplified spontaneous emission (ASE) optical signal, and amplifying the first and second traveling optical signals and outputting amplified optical signals including the ASE optical signals into the first and second directions. The optical pulse signal generating unit may further include a second optical filter passing the second traveling optical signal to the semiconductor optical amplifier, and removing the amplified spontaneous emission (ASE) optical signal from the first traveling optical signal, a delay interferometer generating the optical pulse sequence signal from the first traveling optical signal traveling from the semiconductor optical amplifier in the first direction and the second traveling optical signal traveling from the total reflection mirror in the second direction.

Also, the optical pulse signal generating unit may include an optical waveguide in which a traveling optical signal can travel in either direction, a total reflection mirror provided at one end of the optical waveguide, and an original signal optical combiner combining the optical pulse signal as an original optical signal into the optical waveguide. The optical pulse signal generating unit may further include an optical circulator provided at the other end of the optical waveguide, supplying an external input optical signal to the optical waveguide as a first traveling optical signal traveling in a first direction from the optical circulator to the total reflection mirror, and outputting the optical pulse sequence signal on the optical waveguide as a second traveling optical signal traveling in a second direction from the total reflection mirror to the optical circulator, and a first optical filter passing the first traveling optical signal, and removing an amplified spontaneous emission (ASE) optical signal from the second traveling optical signal to supply to the optical circulator. The optical pulse signal generating unit may further include a semiconductor optical amplifier emitting an amplified spontaneous emission (ASE) optical signal, and amplifying the first and second traveling optical signals and outputting amplified optical signals including the ASE optical signals into the first and second directions, a second optical filter passing the second traveling optical signal to the semiconductor optical amplifier, and removing the amplified spontaneous emission (ASE) optical signal from the first traveling optical signal, and a delay interferometer generating the optical pulse sequence signal from the first traveling optical signal traveling from the semiconductor optical amplifier in the first direction and the second traveling optical signal traveling from the total reflection mirror in the second direction.

Also, the optical pulse signal generating unit may include a first optical waveguide in which a traveling optical signal can travel, a circular optical waveguide in which a circulating optical signal can circulate in a direction, and a semiconductor optical amplifier provided in the first optical waveguide and amplifying an input optical signal traveling in a first direction to the circular optical waveguide to emit a first amplified optical signal including an amplified spontaneous emission (ASE) optical signal, and an output optical signal traveling in a second direction from the circular optical waveguide to emit a second amplified optical signal including an amplified spontaneous emission (ASE) optical signal. The optical pulse signal generating unit may further include a first optical circulator connected to the first optical waveguide and the circular optical waveguide and outputting the first amplified optical signal to the circular optical waveguide as the circulating optical signal and outputting the circulating optical signal to the first optical waveguide as the output optical signal, a first delay interferometer provided in the circular optical waveguide and generating an optical pulse signal from the circulating optical signal, and a first optical filter provided in the circular optical waveguide and filtering the optical pulse signal to generate the optical pulse sequence signal as the circulating optical signal. The optical pulse signal generating unit may further include an original signal optical combiner provided in the circular optical waveguide and combining the optical pulse signal as an original optical signal to the circulating optical signal, a second optical waveguide, a second optical circulator provided in the optical waveguide in the second direction from the semiconductor optical amplifier and connected to the second optical waveguide. The second optical circulator outputs the input optical signal to the semiconductor optical amplifier and the second amplified optical signal to the second optical waveguide, and a second optical filter provided in the second optical waveguide and filtering the second amplified optical signal to produce the optical pulse sequence signal.

Also, the optical pulse signal generating unit may include a first optical waveguide in which a traveling optical signal can travel, a circular optical waveguide in which a circulating optical signal can circulate in a direction, and a semiconductor optical amplifier provided in the first optical waveguide and amplifying an input optical signal traveling in a first direction to the circular optical waveguide to emit a first amplified optical signal including an amplified spontaneous emission (ASE) optical signal, and an output optical signal traveling in a second direction from the circular optical waveguide to emit a second amplified optical signal including an amplified spontaneous emission (ASE) optical signal. The optical pulse signal generating unit may further include a first optical circulator connected to the first optical waveguide and the circular optical waveguide and outputting the first amplified optical signal to the circular optical waveguide as the circulating optical signal and outputting the circulating optical signal to the first optical waveguide as the output optical signal, a first delay interferometer provided in the circular optical waveguide and generating an optical pulse signal from the circulating optical signal, and a first optical filter provided in the circular optical waveguide and filtering the optical pulse signal to generate the optical pulse sequence signal as the circulating optical signal. The optical pulse signal generating unit may further include an original signal optical combiner provided in the circular optical waveguide and combining the optical pulse signal as an original optical signal to the circulating optical signal, and an optical splitter provided in the circular optical waveguide and taking out the optical pulse sequence signal from the circular optical waveguide.

In order to achieve another object of the present invention, an optical pulse signal demultiplexing apparatus includes a delay delaying an input optical pulse signal which is subjected to time division multiplexing of 1/n (n is an integer), an optical pulse signal generating unit generating an optical pulse sequence signal from the input optical pulse signal, the optical pulse sequence signal having a frequency n times more than a frequency of the optical pulse signal, and an all-optical gate gating the delayed optical pulse signal using the optical pulse sequence signal as a control signal.

In this case, the optical pulse signal generating unit may include a circular optical waveguide in which a circulating optical signal can circulate in a direction, a first optical combiner provided in the circular optical waveguide and inputting an externally inputted optical signal to combine the externally inputted optical signal and the circulating optical signal in the circular optical waveguide to produce a combination optical signal, and an original signal optical combiner provided in the circular optical waveguide and combining the optical pulse signal as an original optical signal to the circulating optical signal. The optical pulse signal generating unit may further include an optical converter provided in the circular optical waveguide and having a semiconductor optical amplifier which amplifies the combination optical signal and emits an amplified optical signal including an amplified spontaneous emission (ASE) optical signal. The optical converter outputs an optical pulse sequence signal from the combination optical signal via the amplified optical signal, and a first optical splitter provided outputting the optical pulse sequence signal from the circular optical waveguide. In this case, a portion of the generated optical pulse sequence signal circulates in the circular optical waveguide to reach the first optical combiner, and the generated optical pulse sequence signal finally has a specific pulse width and a specific repetition frequency. Also, the optical converter includes the first delay interferometer provided in the circular optical waveguide and generating the optical pulse signal from the amplified optical signal outputted from the semiconductor optical amplifier. The first delay interferometer has a delay time n times more than the frequency of the original optical signal.

Also, the optical pulse signal generating unit may include a circular optical waveguide in which a traveling optical signal can circulate in a direction, a first optical combiner provided in the circular optical waveguide and inputting a first externally inputted optical signal to combine the first externally inputted optical signal and a first optical pulse sequence signal as the traveling optical signal in the circular optical waveguide to produce a first combination optical signal, and an original signal optical combiner provided in the circular optical waveguide and combining the optical pulse signal as an original optical signal into the circulating optical signal. The optical pulse signal generating unit may further include a first optical converter provided in the circular optical waveguide and converting the first combination optical signal into a second optical pulse sequence signal with a first wavelength, a first optical splitter provided in the circular optical waveguide and outputting the second optical pulse sequence signal from the circular optical waveguide, and a second optical combiner provided in the circular optical waveguide and combining a second externally inputted optical signal and the second optical pulse sequence signal as the traveling optical signal in the circular optical waveguide to produce a second combination optical signal. The optical pulse signal generating unit may further include a second optical converter provided in the circular optical waveguide and converting the second combination optical signal into the first optical pulse sequence signal with a second wavelength, and a second optical splitter provided in the circular optical waveguide and outputting the first optical pulse sequence signal from the circular optical waveguide, one of the first and second optical pulse sequence signal being outputted as the optical pulse sequence signal. The first optical converter includes the first delay interferometer provided in the circular optical waveguide and generating the first optical pulse signal from the first amplified optical signal outputted from the first semiconductor optical amplifier. The first delay interferometer has a delay time n times more than a frequency of the original optical signal. The second optical converter includes the second delay interferometer provided in the circular optical waveguide and generating the second optical pulse signal from the second amplified optical signal outputted from the second semiconductor optical amplifier. The second delay interferometer has a delay time n times more than the frequency of the original optical signal.

Also, the optical pulse signal generating unit may include an optical waveguide in which a traveling optical signal can travel in either direction, a total reflection mirror provided at one end of the optical waveguide, an original signal optical combiner combining the optical pulse signal as an original optical signal and an external input optical signal to produce a combination optical signal and outputting the combination optical signal, and an optical circulator provided at the other end of the optical waveguide, supplying the combination optical signal to the optical waveguide as a first traveling optical signal traveling in a first direction from the optical circulator to the total reflection mirror, and outputting the optical pulse sequence signal on the optical waveguide as a second traveling optical signal traveling in a second direction from the total reflection mirror to the optical circulator. The optical pulse signal generating unit may further include a first optical filter passing the first traveling optical signal, and removing an amplified spontaneous emission (ASE) optical signal from the second traveling optical signal to supply to the optical circulator, a semiconductor optical amplifier emitting an amplified spontaneous emission (ASE) optical signal, and amplifying the first and second traveling optical signals and outputting amplified optical signals including the ASE optical signals into the first and second directions, and a second optical filter passing the second traveling optical signal to the semiconductor optical amplifier, and removing the amplified spontaneous emission (ASE) optical signal from the first traveling optical signal. The optical pulse signal generating unit may further include a delay interferometer generating the optical pulse sequence signal from the first traveling optical signal traveling from the semiconductor optical amplifier in the first direction and the second traveling optical signal traveling from the total reflection mirror in the second direction. The delay interferometer has a delay time n times more than the frequency of the original optical signal.

Also, the optical pulse signal generating unit may include an optical waveguide in which a traveling optical signal can travel in either direction, a total reflection mirror provided at one end of the optical waveguide, and an original signal optical combiner combining the optical pulse signal as an original optical signal into the optical waveguide. The optical pulse signal generating unit may further include an optical circulator provided at the other end of the optical waveguide, supplying an external input optical signal to the optical waveguide as a first traveling optical signal traveling in a first direction from the optical circulator to the total reflection mirror, and outputting the optical pulse sequence signal on the optical waveguide as a second traveling optical signal traveling in a second direction from the total reflection mirror to the optical circulator. The optical pulse signal generating unit may further include a first optical filter passing the first traveling optical signal, and removing an amplified spontaneous emission (ASE) optical signal from the second traveling optical signal to supply to the optical circulator, a semiconductor optical amplifier emitting an amplified spontaneous emission (ASE) optical signal, and amplifying the first and second traveling optical signals and outputting amplified optical signals including the ASE optical signals into the first and second directions, and a second optical filter passing the second traveling optical signal to the semiconductor optical amplifier, and removing the amplified spontaneous emission (ASE) optical signal from the first traveling optical signal. The optical pulse signal generating unit may further include a delay interferometer generating the optical pulse sequence signal from the first traveling optical signal traveling from the semiconductor optical amplifier in the first direction and the second traveling optical signal traveling from the total reflection mirror in the second direction, The delay interferometer has a delay time n times more than the frequency of the original optical signal.

Also, the optical pulse signal generating unit may include a first optical waveguide in which a traveling optical signal can travel, a circular optical waveguide in which a circulating optical signal can circulate in a direction, and a semiconductor optical amplifier provided in the first optical waveguide and amplifying an input optical signal traveling in a first direction to the circular optical waveguide to emit a first amplified optical signal including an amplified spontaneous emission (ASE) optical signal, and an output optical signal traveling in a second direction from the circular optical waveguide to emit a second amplified optical signal including an amplified spontaneous emission (ASE) optical signal. The optical pulse signal generating unit may further include a first optical circulator connected to the first optical waveguide and the circular optical waveguide and outputting the first amplified optical signal to the circular optical waveguide as the circulating optical signal and outputting the circulating optical signal to the first optical waveguide as the output optical signal, a first delay interferometer provided in the circular optical waveguide and generating an optical pulse signal from the circulating optical signal, The first delay interferometer has a delay time n times more than the frequency of the original optical signal, and a first optical filter provided in the circular optical waveguide and filtering the optical pulse signal to generate the optical pulse sequence signal as the circulating optical signal. The optical pulse signal generating unit may further include an original signal optical combiner provided in the circular optical waveguide and combining the optical pulse signal as an original optical signal to the circulating optical signal, a second optical waveguide, a second optical circulator provided in the optical waveguide in the second direction from the semiconductor optical amplifier and connected to the second optical waveguide, The second optical circulator outputs the input optical signal to the semiconductor optical amplifier and the second amplified optical signal to the second optical waveguide, and a second optical filter provided in the second optical waveguide and filtering the second amplified optical signal to produce the optical pulse sequence signal.

Also, the optical pulse signal generating unit may include a first optical waveguide in which a traveling optical signal can travel, a circular optical waveguide in which a circulating optical signal can circulate in a direction, and a semiconductor optical amplifier provided in the first optical waveguide and amplifying an input optical signal traveling in a first direction to the circular optical waveguide to emit a first amplified optical signal including an amplified spontaneous emission (ASE) optical signal, and an output optical signal traveling in a second direction from the circular optical waveguide to emit a second amplified optical signal including an amplified spontaneous emission (ASE) optical signal. The optical pulse signal generating unit may further include a first optical circulator connected to the first optical waveguide and the circular optical waveguide and outputting the first amplified optical signal to the circular optical waveguide as the circulating optical signal and outputting the circulating optical signal to the first optical waveguide as the output optical signal, and a first delay interferometer provided in the circular optical waveguide and generating an optical pulse signal from the circulating optical signal. The first delay interferometer has a delay time n times more than the frequency of the original optical signal. The optical pulse signal generating unit may further include a first optical filter provided in the circular optical waveguide and filtering the optical pulse signal to generate the optical pulse sequence signal as the circulating optical signal, an original signal optical combiner provided in the circular optical waveguide and combining the optical pulse signal as an original optical signal to the circulating optical signal, and an optical splitter provided in the circular optical waveguide and taking out the optical pulse sequence signal from the circular optical waveguide.

In order to achieve still another aspect of the present invention, an optical pulse signal expanding apparatus includes a delay delaying an input optical pulse signal which is subjected to time division multiplexing of 1/n (n is an integer), a first optical pulse signal generating unit generating a first optical pulse sequence signal from the input optical pulse signal, the first optical pulse sequence signal having a frequency n times more than a frequency of the optical pulse signal, a second optical pulse signal generating unit generating a second optical pulse sequence signal from the first optical pulse sequence signal, the second optical pulse sequence signal having a frequency m (m is an integer) times more than a frequency of the first optical pulse sequence signal, and an optical expanding unit expanding the delayed optical pulse signal in units of m bits using the first and second pulse sequence signals.

Also, the optical expanding apparatus is mach-zehnder type delay optical circuit.

Also, the first optical pulse signal generating unit may include a circular optical waveguide in which a circulating optical signal can circulate in a direction, and a first optical combiner provided in the circular optical waveguide and inputting the optical pulse signal to combine the optical pulse signal and the circulating optical signal in the circular optical waveguide to produce a combination optical signal. The first optical pulse signal generating unit may further include an original signal optical combiner provided in the circular optical waveguide and combining the input optical pulse signal as an original optical signal to the circulating optical signal, an optical converter provided in the circular optical waveguide and having a semiconductor optical amplifier which amplifies the combination optical signal and emits an amplified optical signal including an amplified spontaneous emission (ASE) optical signal. The optical converter outputs an optical pulse sequence signal from the combination optical signal via the amplified optical signal. The first optical pulse signal generating unit may further include a first optical splitter provided outputting the optical pulse sequence signal as the first optical pulse sequence signal from the circular optical waveguide. A portion of the generated optical pulse sequence signal circulates in the circular optical waveguide to reach the first optical combiner, and the generated optical pulse sequence signal finally has a specific pulse width and a specific repetition frequency. The optical converter includes the first delay interferometer provided in the circular optical waveguide and generating the optical pulse signal from the amplified optical signal outputted from the semiconductor optical amplifier. Also, the first delay interferometer has a delay time n times more than the frequency of the original optical signal.

Also, the first optical pulse signal generating unit may include a circular optical waveguide in which a traveling optical signal can circulate in a direction, and a first optical combiner provided in the circular optical waveguide and inputting a first externally inputted optical signal to combine the first externally inputted optical signal and a first optical pulse sequence signal as the traveling optical signal in the circular optical waveguide to produce a first combination optical signal. The first optical pulse signal generating unit may further include an original signal optical combiner provided in the circular optical waveguide and combining the optical pulse signal as an original optical signal into the circulating optical signal, a first optical converter provided in the circular optical waveguide and converting the first combination optical signal into a second optical pulse sequence signal with a first wavelength, and a first optical splitter provided in the circular optical waveguide and outputting the second optical pulse sequence signal from the circular optical waveguide. The first optical pulse signal generating unit may further include a second optical combiner provided in the circular optical waveguide and combining a second externally inputted optical signal and the second optical pulse sequence signal as the traveling optical signal in the circular optical waveguide to produce a second combination optical signal, a second optical converter provided in the circular optical waveguide and converting the second combination optical signal into the first optical pulse sequence signal with a second wavelength, and a second optical splitter provided in the circular optical waveguide and outputting the first optical pulse sequence signal from the circular optical waveguide, one of the first and second optical pulse sequence signal being outputted as the first optical pulse sequence signal. The first optical converter includes the first delay interferometer provided in the circular optical waveguide and generating the first optical pulse signal from the first amplified optical signal outputted from the first semiconductor optical amplifier. The first delay interferometer has a delay time n times more than a frequency of the original optical signal. The second optical converter includes the second delay interferometer provided in the circular optical waveguide and generating the second optical pulse signal from the second amplified optical signal outputted from the second semiconductor optical amplifier. The second delay interferometer has a delay time n times more than the frequency of the original optical signal.

Also, the first optical pulse signal generating unit may include an optical waveguide in which a traveling optical signal can travel in either direction, a total reflection mirror provided at one end of the optical waveguide, and an original signal optical combiner combining the optical pulse signal as an original optical signal and an external input optical signal to produce a combination optical signal and outputting the combination optical signal. The first optical pulse signal generating unit may further include an optical circulator provided at the other end of the optical waveguide, supplying the combination optical signal to the optical waveguide as a first traveling optical signal traveling in a first direction from the optical circulator to the total reflection mirror, and outputting the optical pulse sequence signal on the optical waveguide as a second traveling optical signal traveling in a second direction from the total reflection mirror to the optical circulator, the optical pulse sequence signal being the first optical pulse sequence signal, and a first optical filter passing the first traveling optical signal, and removing an amplified spontaneous emission (ASE) optical signal from the second traveling optical signal to supply to the optical circulator. The first optical pulse signal generating unit may further include a semiconductor optical amplifier emitting an amplified spontaneous emission (ASE) optical signal, and amplifying the first and second traveling optical signals and outputting amplified optical signals including the ASE optical signals into the first and second directions, a second optical filter passing the second traveling optical signal to the semiconductor optical amplifier, and removing the amplified spontaneous emission (ASE) optical signal from the first traveling optical signal, and a delay interferometer generating the optical pulse sequence signal from the first traveling optical signal traveling from the semiconductor optical amplifier in the first direction and the second traveling optical signal traveling from the total reflection mirror in the second direction. The delay interferometer has a delay time n times more than the frequency of the original optical signal.

Also, the first optical pulse signal generating unit may include an optical waveguide in which a traveling optical signal can travel in either direction, a total reflection mirror provided at one end of the optical waveguide, and an original signal optical combiner combining the optical pulse signal as an original optical signal into the optical waveguide. The first optical pulse signal generating unit may further include an optical circulator provided at the other end of the optical waveguide, supplying an external input optical signal to the optical waveguide as a first traveling optical signal traveling in a first direction from the optical circulator to the total reflection mirror, and outputting the optical pulse sequence signal on the optical waveguide as a second traveling optical signal traveling in a second direction from the total reflection mirror to the optical circulator, the optical pulse sequence signal being the first optical pulse sequence signal, and a first optical filter passing the first traveling optical signal, and removing an amplified spontaneous emission (ASE) optical signal from the second traveling optical signal to supply to the optical circulator. The first optical pulse signal generating unit may further include a semiconductor optical amplifier emitting an amplified spontaneous emission (ASE) optical signal, and amplifying the first and second traveling optical signals and outputting amplified optical signals including the ASE optical signals into the first and second directions, a second optical filter passing the second traveling optical signal to the semiconductor optical amplifier, and removing the amplified spontaneous emission (ASE) optical signal from the first traveling optical signal, and a delay interferometer generating the optical pulse sequence signal from the first traveling optical signal traveling from the semiconductor optical amplifier in the first direction and the second traveling optical signal traveling from the total reflection mirror in the second direction, The delay interferometer has a delay time n times more than the frequency of the original optical signal.

Also, the first optical pulse signal generating unit may include a first optical waveguide in which a traveling optical signal can travel, a circular optical waveguide in which a circulating optical signal can circulate in a direction, and a semiconductor optical amplifier provided in the first optical waveguide and amplifying an input optical signal traveling in a first direction to the circular optical waveguide to emit a first amplified optical signal including an amplified spontaneous emission (ASE) optical signal, and an output optical signal traveling in a second direction from the circular optical waveguide to emit a second amplified optical signal including an amplified spontaneous emission (ASE) optical signal. The first optical pulse signal generating unit may further include a first optical circulator connected to the first optical waveguide and the circular optical waveguide and outputting the first amplified optical signal to the circular optical waveguide as the circulating optical signal and outputting the circulating optical signal to the first optical waveguide as the output optical signal, a first delay interferometer provided in the circular optical waveguide and generating an optical pulse signal from the circulating optical signal. The first delay interferometer has a delay time n times more than the frequency of the original optical signal, and a first optical filter provided in the circular optical waveguide and filtering the optical pulse signal to generate the optical pulse sequence signal as the circulating optical signal. The first optical pulse signal generating unit may further include an original signal optical combiner provided in the circular optical waveguide and combining the optical pulse signal as an original optical signal to the circulating optical signal, a second optical waveguide, a second optical circulator provided in the optical waveguide in the second direction from the semiconductor optical amplifier and connected to the second optical waveguide. The second optical circulator outputs the input optical signal to the semiconductor optical amplifier and the second amplified optical signal to the second optical waveguide, and a second optical filter provided in the second optical waveguide and filtering the second amplified optical signal to produce the optical pulse sequence signal as the first optical pulse sequence signal.

Also, the first optical pulse signal generating unit may include a first optical waveguide in which a traveling optical signal can travel, a circular optical waveguide in which a circulating optical signal can circulate in a direction, and a semiconductor optical amplifier provided in the first optical waveguide and amplifying an input optical signal traveling in a first direction to the circular optical waveguide to emit a first amplified optical signal including an amplified spontaneous emission (ASE) optical signal, and an output optical signal traveling in a second direction from the circular optical waveguide to emit a second amplified optical signal including an amplified spontaneous emission (ASE) optical signal. The first optical pulse signal generating unit may further include a first optical circulator connected to the first optical waveguide and the circular optical waveguide and outputting the first amplified optical signal to the circular optical waveguide as the circulating optical signal and outputting the circulating optical signal to the first optical waveguide as the output optical signal, and a first delay interferometer provided in the circular optical waveguide and generating an optical pulse signal from the circulating optical signal. The first delay interferometer has a delay time n times more than the frequency of the original optical signal. The first optical pulse signal generating unit may further include a first optical filter provided in the circular optical waveguide and filtering the optical pulse signal to generate the optical pulse sequence signal as the circulating optical signal, an original signal optical combiner provided in the circular optical waveguide and combining the optical pulse signal as an original optical signal to the circulating optical signal, and an optical splitter provided in the circular optical waveguide and taking out the optical pulse sequence signal as the first optical pulse sequence signal from the circular optical waveguide.

Also, the second optical pulse signal generating unit may include a circular optical waveguide in which a circulating optical signal can circulate in a direction, a first optical combiner provided in the circular optical waveguide and inputting an externally inputted optical signal to combine the externally inputted optical signal and the circulating optical signal in the circular optical waveguide to produce a combination optical signal, and an original signal optical combiner provided in the circular optical waveguide and combining the first optical pulse sequence signal to the circulating optical signal. The second optical pulse signal generating unit may further include an optical converter provided in the circular optical waveguide and having a semiconductor optical amplifier which amplifies the combination optical signal and emits an amplified optical signal including an amplified spontaneous emission (ASE) optical signal. The optical converter outputs an optical pulse sequence signal from the combination optical signal via the amplified optical signal, and a first optical splitter provided outputting the optical pulse sequence signal as the second optical pulse sequence signal from the circular optical waveguide. A portion of the generated optical pulse sequence signal circulates in the circular optical waveguide to reach the first optical combiner, and the generated optical pulse sequence signal finally has a specific pulse width and a specific repetition frequency. The optical converter includes the first delay interferometer provided in the circular optical waveguide and generating the optical pulse signal from the amplified optical signal outputted from the semiconductor optical amplifier. The first delay interferometer has a delay time m times more than the frequency of the original optical signal.

Also, the second optical pulse signal generating unit may include a circular optical waveguide in which a traveling optical signal can circulate in a direction, a first optical combiner provided in the circular optical waveguide and inputting a first externally inputted optical signal to combine the first externally inputted optical signal and a first optical pulse sequence signal as the traveling optical signal in the circular optical waveguide to produce a first combination optical signal, and an original signal optical combiner provided in the circular optical waveguide and combining the second optical pulse sequence signal as an original optical signal into the circulating optical signal. The second optical pulse signal generating unit may further include a first optical converter provided in the circular optical waveguide and converting the first combination optical signal into a second optical pulse sequence signal with a first wavelength, a first optical splitter provided in the circular optical waveguide and outputting the second optical pulse sequence signal from the circular optical waveguide, and a second optical combiner provided in the circular optical waveguide and combining a second externally inputted optical signal and the second optical pulse sequence signal as the traveling optical signal in the circular optical waveguide to produce a second combination optical signal. The second optical pulse signal generating unit may further include a second optical converter provided in the circular optical waveguide and converting the second combination optical signal into the first optical pulse sequence signal with a second wavelength, and a second optical splitter provided in the circular optical waveguide and outputting the first optical pulse sequence signal from the circular optical waveguide, one of the first and second optical pulse sequence signal being outputted as the second optical pulse sequence signal. The first optical converter includes the first delay interferometer provided in the circular optical waveguide and generating the first optical pulse signal from the first amplified optical signal outputted from the first semiconductor optical amplifier. The first delay interferometer has a delay time the m times more than a frequency of the original optical signal. The second optical converter includes the second delay interferometer provided in the circular optical waveguide and generating the second optical pulse signal from the second amplified optical signal outputted from the second semiconductor optical amplifier. The second delay interferometer has a delay time the m times more than the frequency of the original optical signal.

Also, the second optical pulse signal generating unit may include an optical waveguide in which a traveling optical signal can travel in either direction, a total reflection mirror provided at one end of the optical waveguide, and an original signal optical combiner combining the second optical pulse sequence signal as an original optical signal and an external input optical signal to produce a combination optical signal and outputting the combination optical signal. The second optical pulse signal generating unit may further include an optical circulator provided at the other end of the optical waveguide, supplying the combination optical signal to the optical waveguide as a first traveling optical signal traveling in a first direction from the optical circulator to the total reflection mirror, and outputting the optical pulse sequence signal on the optical waveguide as a second traveling optical signal traveling in a second direction from the total reflection mirror to the optical circulator, the optical pulse sequence signal being the second optical pulse sequence signal, and a first optical filter passing the first traveling optical signal, and removing an amplified spontaneous emission (ASE) optical signal from the second traveling optical signal to supply to the optical circulator. The second optical pulse signal generating unit may further include a semiconductor optical amplifier emitting an amplified spontaneous emission (ASE) optical signal, and amplifying the first and second traveling optical signals and outputting amplified optical signals including the ASE optical signals into the first and second directions, a second optical filter passing the second traveling optical signal to the semiconductor optical amplifier, and removing the amplified spontaneous emission (ASE) optical signal from the first traveling optical signal, and a delay interferometer generating the optical pulse sequence signal from the first traveling optical signal traveling from the semiconductor optical amplifier in the first direction and the second traveling optical signal traveling from the total reflection mirror in the second direction. The delay interferometer has a delay time the m times more than the frequency of the original optical signal.

Also, the second optical pulse signal generating unit may include an optical waveguide in which a traveling optical signal can travel in either direction, a total reflection mirror provided at one end of the optical waveguide, and an original signal optical combiner combining the second optical pulse sequence signal as an original optical signal into the optical waveguide. The second optical pulse signal generating unit may further include an optical circulator provided at the other end of the optical waveguide, supplying an external input optical signal to the optical waveguide as a first traveling optical signal traveling in a first direction from the optical circulator to the total reflection mirror, and outputting the optical pulse sequence signal on the optical waveguide as a second traveling optical signal traveling in a second direction from the total reflection mirror to the optical circulator, the optical pulse sequence signal being the second optical pulse sequence signal, and a first optical filter passing the first traveling optical signal, and removing an amplified spontaneous emission (ASE) optical signal from the second traveling optical signal to supply to the optical circulator. The second optical pulse signal generating unit may further include a semiconductor optical amplifier emitting an amplified spontaneous emission (ASE) optical signal, and amplifying the first and second traveling optical signals and outputting amplified optical signals including the ASE optical signals into the first and second directions, and a second optical filter passing the second traveling optical signal to the semiconductor optical amplifier, and removing the amplified spontaneous emission (ASE) optical signal from the first traveling optical signal. The second optical pulse signal generating unit may further include a delay interferometer generating the optical pulse sequence signal from the first traveling optical signal traveling from the semiconductor optical amplifier in the first direction and the second traveling optical signal traveling from the total reflection mirror in the second direction, The delay interferometer has a delay time the m times more than the frequency of the original optical signal.

Also, the second optical pulse signal generating unit may include a first optical waveguide in which a traveling optical signal can travel, a circular optical waveguide in which a circulating optical signal can circulate in a direction, and a semiconductor optical amplifier provided in the first optical waveguide and amplifying an input optical signal traveling in a first direction to the circular optical waveguide to emit a first amplified optical signal including an amplified spontaneous emission (ASE) optical signal, and an output optical signal traveling in a second direction from the circular optical waveguide to emit a second amplified optical signal including an amplified spontaneous emission (ASE) optical signal. The second optical pulse signal generating unit may further include a first optical circulator connected to the first optical waveguide and the circular optical waveguide and outputting the first amplified optical signal to the circular optical waveguide as the circulating optical signal and outputting the circulating optical signal to the first optical waveguide as the output optical signal, and a first delay interferometer provided in the circular optical waveguide and generating an optical pulse signal from the circulating optical signal. The first delay interferometer has a delay time the m times more than the frequency of the original optical signal. The second optical pulse signal generating unit may further include a first optical filter provided in the circular optical waveguide and filtering the optical pulse signal to generate the optical pulse sequence signal as the circulating optical signal, an original signal optical combiner provided in the circular optical waveguide and combining the first optical pulse sequence signal as an original optical signal to the circulating optical signal, a second optical waveguide, a second optical circulator provided in the optical waveguide in the second direction from the semiconductor optical amplifier and connected to the second optical waveguide. The second optical circulator outputs the input optical signal to the semiconductor optical amplifier and the second amplified optical signal to the second optical waveguide, and a second optical filter provided in the second optical waveguide and filtering the second amplified optical signal to produce the optical pulse sequence signal as the second optical pulse sequence signal.

Also, the second optical pulse signal generating unit may include a first optical waveguide in which a traveling optical signal can travel, a circular optical waveguide in which a circulating optical signal can circulate in a direction, and a semiconductor optical amplifier provided in the first optical waveguide and amplifying an input optical signal traveling in a first direction to the circular optical waveguide to emit a first amplified optical signal including an amplified spontaneous emission (ASE) optical signal, and an output optical signal traveling in a second direction from the circular optical waveguide to emit a second amplified optical signal including an amplified spontaneous emission (ASE) optical signal. The second optical pulse signal generating unit may further include a first optical circulator connected to the first optical waveguide and the circular optical waveguide and outputting the first amplified optical signal to the circular optical waveguide as the circulating optical signal and outputting the circulating optical signal to the first optical waveguide as the output optical signal, and a first delay interferometer provided in the circular optical waveguide and generating an optical pulse signal from the circulating optical signal. The first delay interferometer has a delay time n times more than the frequency of the original optical signal. The second optical pulse signal generating unit may further include a first optical filter provided in the circular optical waveguide and filtering the optical pulse signal to generate the optical pulse sequence signal as the circulating optical signal, an original signal optical combiner provided in the circular optical waveguide and combining the first optical pulse sequence signal as an original optical signal to the circulating optical signal, and an optical splitter provided in the circular optical waveguide and taking out the optical pulse sequence signal as the second optical pulse sequence signal from the circular optical waveguide.

### BRIEF DESCRIPTION OF THE DRAWINGS

FIG. 1 is a block diagram showing the structure of a optical pulse generation apparatus according to a first embodiment of the of the present invention;

FIG. 2 is a diagram showing the operation of a wavelength converter which is contained in the optical pulse generation apparatus of the present invention;

FIGS. 3A to 3F are diagrams showing the operation of the optical pulse generation apparatus according to the first embodiment of the present invention;

FIGS. 4A to 4F are diagrams showing the operation of the optical pulse generation apparatus according to the first embodiment of the present invention;

FIG. 5 is a diagram showing the operation of the optical pulse generation apparatus according to the first embodiment of the present invention;

FIG. 6 is a block diagram showing the structure of the optical pulse generation apparatus according to a second embodiment of the present invention;

FIG. 7 is a block diagram showing the structure of the optical pulse generation apparatus according to a third embodiment of the present invention;

FIG. 8 is a block diagram showing the structure of the optical pulse generation apparatus according to a fourth embodiment of the present invention;

FIG. 9 is a block diagram showing the structure of the optical pulse generation apparatus according to the fifth embodiment of the present invention;

FIG. 10 is a block diagram showing the structure of the optical pulse generation apparatus according to a sixth embodiment of the present invention;

FIG. 11 is a block diagram showing the structure of the optical clock extraction apparatus according to a seventh embodiment of the present invention;

FIGS. 12A to 12F are diagrams showing the operation of the optical clock extraction apparatus according to the seventh embodiment of the present invention;

FIG. 13 is a diagram showing the structure of an all-optical signal regeneration apparatus using an optical clock extraction apparatus according to the seventh embodiment of the present invention;

FIG. 14 is a block diagram showing the structure of the optical clock extraction apparatus according to an eighth embodiment of the present invention;

FIG. 15 is a block diagram showing the structure of the optical clock extraction apparatus according to a ninth embodiment of the present invention;

FIG. 16 is a block diagram showing the structure of the optical clock extracting according to the tenth embodiment of the present invention;

FIGS. 17A to 17F are diagrams showing the basic operation of the simultaneous process of a clock extracting operation and a frequency-dividing operation in the optical clock extraction apparatus according to tenth embodiment of the present invention;

FIGS. 18A to 18F are diagrams showing the clock extracting operation and the frequency-dividing operation of the optical clock extraction apparatus according to the tenth embodiment of the present invention;

FIG. 19 is a diagram showing the consequence of phase bias optimization in the optical clock extraction apparatus according to tenth embodiment of the present invention;

FIG. 20 is a block diagram showing the structure of the all-optical demultiplexing apparatus using the clock extracting operation and the frequency-dividing operation in the optical clock extraction apparatus according to tenth embodiment of the present invention;

FIG. 21 is a block diagram showing the structure of an all-optical packet expanding apparatus using the clock extracting operation and the frequency-dividing operation in the optical clock extraction apparatus according to tenth embodiment of the present invention;

FIG. 22 is a diagram showing the structure example when Mach-Zehnder type delay light circuit is used for the packet expanding light circuit of FIG. 21;

FIG. 23 is a block diagram showing the structure of the optical clock extraction apparatus according to an eleventh embodiment of the present invention;

FIG. 24 is a block diagram showing the structure of the optical clock extraction apparatus according to a twelfth embodiment of the present invention;

FIG. 25 is a block diagram showing the structure of the optical clock extraction apparatus according to a thirteenth embodiment of the present invention;

FIG. 26 is a block diagram showing the structure of the optical clock extraction apparatus according to a fourteenth embodiment of the present invention;

FIGS. 27A and 27B are diagrams showing pulse train waveforms at the delay interferometer (MZI) input where the pulse repetition frequency is 40.000 GHz, FIGS. 27C and 27D are diagrams showing pulse train waveforms at the MZI output where the pulse repetition frequency is 40.000 GHz, FIGS. 27E and 27F are diagrams showing pulse train waveforms at the MZI output where the pulse repetition frequency is 42.400 GHz, and FIGS. 27G and 27H are diagrams showing pulse train waveforms at the MZI output where the pulse repetition frequency is 44.800 GHz;

FIG. 28 is a diagram showing transmissivity of 40-GHz MZI as a function of the optical frequency detuning;

FIG. 29 is a diagram showing the decrease in pulse peak intensity of a pulse train at the MZI output as a function of the repetition frequency detuning of the pulse train;

FIGS. 30 to 39 are diagrams showing the apparatuses in which the delay interferometer 7, 24, or 77 is replaced by an etalon 107, 124 or 177 in the apparatuses shown in FIGS. 1, 6, 8, 9, 10, 11, 14, 16, 25 and 26;

FIGS. 40A and 40B are diagrams showing the pulse train waveforms and optical spectra at the 40-GHz etalon input and output, at the etalon input where the pulse repetition frequency is 40.000 GHz, FIGS. 40C and 40D are diagrams showing the pulse train waveforms and optical spectra at the 40-GHz etalon input and output, at the etalon output where the pulse repetition frequency is 40.000 GHz, FIGS. 40E and 40F are diagrams showing the pulse train waveforms and optical spectra at the 40-GHz etalon input and output, at the etalon output where the pulse repetition frequency is 40.600 GHz, and FIGS. 40G and 40H are diagrams showing the pulse train waveforms and optical spectra at the 40-GHz etalon input and output, at the etalon output where the pulse repetition frequency is 41.200 GHz;

FIG. 41 a diagram showing transmissivity of 40-GHz etalon as a function of the optical frequency detuning; and

FIGS. 42A and 42B are diagrams showing the decrease in the pulse peak intensity of a pulse train at the etalon output as a function of the repetition frequency detuning of the pulse train.

### DESCRIPTION OF THE PREFERRED EMBODIMENTS

Hereinafter, an optical pulse generation apparatus of the present invention will be described below in detail with reference to the attached drawings.

### First Embodiment

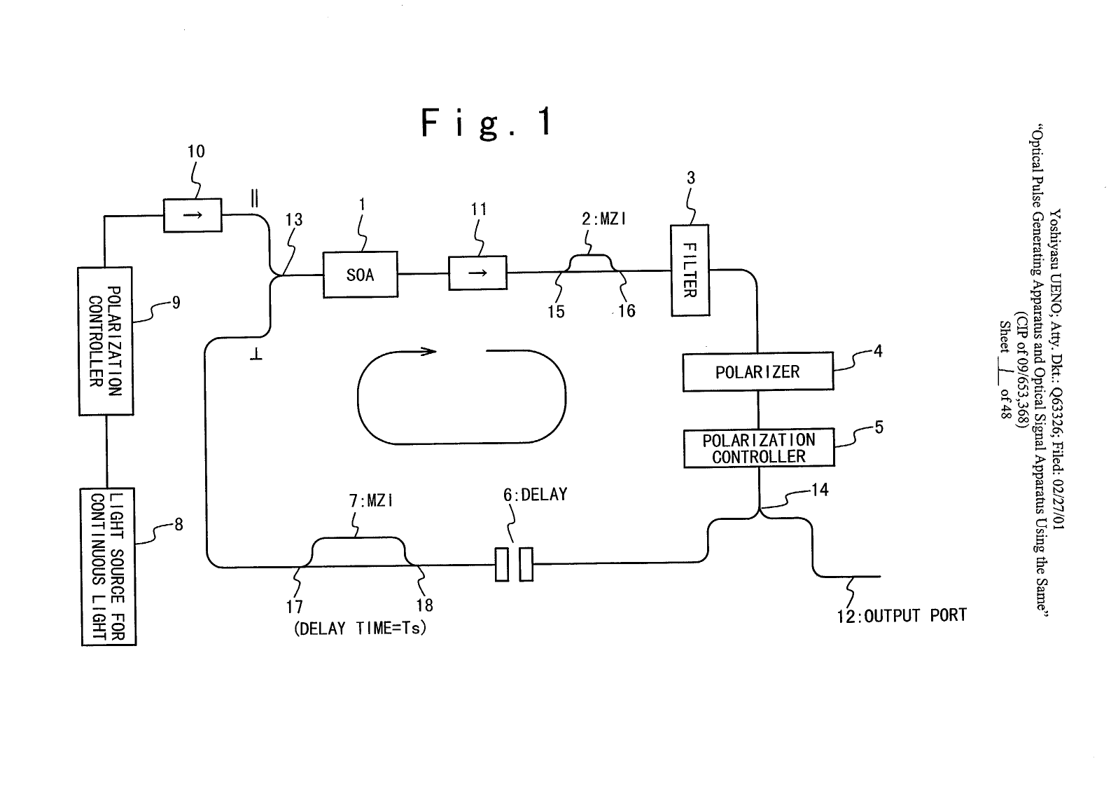

FIG. 1 is a block diagram for schematically showing the structure of an optical pulse generation apparatus according to the first embodiment of the present invention. Referring to FIG. 1, the optical pulse generation apparatus according to the first embodiment of the present invention is composed of a circular optical waveguide and continuous wave light source 8.

The circular optical waveguide of the first embodiment is composed of a semiconductor optical amplifier (SOA) 1, delay interferometers (MZI) 2 and 7, a band pass wavelength filter 3, a polarizer 4, a polarization controller 5, a time delay 6, an isolator 11, optical combiners 13, 16 and 17, and optical splitters 14, 15 and 18.

The delay interferometer 2 is composed of at least an optical phase adjusting unit. The optical phase adjusting unit is provided on any of arms. The delay interferometer 7 is composed of at least a time delay. The time delay is provided on any of the arms. The continuous wave light generated from the continuous wave light source 8 is entered via the polarization controller 9, the isolator 10, and the optical combiner 13 into the circular optical waveguide. An optical pulse signal generated within the circular optical waveguide is supplied to an output port 12 via the optical splitter 14.

The semiconductor optical amplifier 1 has the sectional structure in which an InGaAs gain region is surrounded by an InP cladding layer. The semiconductor optical amplifier 1 has the α parameter of 2.5, the non-saturation gain equal to or larger than 28 dB in the wavelength between 1520 and 1590 nm the gain peak wavelength of 1550 nm, the pulse signal saturation energy of 180 fJ, the carrier lifetime of 60 ps, and the injection current of 400 mA.

It should be noted that various types of semiconductor optical amplifiers reported in the previous papers may be utilized as this semiconductor optical amplifier 1. That is, as the semiconductor optical amplifier 1, the following semiconductor amplifiers may be utilized as described in the publications: (IEEE Photonics Technology Letters, volume 7, No. 2, 1995, pages 147 to 148), (Electronics Letters” volume 33, No. 25, 1997, pages 2123 to 2124), and (IEEE Photonics Technology Letters, volume 6, No. 2, 1994, pages 170 to 172).

The delay time of the delay interferometer 2 is defined by a time difference between a time required for the light circulated within the circular optical waveguide to propagate from the optical splitter 15 of the delay interferometer 2 to the optical combiner 16 via the first arm, and a time required for the circulated light to propagate from the optical splitter 15 to the optical combiner 16 via the second arm. In this embodiment, the delay time of the delay interferometer 2 is 1.78 ps. Also, a phase difference in the delay interferometer 2 is defined as the phase difference between a phase of an optical signal propagated from the optical splitter 15 of the delay interferometer 2 to the optical combiner 16 via the first arm, and a phase of an optical signal propagated from the optical splitter 15 to the optical combiner 16 via the second arm. In this embodiment, the phase difference in the delay interferometer 2 is equal to 1.01π to 1.35π. The delay time of the delay interferometer 7 is set to 10.0 ps, and the time delay 6 is adjusted in such a manner that the circulating time of the optical pulse signal circulated in the circular optical waveguide is equal to positive integer times of 10.0 ps.

Also, the polarization of the continuous wave light is adjusted by the polarization controller 9 in such a manner that the polarization of the continuous wave light entered into the semiconductor optical amplifier 1 is orthogonalized to the polarization of the optical pulse signal. The polarization orientation of the polarizer 4 is adjusted in such a manner that an optical pulse signal which is newly generated in the waveguide from the semiconductor optical amplifier 1 to the delay interferometer 2 passes through the polarizer 4, and the old optical pulse signal which has been amplified by the semiconductor optical amplifier 1 is interrupted.

The wavelength filter 3 defines the wavelength of an optical pulse signal outputted from the optical pulse signal generation apparatus according to the first embodiment. The gain peak wavelength and gain bandwidth of the semiconductor optical amplifier 1, and the center wavelength of the wavelength filter are properly combined so that an optical pulse signal can be generated to have one wavelength in a wide wavelength range. A transmission spectrum width of the wavelength filter is set in accordance with the spectrum width of the optical pulse signal. In the first embodiment, the center wavelength is selected to be 1550 nm, and a full width at half maximum is selected to be 6 nm.

The above-explained optical pulse signal generation apparatus spontaneously generates an optical pulse sequence. When the continuous wave light is inputted into the semiconductor optical amplifier 1 and a current is injected into the semiconductor optical amplifier 1, spontaneous emission light which is generated by the semiconductor optical amplifier 1 and the continuous wave light are first circulated. When both of the spontaneous emission light and the continuous wave light are circulated several times, the optical pulse signal is grown and the pulse width of the optical pulse signal is reduced.

When the circulated optical pulse signal and the operation condition of the semiconductor optical amplifier 1 are brought into a balanced condition, a predetermined stable optical pulse sequence continues to be circulated. In the first embodiment, the pulse width of the generated optical pulse signal is 1.5 ps, and the pulse interval is 10.0 ps. This corresponds to the repetition frequency is selected to be 100 GHz. The optical pulse sequence brought into the stable condition is circulated into the circular optical waveguide in the following manner. That is, when an optical pulse signal (A) is entered into the semiconductor optical amplifier 1, both of the phase and intensity of the continuous wave light which passes through the semiconductor optical amplifier 1 at the same time as the optical pulse signal. When the continuous wave light which is subjected to the phase modulation and the intensity modulation passes through the delay interferometer 2, a new optical pulse signal (B) with the pulse width of 1.5 ps is generated. The wavelength filter 3 removes amplified spontaneous emission (ASE) light emitted from the semiconductor optical amplifier 1.

The optical pulse signal (B) which has passed through the wavelength filter 3 is traveled through both of the polarizer 4 and the polarization controller 5, and then returns to the semiconductor optical amplifier 1. The optical pulse signal (B) is adjusted by the polarization controller 5 in such a manner that the polarization of the optical pulse signal (B) inputted to the semiconductor optical amplifier 1 is orthogonalized to the polarization of the continuous wave light.

On the other hand, the optical pulse signal (A) amplified by the semiconductor optical amplifier 1 is removed by the polarizer 4. The structure and the operation of the optical circuit from the semiconductor optical amplifier 1 to the wavelength filter 3 via the isolator 11 and the delay interferometer 2 are similar to those of the wavelength converters as described in Japanese Laid Open Patent Application (JP-A-Heisei 10-301151), Japanese Laid Open Patent Application (JP-A-Heisei 10-319448), U.S. patent application Ser. No. 09/342,445 corresponding to Japanese Laid Open Patent Application (JP-A-2000-19574), and Japanese Patent Application No. Heisei 10-198744 corresponding to Japanese Laid Open Patent Application (JP-A-2000-29081), and as recited in the publications (IEEE Photonics Technology Letters, volume 10, No. 3, 1998, pages 346 to 348, and Optical Letter, volume 23, No. 23, 1998, pages 1846 to 1848). Here, the disclosure of U.S. patent application Ser. No. 09/342,445 is incorporated by refernce.

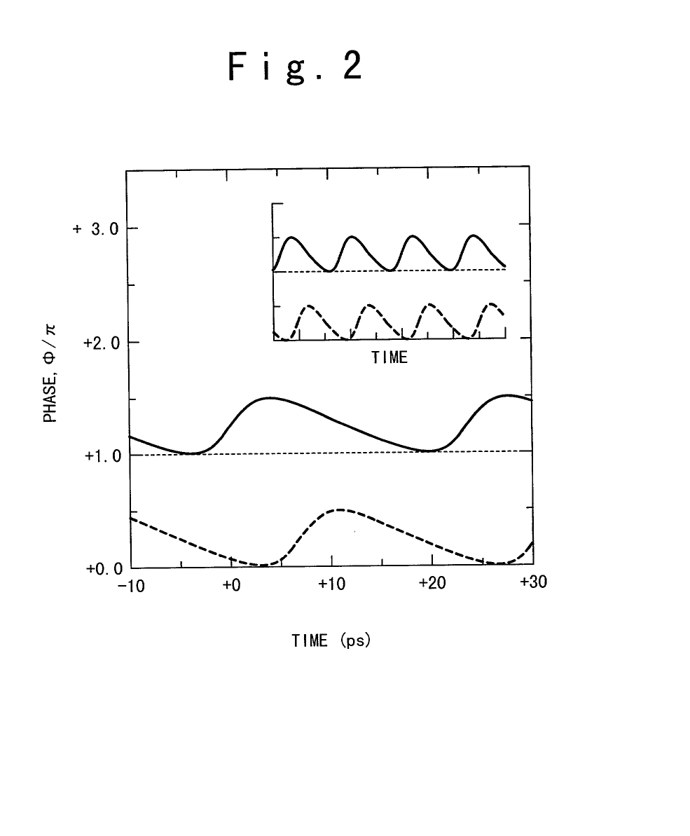

FIG. 2 is a diagram showing an operation of a wavelength converter section provided inside the optical pulse signal generation apparatus of the present invention. Referring now to FIG. 2, a description will be made of the operation of a wavelength converter (DISC type wavelength converter) of an optical circuit from the semiconductor optical amplifier 1 to the wavelength filter 3 via the isolator 11 and the delay interferometer 2.

When an optical pulse sequence is entered into the semiconductor optical amplifier 1, the optical pulse sequence is optically amplified. When the optical pulse sequence is optically amplified, the internal carrier density of the semiconductor optical amplifier 1 is modulated as the reaction of the optical amplification. As a result of carrier density modulation, the phase of the continuous wave light passing through the semiconductor optical amplifier 1 at the same time as the optical pulse sequence is modulated.

When the phase-modulated continuous wave light is further entered into the delay interferometer 2, the continuous wave light is branched into two light components by the branching unit 15. In the case, the continuous wave light is branched into two light components of 50:50, and the delay interferometer 2 applies a constant delay time to one light component. Furthermore, when these two light components are reached a combining unit 16, these two light components interfere with each other. FIG. 2 represents an example of a phase change of the two components of the continuous wave light which is passing through the delay interferometer 2. A small-sized figure is inserted in FIG. 2 to represent a temporal change in optical signal phase in a wider time range. In FIG. 2, a solid line portion shows a phase change in the continuous wave light component to which no delay time is applied, namely, fast component, whereas a broken line portion shows the continuous wave light component to which the delay time is applied, namely, slow component.

In the above-explained example, each pulse signal of the input pulse sequence has the pulse width of 5 ps, and the pulse signal interval of 24 ps. The delay time of the delay interferometer 2 is 7 ps, the initial phase bias between the two light components is π, and the carrier lifetime of the semiconductor optical amplifier 1 is 60 ps. In the case, the rising time of the signal is substantially equal to the width of the input pulse signal, and the falling time thereof is linear with respect to time. This is because the time interval of the input pulse signal in the above-explained operation example is sufficiently shorter than the carrier lifetime, and the carrier density after the optical amplification is recovered in the linear form.

The two continuous wave light components which have been subjected to the phase modulation and are shown in FIG. 2 will interfere with each other in the combining unit 16. As shown in FIG. 2, a phase difference between these two light components becomes substantially equal to π in a time range after the phase of the slow component starts to fall and until the phase of the fast component starts to rise. This time range is from +10 ps up to +20 ps in FIG. 2.

As described in the publication (Optical Letter, volume 23, No. 23, 1998, pages 1846 to 1848 pages), when an initial phase bias is optimized to 1.1π, the phase difference in the above-explained time range becomes completely π. As a consequence, in the above-described time range, the two components of the continuous wave light interfere with each other so that they are canceled with each other. As a result, the delay interferometer 2 can pass the continuous wave light only for the time period from when the fast light component starts to rise to when the slow light component starts to fall. The time period is from −4 ps up to +10 ps in FIG. 2.

As a result of the above-explained operation, the delay interferometer 2 cuts out the continuous wave light to generate a new pulse sequence (namely, wavelength converted output). At this time, the pulse width (full width at half maximum) is in a range of 6 to 8 ps, and the pulse signal interval is 24 ps. In the case, the wavelength of each optical pulse signal of the new pulse sequence is determined based upon the wavelength of the continuous wave light.

In the above-described operation example, the delay time of the delay interferometer 2 is substantially equal to the input pulse width. As apparent from the above-described wavelength converting operation, when the delay time of the delay interferometer 2 is longer than the input pulse width, the pulse width of the optical pulse signal of the newly generated pulse sequence is approximated to the delay time. Conversely, when the delay time of the delay interferometer 2 is shorter than the input pulse width, the pulse width of the optical pulse signal of the newly generated pulse sequence is shorter than the input pulse width.

It should be understood that while the optimum value of the initial phase bias in the operation example shown in FIG. 2 is equal to 1.1π, the optimum value of the initial phase bias in the first embodiment is equal to 1.035π. The optimum value of the initial phase bias depends upon the phase shift amount through the optical amplification, the delay time of the delay interferometer 2, the pulse signal interval of the input pulse signal, and so on. The method for estimating the optimum value of the initial phase bias and the method for monitoring the optimum condition are described in the publication (Optical Letter, volume 23, No. 23, 1998, pages 1846 to 1848), and in Japanese Patent Application No. Heisei 10-198744.

Referring back to FIG. 1, the optical pulse signal generation apparatus according to the first embodiment of the present invention is described. A portion of the circulated optical pulse signal is extracted by the optical splitter 14, and then is reached the output port 12. In the first embodiment, the output pulse signal has the pulse width of 1.5 ps, the repetition frequency of 100 GHz, the average power of 9 mW, the peak power of 60 mW, and the pulse signal energy of 90 fJ. The energy of the optical pulse signal inputted into the semiconductor optical amplifier 1 is 9 fJ, and the power of the continuous wave light is 0.5 mW.

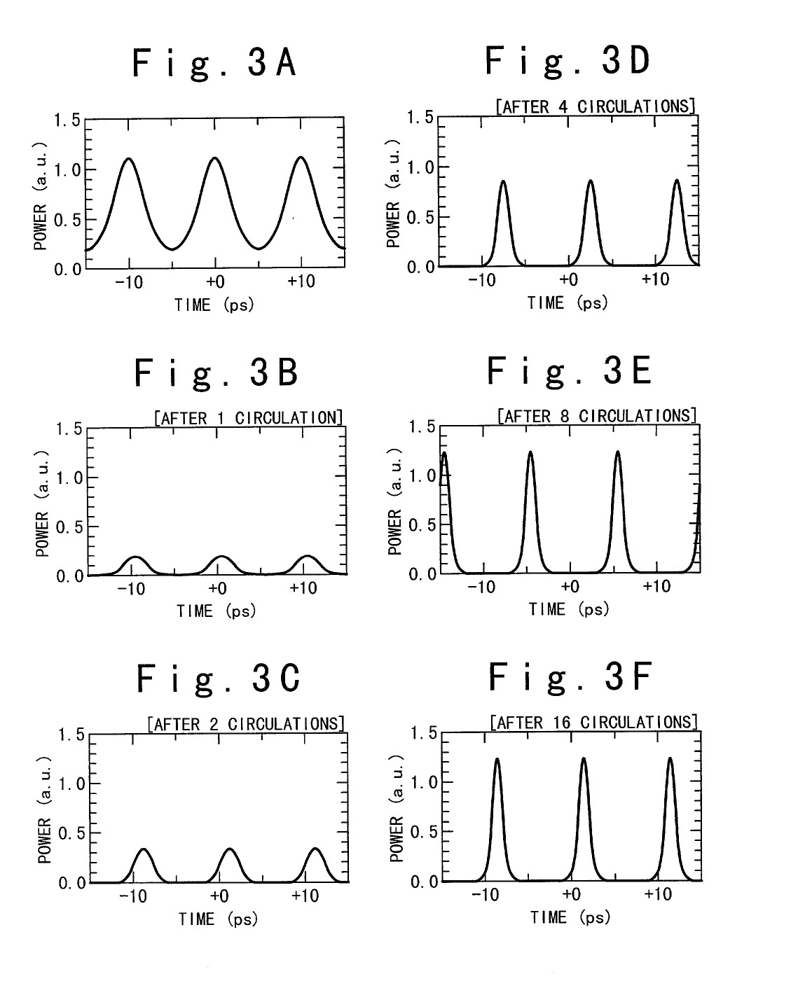

FIGS. 3A to FIG. 3F are diagrams showing operations of the optical pulse signal generation apparatus according to the first embodiment of the present invention. Referring to FIGS. 3A to 3F, a description is given of the establishment of a balanced condition in the above-described circulation.

FIGS. 3A to 3F represent the growth of an optical pulse sequence having a wide pulse width as shown in FIG. 3A in case that the optical pulse sequence is entered into the semiconductor optical amplifier 1. The optical pulse signal has the pulse width of 4.0 ps and the pulse signal interval of 10 ps. When both of the optical pulse signal and the continuous wave light pass through the semiconductor optical amplifier 1 and the delay interferometer 2, the continuous wave light is converted into the optical pulse signal in accordance with the same mechanism as the above-described wavelength converting operation.

The pulse width of the newly generated optical pulse signal shown in FIG. 3B is approximated to the delay time of the delay interferometer 2. It should be noted that since the pulse width of the original optical pulse signal is wider than the delay time, the power of the newly generated optical pulse signal is relatively low. The optical pulse signal shown in FIG. 3B corresponds to the optical pulse signal in a first circulating operation, and returns to the semiconductor optical amplifier 1. In the example, the optical pulse signal in the first circulating operation is weaker than that of the balanced condition. As a consequence, while the optical pulse sequence in the first circulating operation passes through the semiconductor optical amplifier 1, the carrier density of the semiconductor optical amplifier 1 is higher than in the balanced condition. Accordingly, the power of the optical pulse signal of the second circulating operation is increased, as compared with that in the first circulating operation, and the pulse width of the optical pulse signal of the second circulating operation is further reduced. FIG. 3C to FIG. 3F show optical pulse sequence of the second circulating operation, the fourth circulating operation, the eight circulating operation, and the 16th circulating operation. As shown in these figures, as the circulating operation of the optical pulse signal is repeated, both of the pulse width and the optical pulse signal power reaches the balanced conditions. The pulse width of the pulse sequence which has been reached the balanced condition is 1.5 ps.

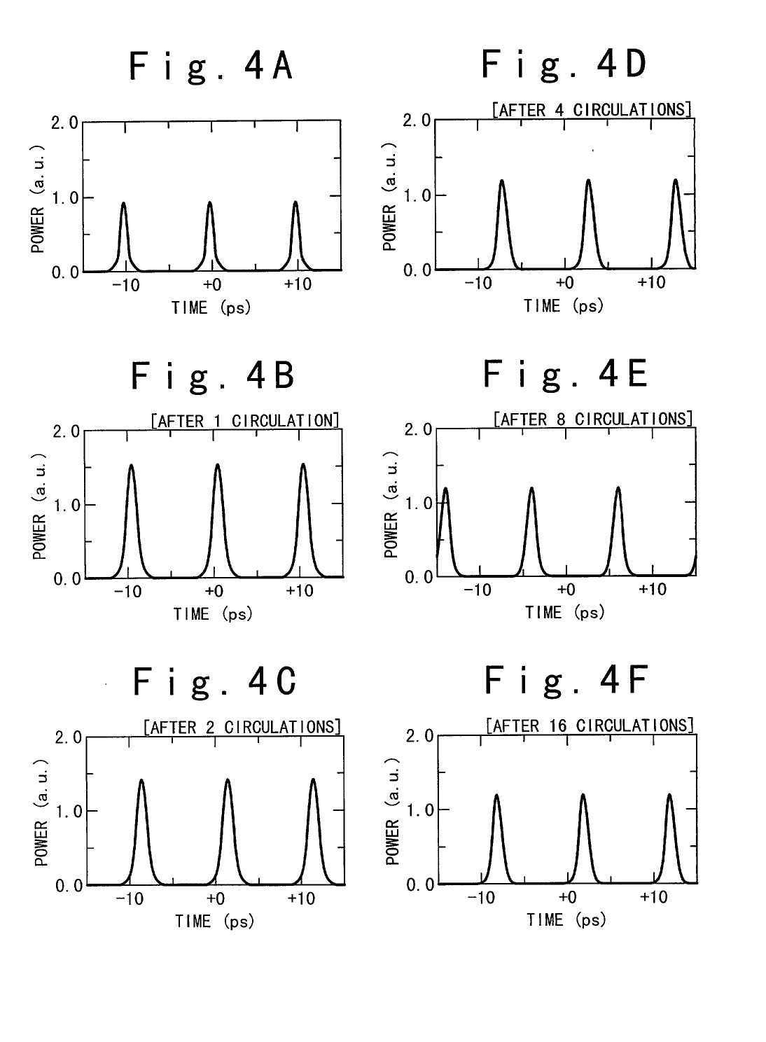

FIG. 4A to FIG. 4F are diagrams showing operations of the optical pulse signal generation apparatus according to the first embodiment of the present invention. FIG. 4 shows a transition of the optical pulse sequence having a narrow pulse width shown in FIG. 4A when the optical pulse sequence is inputted into the semiconductor optical amplifier 1. In this case, a pulse width of the optical pulse sequence is 0.8 ps and a pulse signal interval thereof is 10 ps.

A pulse width of an optical pulse signal shown in FIG. 4B in a first circulating operation is expanded to approximately 1.5 ps. As compared with the pulse signal waveforms of the balanced conditions shown in FIG. 3E and FIG. 3F, the waveform of the optical pulse signal in the first circulating operation is approximated to a trapezoid and is distorted. The power of the optical pulse signal is larger than in the balanced condition. While the optical pulse sequence in the first circulating operation passes through the semiconductor optical amplifier 1, both of the carrier density and the gain of the semiconductor optical amplifier are lower than in the balanced condition.

While the optical pulse signal is repeatedly circulated, the distortion of the pulse signal waveform is decreased, and the power thereof is lowered. Also, both of the carrier density and the gain of the semiconductor optical amplifier 1 are increased, which are approached to the balanced conditions, respectively. FIG. 4C to FIG. 4F show optical pulse sequences in the second circulating operation, the fourth circulating operation, and the sixteenth circulating operation, respectively. Also, in this case, the optical pulse sequence after the eighth circulating operation reaches the balanced conditions. A pulse signal waveform, pulse width and power of the pulse sequence under balanced conditions are the same as those shown in FIGS. 3A to 3F.

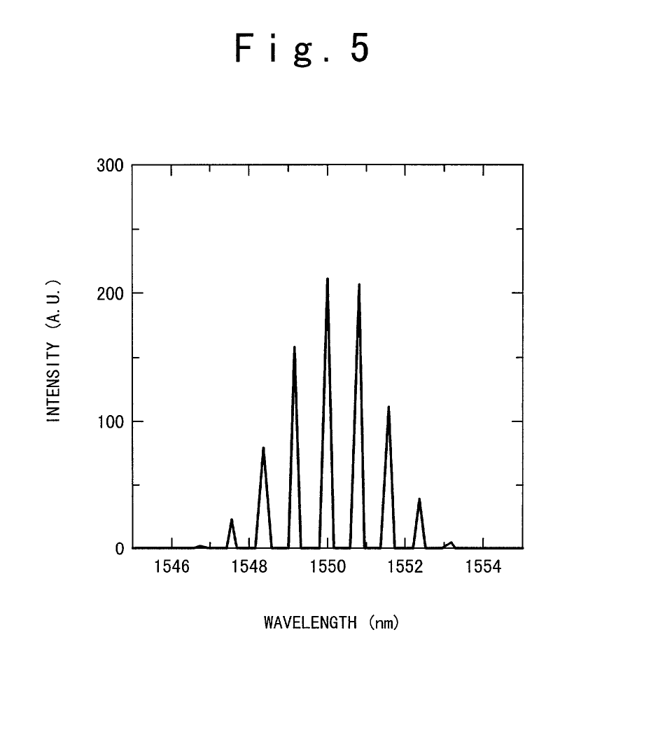

FIG. 5 is a diagram showing the operation of the optical pulse signal generation apparatus according to the first embodiment of the present invention. FIG. 5 shows a spectrum of the optical pulse sequence according to the first embodiment after a balanced condition having the pulse width of 1.5 ps and the time interval of 100 GHz. The figure shows that a longitudinal mode interval is 100 GHz (0.8 nm), and the half width of an envelope line is approximately 4 nm. Thus, a transform-limited optical pulse signal is generated.

The optical pulse signal power and the pulse signal interval of the optical pulse signal in the first circulating operation are not uniform. However, when the optical pulse signal reaches the balanced condition, the optical pulse signal power and the pulse signal interval become uniform, respectively. The 10-ps delay interferometer 7 provided in the circular optical waveguide uniformly distributes the power of the optical pulse signal, and controls the interval of the optical pulse signal to be 10 ps. The intensity branching ratio of the delay interferometer 7 may be designed to be the proper ratio of 50:50, 90:10, 95:5, 99:1, 99.9:0.1, 99.99:0.01, or 99.999:0.001, while considering the characteristic of the semiconductor optical amplifier 1.

In the case that the repetition frequency of the optical pulse signal generated from the optical pulse signal generation apparatus according to the first embodiment is required to be controlled, both of the delay interferometer 7 and the time delay 6 are subjected to feedback control, while the repetition frequency of the output optical pulse signal is monitored. The delay time between the delay interferometer 7 and the time delay 6 are finely adjusted in such a manner that the difference between the repetition frequency of the output optical pulse signal and the frequency of the clock input is zero. As a result, the optical pulse signal having the repetition frequency strictly identical to the clock frequency can be generated. In this case, the clock input power is equal to or lower than −10 dBm.

In addition to the method for monitoring a light portion of output light by a photodetector, another method is known for monitoring the injection current to the semiconductor optical amplifier 1, as the monitoring method of the output optical pulse signal frequency. The driving system of the semiconductor optical amplifier 1 is basically the DC constant current driving system. As the reaction occurred when the semiconductor optical amplifier 1 amplifies the optical pulse signal, an AC component with the frequency equal to the circulated optical pulse signal frequency is mixed with the driving current.

Alternatively, an optical intensity modulator and/or an optical phase modulator may be provided in a portion of the circular optical waveguide, if required. When modulation is carried out in the optical intensity modulator and/or the optical phase modulator by use of the clock signal, the stability in the pulse signal interval of the circulated optical pulse signal can be furthermore increased.

### Second Embodiment

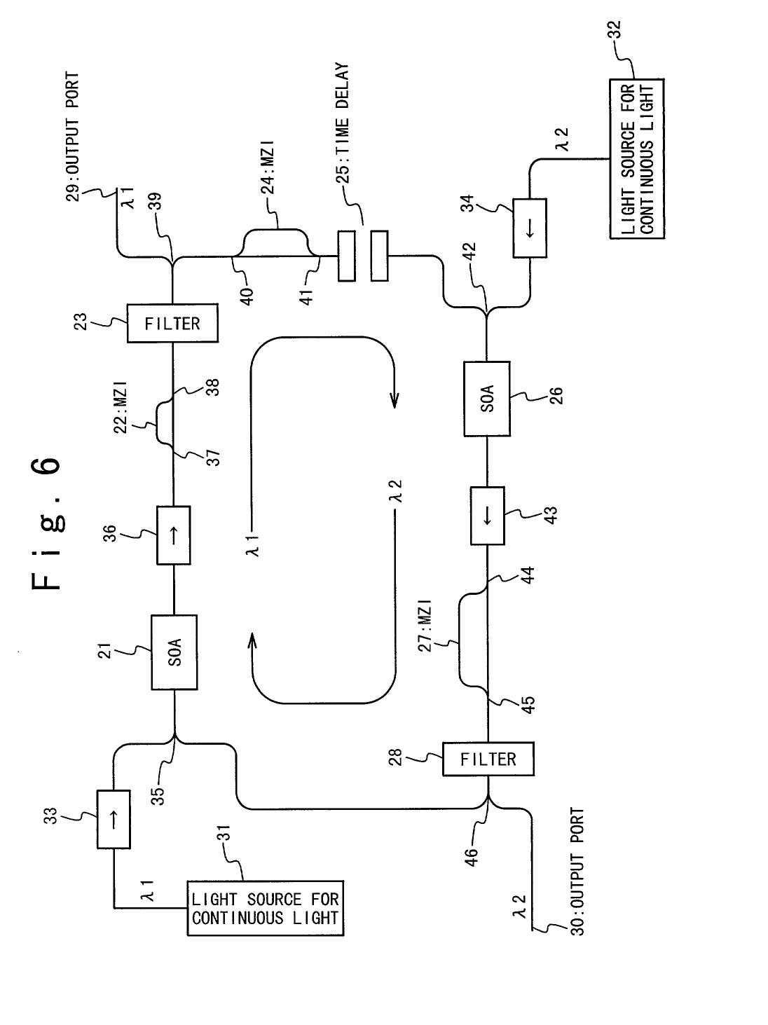

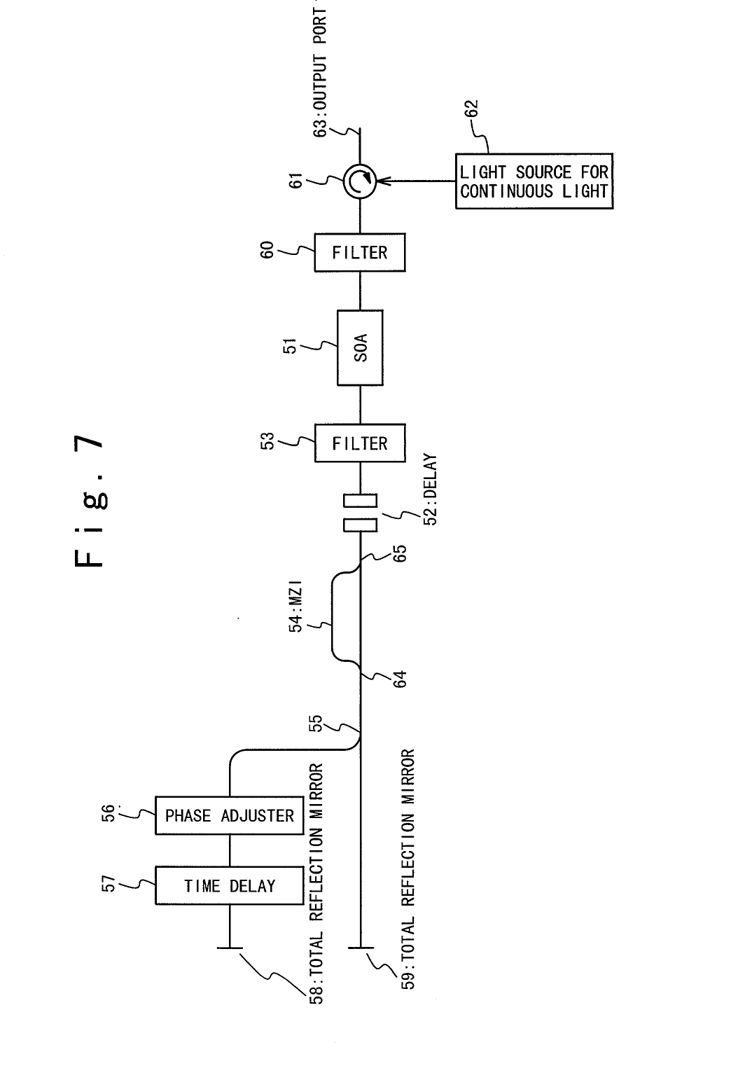

FIG. 6 is a block diagram showing the structure of the optical pulse signal generation apparatus according to the second embodiment of the present invention. In FIG. 6, the optical pulse signal generation apparatus according to the second embodiment of the present invention is composed of one set of circular optical waveguide and two sets of continuous wave light sources 31 and 32. In this case, the wavelength of the first continuous wave light source 31 is selected to be λ1, and the wavelength of the second continuous wave light source 32 is selected to be λ2. The circular optical waveguide according to the second embodiment is composed of semiconductor optical amplifiers (SOA) 21 and 26, delay interferometers (MZI) 22, 24 and 27, wavelength filters 23 and 28, a time delay 25, isolators 36 and 43, optical combiners 35, 38, 41, 42 and 45, and optical splitters 37, 39, 40, 44 and 46. The circular optical waveguide is further composed of two sets of wavelength converters.

The first wavelength converter is composed of the semiconductor optical amplifier 21, the delay interferometer 22, and the wavelength filter 23 and converts a wavelength of an input optical pulse signal from λ2 to λ1. On the other hand, the second wavelength converter is composed of the semiconductor optical amplifier 26, the delay interferometer 27, and the wavelength filter 28 and converts a wavelength of an input optical pulse signal from λ1 to λ2. Accordingly, when an optical pulse signal arrived at the semiconductor optical amplifier 21 is circulated around the circular optical waveguide once, the wavelength of the optical pulse signal is converted from λ2 to λ1, and then converted from λ1 to λ2. Thus, the wavelength-converted optical pulse signal returns to the semiconductor optical amplifier.

The center wavelength of the wavelength filter 23 is λ1, and the center wavelength of the wavelength filter 28 is λ2. The respective wavelength filters 21 and 28 allow the newly generated optical pulse signals to pass therethrough, and prevent the amplified old optical pulse signals and ASE. It should be noted that the structure and operation of the delay interferometer 24 are the same as those of the delay interferometer 7 according to the first embodiment of the present invention. Also, the structure and operation of the time delay 25 are the same as those of the time delay 6 according to the first embodiment of the present invention.

Similar to the first embodiment of the present invention, the above-described optical pulse signal generation apparatus in the second embodiment spontaneously generates an optical pulse sequence, and the optical pulse sequence having the pulse width of 1.5 ps and the repetition frequency of 100 GHz is circulated in the circular optical waveguide. The optical pulse signal generation apparatus in the second embodiment is composed of two sets of output ports 29 and 30. The optical pulse signal having the wavelength of λ1 is outputted from an output port 29, whereas, the optical pulse signal having the wavelength of λ2 is outputted from an output port 30.

It should also be noted that the continuous wave light supplied from the continuous wave light source 31 is entered into the circular optical waveguide via an isolator 33 and the continuous wave light supplied from the continuous wave light source 32 is entered into the circular optical waveguide via the isolator 34.

### Third Embodiment

FIG. 7 is a block diagram showing the structure of an optical pulse signal generation apparatus according to the third embodiment of the present invention. In FIG. 7, the optical pulse signal generation apparatus according to the third embodiment of the present invention is composed of one set of circular optical waveguide and one set of continuous wave light source 62. Different from the first and second embodiments, the optical pulse signal generation apparatus according to the third embodiment of the present invention has a circular optical waveguide arranged in a straight line form. The circular optical waveguide according to the third embodiment is composed of a semiconductor optical amplifier (SOA) 51, a delay interferometer (MZI) 54, wavelength filters 53 and 60, time delays 52 and 57, an optical circulator 61, a phase adjusting unit 56, optical splitters 55 and 65, total reflection mirrors 58 and 59, and an optical combiner 64.

The time taken for light to propagate from the optical splitter 55 to the total reflection mirror 58 via the phase adjusting unit 56 and the time delay 57 is different from the time taken for light to propagate from the optical splitter 55 to the total reflection mirror 59. In the third embodiment, the time difference is set to 0.89 ps, and the delay time of the delay interferometer 54 is set to 10.0 ps.

Similar to the first embodiment of the present invention, the above-described optical pulse signal generation apparatus in the first embodiment spontaneously generates an optical pulse sequence, and the optical pulse sequence having the pulse width of 1.5 ps and the repetition frequency of 100 GHz is circulated in the circular optical waveguide. First, the continuous wave light emitted from the continuous wave light source 62 reaches the semiconductor optical amplifier 51 via the optical circulator 61 and a filter 60. An optical pulse signal entered from the left side of the figure into the semiconductor optical amplifier 51 modulates the phase and intensity of the continuous wave light entered from the right side thereof to the semiconductor optical amplifier 51. The continuous wave light modulated in both of the phase and the intensity is branched into two light components by the optical splitter 55. The first light component is reflected by the total reflection mirror 58, and then returns to the optical splitter 55. The second light component is reflected by the total reflection mirror 59, and then returns to the optical splitter 55. The first light component and the second light component, which have returned to the optical splitter 55 are interfered with each other.

The traveling time of the first light component required until the first light component returns to the optical splitter 55 after the first light component is outputted from the optical splitter 55 is longer than that of the second light component by 1.78 ps (otherwise, shorter). In other words, the function of a portion of the optical circuit from the optical splitter 55 to the total reflection mirrors 58 and 59 is the same as that of the delay interferometer of the first embodiment of the present invention. As a consequence, when the continuous wave light modulated in phase and intensity by the semiconductor optical amplifier 51 interferes with each other in the optical demodulator 55, a new optical pulse signal is generated. The newly generated optical pulse signal is reaches the semiconductor optical amplifier 51 via the delay interferometer 54, the time delay 52, and the wavelength filter 53.

On the other hand, the amplified optical pulse signal is traveled from the semiconductor optical amplifier 51 to the right side of the figure. The amplified optical pulse signal is taken out from the output port 63 via the wavelength filter 60 and the optical circulator 61. Both of the wavelength filters 53 and 60 allow the optical pulse signal to pass therethrough, and remove ASE of the semiconductor optical amplifier 51.

It should also be noted that the operation of the delay interferometer 54 is the same as that of the delay interferometer 7 according to the first embodiment and that of the delay interferometer 24 according to the second embodiment. The delay interferometer 54 uniformly distributes power of the optical pulse signal, and controls the interval of the optical pulse signal to be 10 ps. Furthermore, the operation and function of the time delay 52 are the same as those of the time delay 6 according to the first embodiment and that of the time delay 25 according to the second embodiment of the present invention.

### Fourth Embodiment

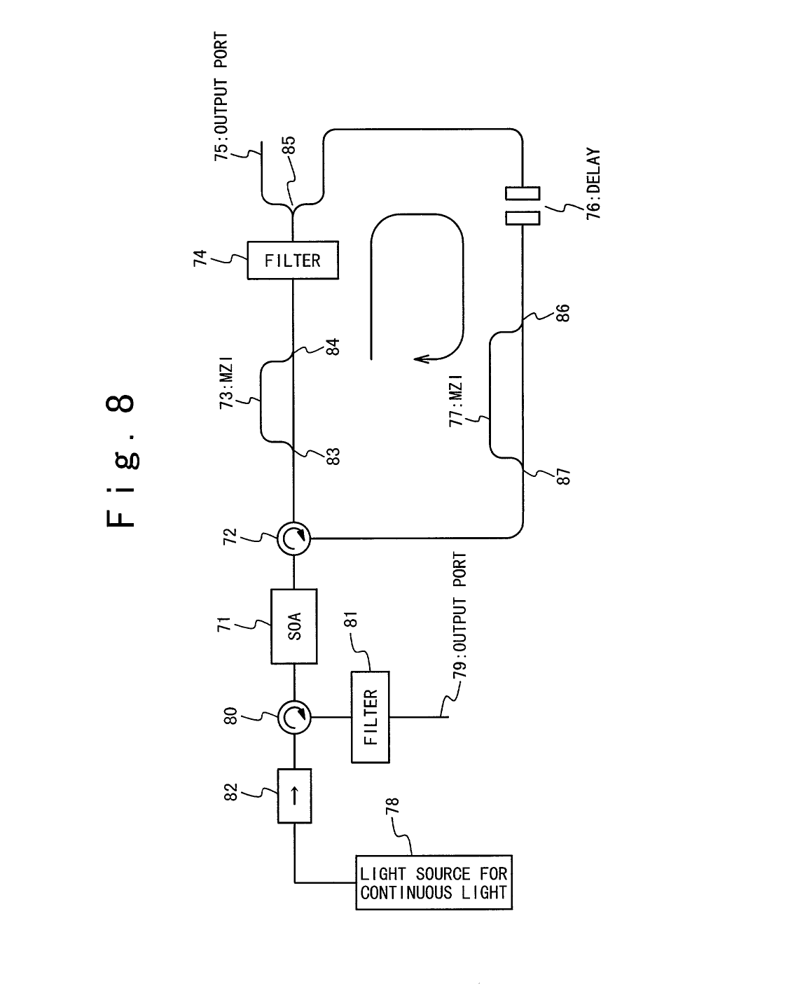

FIG. 8 is a block diagram showing the structure of the optical pulse signal generation apparatus according to the fourth embodiment of the present invention. In FIG. 8, the optical pulse signal generation apparatus according to the fourth embodiment of the present invention is composed of one set of circular optical waveguide and one set of continuous wave light source 78. The circular optical waveguide according to the fourth embodiment is composed of a semiconductor optical amplifier (SOA) 71, delay interferometers (MZI) 73 and 77, a wavelength filter 74, a time delay 76, an optical circulator 72, optical combiners 83, 85 and 86, and optical splitters 84 and 87.

The delay time of the delay interferometer 72 in the fourth embodiment is selected to be 1.78 ps, and the operation of the delay interferometer 72 is the same as that of the delay interferometer 2 according to the first embodiment of the present invention. Also, the delay time of the delay interferometer 77 in the fourth embodiment is selected to be 10.0 ps, and the operation of the delay interferometer 77 is the same as that of the delay interferometer 7 according to the first embodiment of the present invention.

Similar to the first embodiment of the present invention, the above-described optical pulse signal generation apparatus spontaneously generates an optical pulse sequence, and the optical pulse sequence having the pulse width of 1.5 ps and the repetition frequency of 100 GHz is circulated in the circular optical waveguide. The continuous wave light emitted from the continuous wave light source 78 reaches the semiconductor optical amplifier 71 via the optical circulator 80 and an optical isolator 82. An optical pulse signal entered from the left side of the figure into the semiconductor optical amplifier 71 modulates in phase and intensity the continuous wave light entered from the right side to the semiconductor optical amplifier 71.

When the continuous wave light modulated in phase and intensity travels toward the right side. When the modulated continuous wave light passes through the optical circulator 72 and the delay interferometer 72, the continuous wave light is converted into a new optical pulse signal. The new optical pulse signal is propagated via the time delay 76, the delay interferometer 77, and the optical circulator 72, and then, returns to the semiconductor optical amplifier 71. On the other hand, the optical pulse signal amplified by the semiconductor optical amplifier 71 reaches the output port 79 via the optical circulator 80 and the wavelength filter 81.

The wavelength filters 74 and 81 both remove ASE outputted from the semiconductor optical amplifier 71. The operation and function of the time delay 76 are the same as those of the time delay 6 according to the first embodiment of the present invention. Also, the operation and function of the delay interferometer 77 are the same as those of the time interferometer 7 according to the first embodiment of the present invention.

It should also be noted that the above-described delay interferometers 7, 27, and 77 shown in the first embodiment (FIG. 1) of the present invention, the second embodiment (FIG. 6), and the fourth embodiment (FIG. 8) of the present invention are not always required, but may be omitted. Further, in the optical pulse signal generation apparatus according to the third embodiment (FIG. 7) of the present invention, the circuit portion corresponding to the second arm of the delay interferometer 54 from the branching unit 55 to the total reflection mirror 59 is not always needed, but may be omitted.

The optical pulse signal is generated under the optimal condition and the better efficiency condition from the wavelength converter portion of the optical pulse signal generator of the present invention. The generated optical pulse signal is approximated to the limitation of the Fourier transformation. The above fact is reported in the publication (Jpn. Journal of Applied physics, volume 38, part 2, No. 11A, November in 1999, pages L1243 to 1245). Therefore, the optical pulse signal generated by the optical pulse signal generator of the present invention is the optical pulse signal having a better quality, which is approximated to the Fourier transformation limit. The function of the wavelength filter in the optical pulse signal generator of the present invention is to remove the old optical pulse signal and ASE. Even when the range of the wavelength filter is widened, the Fourier transformation limit characteristic is not deteriorated.

One of the necessary conditions required for the optical pulse signal generated by the optical pulse signal generator of the present invention to continue to circulate in the circular optical waveguide is that the circulating operation loss in the circular optical waveguide is zero. Therefore, the semiconductor optical amplifier having a gain larger than a total of the losses the respective optical components of the circular optical waveguide is used. Also, an optical attenuator provided in a portion of the circular optical waveguide is adjusted such that the circulating operation loss is zero. The optical attenuator is omitted in above-described descriptions of the first to fourth embodiments. Alternatively, it is possible to adjust the circulating operation loss to zero by providing a semiconductor optical amplifier having a small gain and by using an optical fiber type optical amplifier provided in a proper portion of the circular optical waveguide and having a large gain.

### Fifth Embodiment

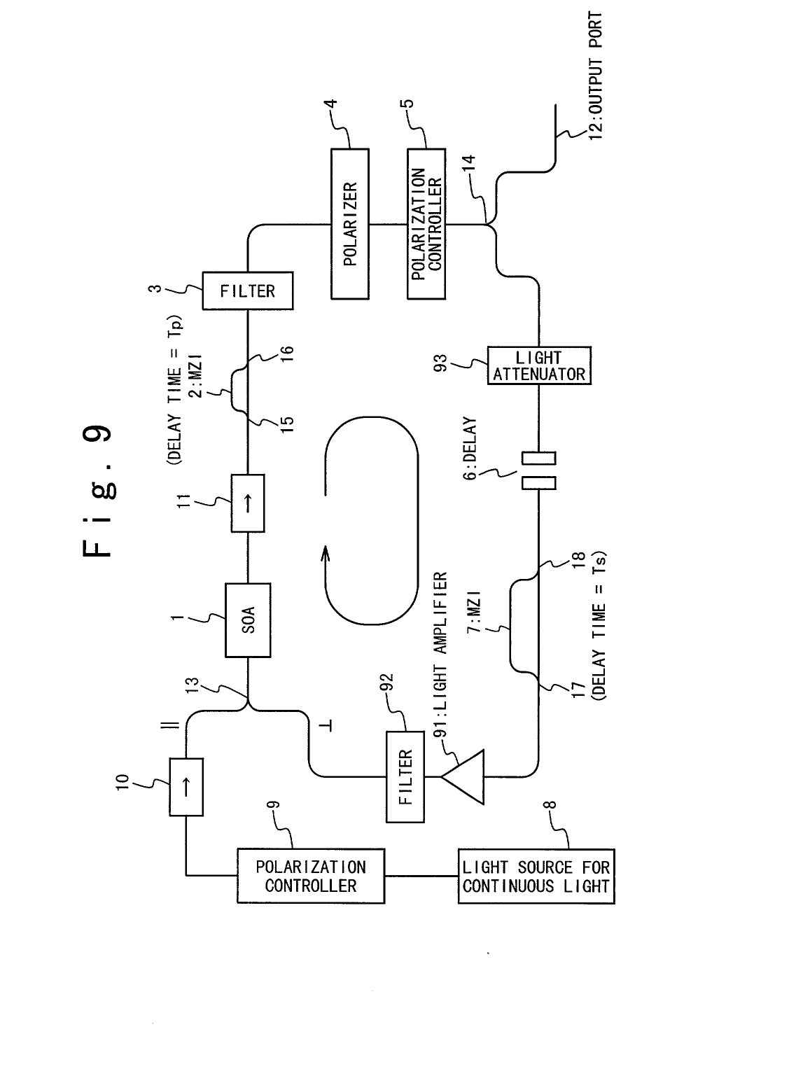

FIG. 9 is a block diagram showing the structure of an optical pulse signal generation apparatus according to the fifth embodiment of the present invention. Referring to FIG. 9, the structure of the optical pulse signal generation apparatus according to the fifth embodiment of the present invention is similar to the structure of the optical pulse signal generation apparatus according to the first embodiment. In the optical pulse signal generation apparatus in the fifth embodiment, an optical fiber type optical amplifier 91 and a band pass wavelength filter 92 for removing ASE of the optical fiber type optical amplifier 91, and an optical attenuator 93 are further added. It should be noted that the same reference numerals shown in the first embodiment are allocated to the same components in the fifth embodiment as those in the first embodiment. In this case, the operation of the component with the same reference numeral is the same as that of the corresponding component in the first embodiment of the present invention. Both of the optical fiber type optical amplifier 91 and the band-pass wavelength filter 92 are arranged between the delay interferometer 7 and the optical combiner 13, and the optical attenuator 93 is arranged between the time delay 6 and the optical splitter 14.

### Sixth Embodiment

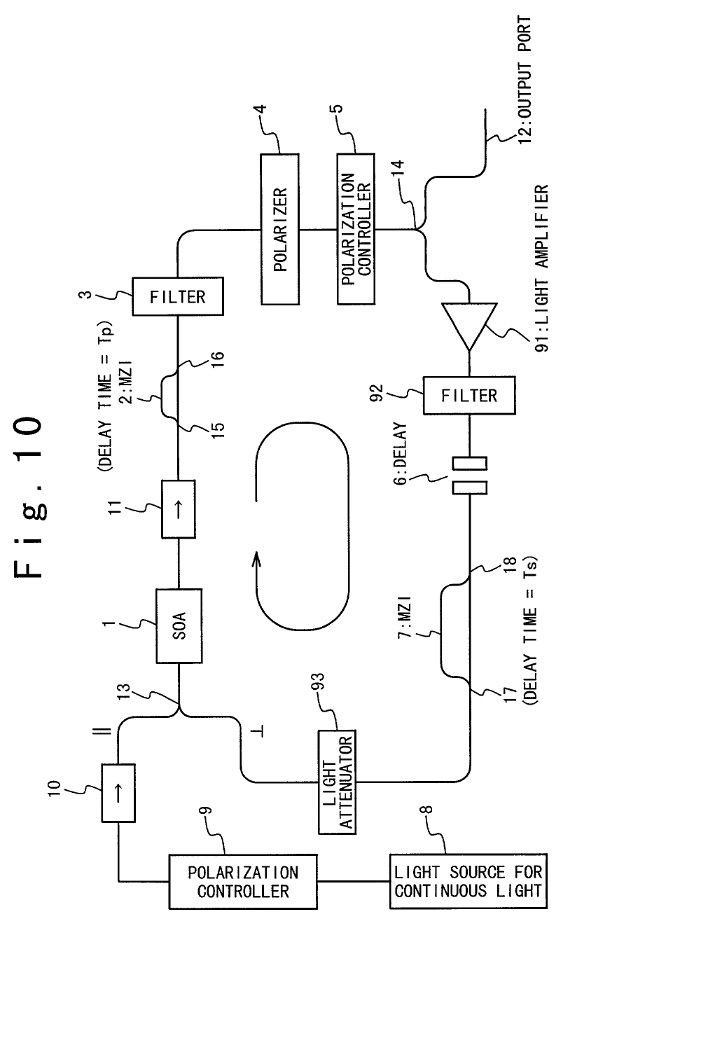

FIG. 10 is a block diagram showing the structure of an optical pulse signal generation apparatus according to the sixth embodiment of the present invention. Referring to FIG. 10, the structure of the optical pulse signal generation apparatus according to the sixth embodiment of the present invention is the same as that of the optical pulse signal generation apparatus according to the fifth embodiment except for the arrangement of the optical fiber type optical amplifier 91, the band pass wavelength filter 92, and the optical attenuator 93.

Both of the optical fiber type optical amplifier 91 and the band pass wavelength filter 92 are arranged between the delay 6 and the optical splitter 14, and the optical attenuator 93 is arranged between the time interferometer 7 and the optical combiner 13.

The optical fiber type optical amplifier 91 may be inserted into any portion within the circular optical waveguide, as shown in the sixth embodiment of the present invention shown in FIG. 10. However, the optical fiber type optical amplifier 91 should not be inserted between the semiconductor optical amplifier 1 and the band pass wavelength filter 3. If the optical fiber type optical amplifier 91 is inserted between the semiconductor optical amplifier 1 and the band pass wavelength filter 3, then the optical fiber type optical amplifier 91 amplifies ASE of the semiconductor optical amplifier 1 to increase noise.

### Seventh Embodiment

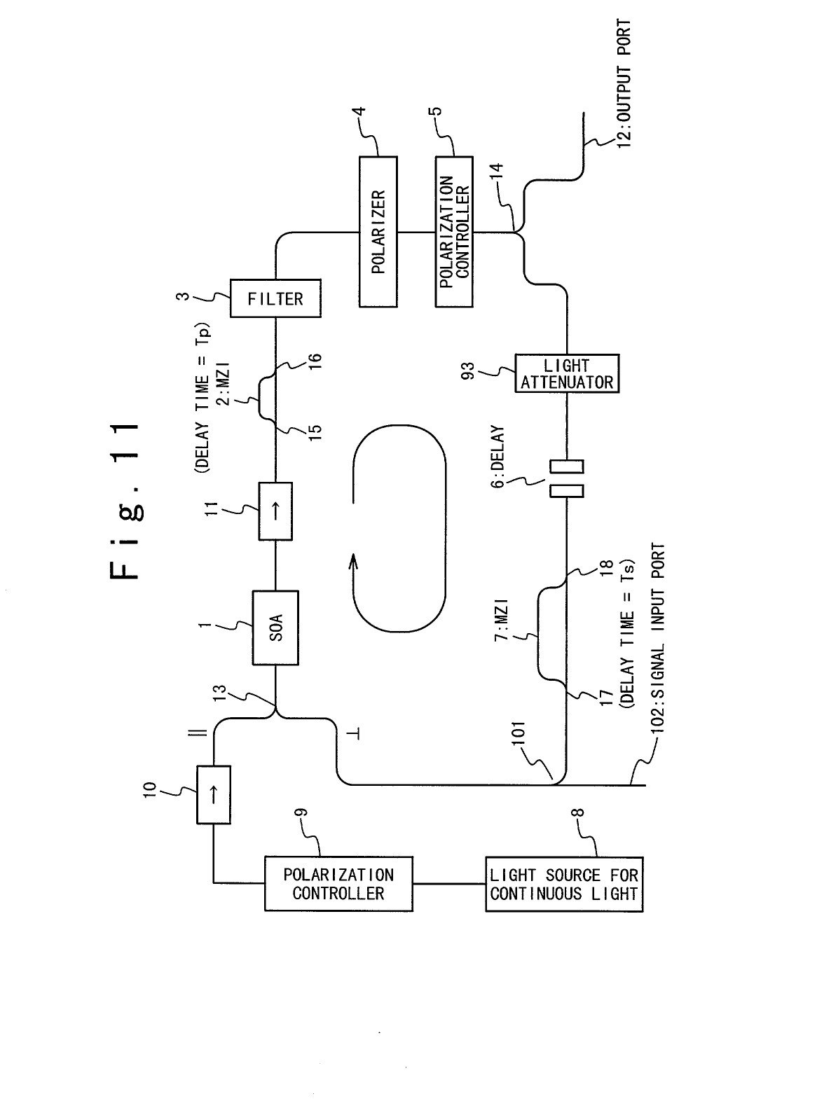

FIG. 11 is a block diagram showing the structure of an optical clock extraction apparatus according to the seventh embodiment of the present invention. Referring to FIG. 11, the optical clock extraction apparatus, according to the seventh embodiment of the present invention is composed of a single input port 102 and an optical combiner 101 in addition to the structure of the optical pulse signal generation apparatus according to the first embodiment of the present invention.

An input signal is entered into the circular optical waveguide via both of the signal input port 102 and the optical combiner 101, and then is combined or multiplexed with an optical pulse signal circulating in the circular optical waveguide. An optimum value of a synthesis ratio of the input signal to the optical component circulating in the circular optical waveguide depends upon the characteristic of the semiconductor optical amplifier 1. Therefore, the synthesis ratio is selected in consideration to the characteristic of the semiconductor optical amplifier 1. It is preferable that a nonlinear phase shift amount by which light passing through the semiconductor optical amplifier 1 is phase-shifted is in a range of 0.5π to 1.2π. The nonlinear phase shift amount in the seventh embodiment of the present invention is set to 0.7π.

The optical clock extraction apparatus according to the seventh embodiment of the present invention generates an optical clock having the frequency equal to the frequency of the input signal, and then outputs the optical clock to the output port 12. Similar to the above-described optical pulse signal generation apparatus of the present invention, the pulse width of the optical clock pulse signal is substantially equal to the delay time (Tp) of the delay interferometer 2, and the pulse signal interval of the optical clock pulse signal is substantially equal to the delay time (Ts) of the delay interferometer 7.

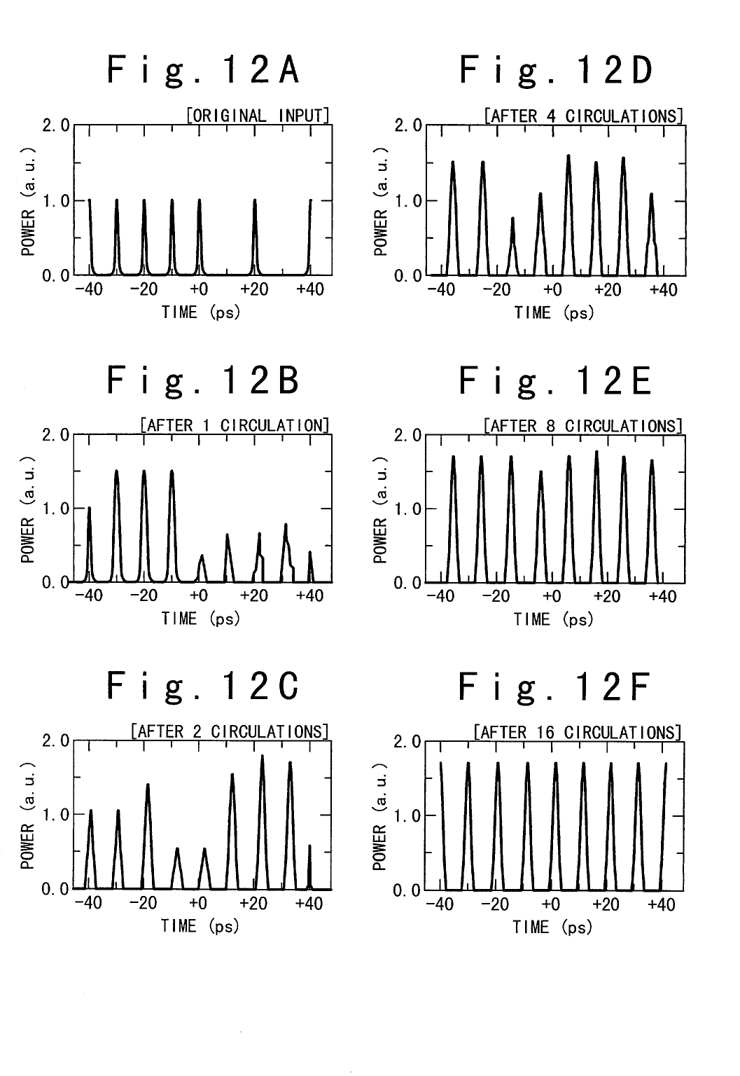

FIG. 12A to FIG. 12F are diagrams showing a basic operation of the above-described optical clock extraction apparatus according to the seventh embodiment of the present invention. Referring now to FIG. 12, the operation when the optical clock extraction apparatus in the seventh embodiment, which receives an input signal extracts an optical clock is will be described below.

FIG. 12A shows an example of an input signal. The input signal has the 8-bit period of “11110101”, the pulse width of 1.5 ps and the repetition frequency of 100 GHz.

FIG. 12B shows a simulation result of the waveform of the optical pulse signal which has circulated once around the circular optical waveguide. When the input optical signal passes through the delay interferometer 7, the delay interferometer 7 distributes a portion of power at the “1” bit position to a position neighbor to the “1” bit position. Therefore, a weak optical pulse signal is grown at the “0” bit position.

FIG. 12C to FIG. 12F show the waveforms of the optical pulse signal in the second circulating operation, the fourth circulating operation, the eight circulating operation, and the 16th circulating operation, respectively. As shown in these figures, when the optical pulse signal is circulated in the circular optical waveguide in a range of eight times to sixteen times, optical clock pulse signals are generated to have uniform pulse intensity. The pulse width of the generated optical clock pulse signal is approximately 1.5 ps, and the quenching ratio of the generated optical clock pulse signal is as large as equal to or larger than 30 dB.

FIG. 12 shows that the clock extraction apparatus of the present invention has the function to generate an optical clock pulse sequence signal, using the input optical signal as a seed. It should be understood that FIG. 12A to FIG. 12F show the simulation results of the optical clock extraction apparatus using a simplified simulation procedure. That is to say, first of all, it is supposed that the input signal shown in FIG. 12A starts from an optical combiner 101 toward another optical combiner 13, and then returns again to the optical combiner 101 via the semiconductor optical amplifier 1.

It is also supposed that the length of the input signal is the length filling the circular optical waveguide, namely, equal to or larger than 50 bits, and a new input signal pulse is not added to the optical pulse signal which has returned to the optical combiner 101. In other words, it is now supposed that the optical pulse signal, which has returned to the optical combiner 101, travels to the optical combiner 13 again, as it is, and then continues to circulate in the circular optical waveguide.

As previously described, when the operation of the optical pulse signal extracting apparatus is simplified and thereafter is simulated, the circulating pulse sequence other than several tens bits at the head portion shows the repetition waveform of an 8-bit period. For the simplification of the description, the waveforms shown in FIG. 12B to FIG. 12F are the repetition waveform portions of the 8-bit period. Although the head portion of the circulating pulse sequence shows a slightly strange behavior, an optical clock pulse signal having a high purity can be obtained after the circulating pulse sequence is circulated in the circular optical pulse sequence in a range of eight times to about thirty two times. When an actual digital signal having a considerably higher random characteristic than that of the 8-bit period, the optical clock having the high purity can be generated less than the number of times of the circulation in the above-described example.

Referring to FIG. 12, an actual operation of the optical clock extraction apparatus according to the seventh embodiment of the present invention will be described. In the circular optical waveguide of the actual optical clock extraction apparatus, an input optical signal is continuously entered from the optical combiner 101. Even when the input optical signal is continuously entered from the optical combiner 101, the synthesis ratio of the input optical signal to the circulating optical component is sufficiently reduced, so that the intensity of each of the pulse signals contained in the circulating optical pulse sequence can be made uniform, as shown in FIG. 12F.

Thereafter, when the phase of the input optical signal jumps at a certain time, the optical clock extraction apparatus of the present invention has the function shown in FIG. 12 and commences to generate the optical clock sequence having the phase coincident with the phase of a new input optical signal. As shown in FIG. 12, the time duration required until the new optical clock sequence is generated after the phase of the input signal jumps is as short as the time duration during which the optical pulse sequence circulates in the circular optical waveguide in a range of eight times to sixteen times.

On the other hand, when a jitter component of each pulse of the input signal after a certain time is increased, the optical clock extraction apparatus of the present invention has the function shown in FIG. 12 commences to generate a clock pulse sequence having the phase coincident with the averaged phase of an input signal. In other words, even when the pulse signal interval of the input signal is fluctuated, the optical clock extraction apparatus of the present invention can output a clock pulse sequence having a constant interval.

As a consequence, the optical clock extraction apparatus of the present invention has the function to remove the jitter component contained in the input signal. The time period required to generate the optical clock sequence containing less jitter components by the optical clock extraction apparatus of the present invention is substantially equal to the time period during which the optical pulse sequence circulates in the circular optical waveguide in a range of eight times to sixteen times.

As one example, a clock generating time is estimated in an optical clock extraction apparatus having a circular optical waveguide with the optical length of one meter and the average group velocity refractive index of 1.5. At this time, the clock generating time is about 60 ns. When the circular optical waveguide is manufactured in the form of an optical integrated circuit so as to shorten the optical length to 10 cm, the clock generating time can be further reduced to approximately 6 ns. As a consequence, the minimum number of bits of the input signal which is required for the optical IC type clock extraction apparatus to extract the optical clock becomes 600 bits, when the signal bit rate is selected to be 100 Gbps.

Moreover, when the frequency of the input signal is changed after a certain time, the optical clock extraction apparatus with the function shown in FIG. 12 of the present invention starts to generate a clock pulse sequence having the frequency coincident with the average frequency of the input signal. The time duration required to generate the optical clock sequence having the new frequency by the optical clock extraction apparatus of the present invention can depend upon a change amount of the frequency. The time duration is shorter than the time duration when the optical pulse sequence circulates in the circular optical waveguide when the frequency change amount is sufficiently small.

It should be understood that the frequency range of the input signal to which the optical clock extraction apparatus of the present invention can follow is in a frequency range of about ±1×10⁻². This frequency trackable range is considerably wider than that of a fiber ring laser. In case of the fiber ring laser, the Q value of a ring resonator is very large, and a variation range of a characteristic frequency, namely, repetition frequency of the laser pulse signal is very narrow.

In case of the optical clock extraction apparatus of the present invention, the same optical pulse signal does not continue to circulate, but the old pulse signal is replaced by the new pulse signal in the wavelength converter portion. Since the incoherent carrier density change has a relation to the optical pulse signal replacing process, the effective Q value of the circular optical waveguide of the present invention is considerably smaller than that of the ring resonator of the fiber ring laser. This is a main reason why the frequency trackable range is wide.

Furthermore, the delay time between the time delay 6 and the delay interferometer 7 may be adjusted in a mechanical manner, in an electrical manner, or in a thermal manner. In this case, the optical clock extraction apparatus of the present invention can generate an optical clock pulse signal which can follow a wider frequency range of an input signal.

All of the light components pass through the semiconductor optical amplifier 1 of the optical clock extraction apparatus of the seventh embodiment of the present invention and then are propagated into the same direction. Therefore, different from the sixth conventional clock extraction apparatus, the optical clock extraction apparatus according to the seventh embodiment of the present invention can generate the optical clock pulse sequence having the shorter pulse width than the transmission time “Ttr” through the semiconductor amplifier 1. Furthermore, when the delay time of the delay interferometer 2 is made short in the optical clock extraction apparatus according to the seventh embodiment of the present invention, it is possible to generate an optical clock pulse signal having a narrower width than the pulse width of the input signal.

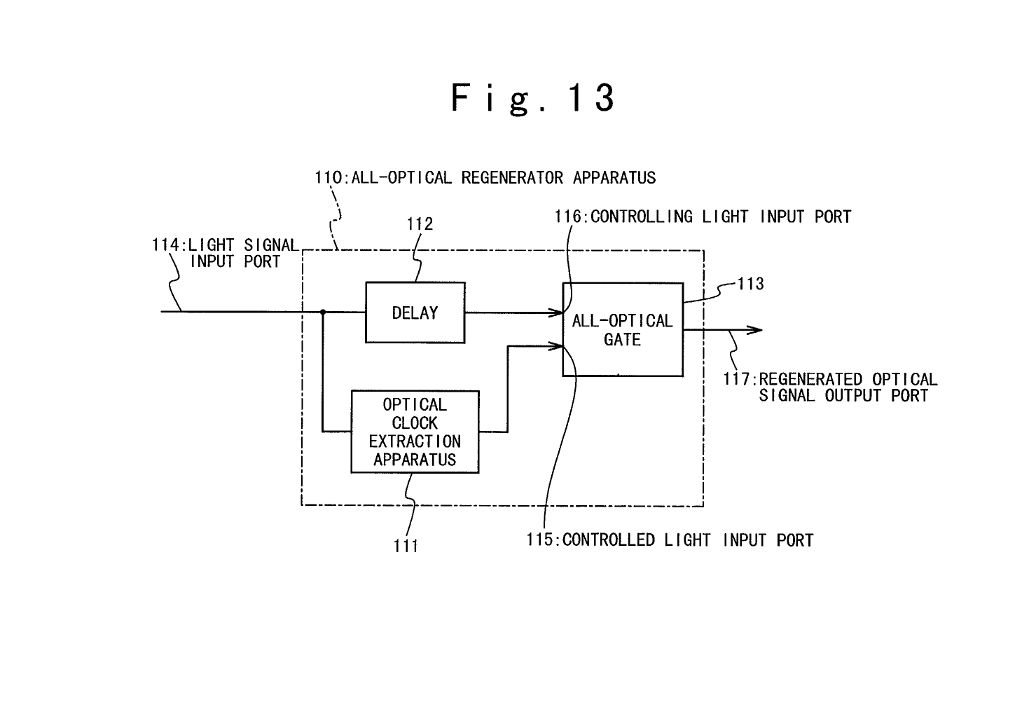

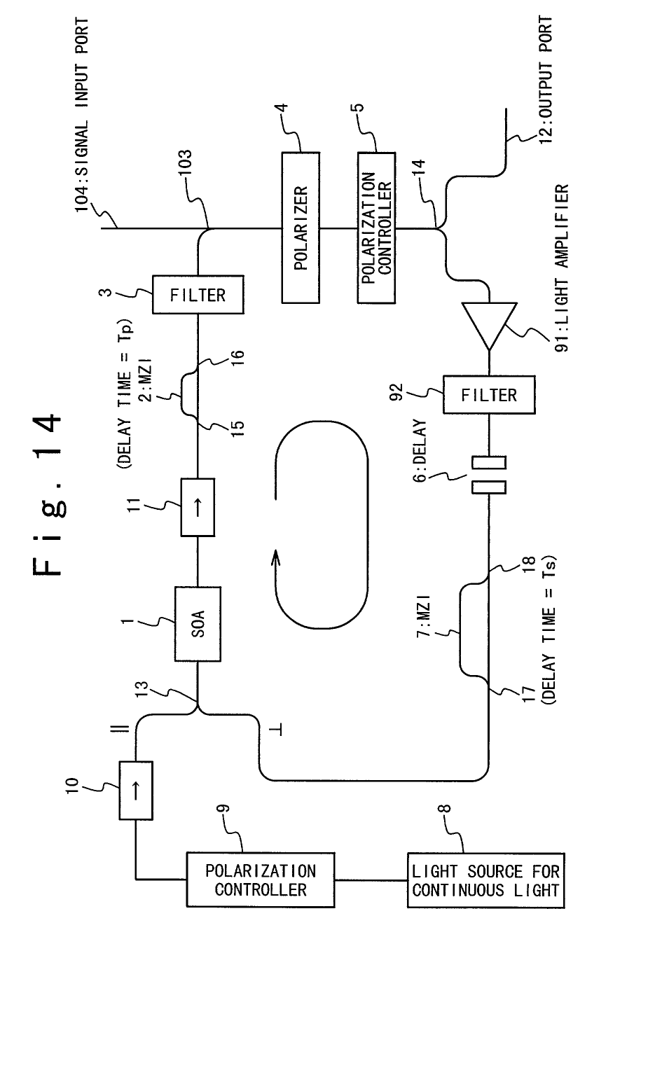

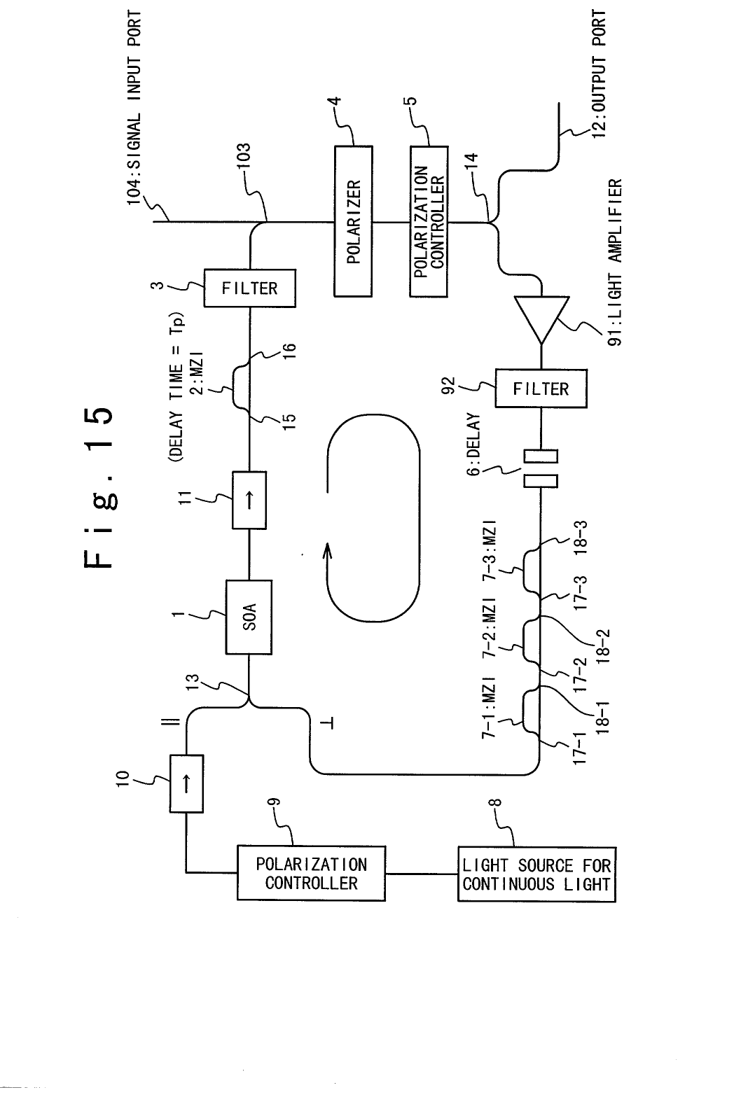

FIG. 13 is a block diagram showing the structure of an optical signal regeneration apparatus which utilizes the optical clock extraction apparatus of the present invention. In FIG. 13, the optical signal regeneration apparatus 110 is composed of an optical clock extraction apparatus 111, a delay 112, and an all-optical gate 113.

A portion of an input optical signal entered from an input optical signal port 114 is supplied to the all-optical gate 113 via both of the delay 112 and a control light input port 116 so as to control the all-optical gate 113. When a portion of the input optical signal is equal to “0”, the all-optical gate 113 is closed. Contrary, when a portion of the input optical signal is equal to “1”, the all-optical gate 113 is opened for a predetermined time period. The time duration during which the all-optical gate 113 is opened, i.e., so-called “switch window width” is set to approximately 20% to 100% of the signal pulse signal interval by use of a delay inside the all-optical gate 113.

Another portion of the input optical signal is converted into an optical clock pulse sequence via the optical clock extraction apparatus 111. Then, the optical clock pulse sequence is entered to the all-optical gate 113 via a controlled light input port 115. As a result, an output signal outputted from the all-optical gate 113 to a regenerated optical signal output port 117 is a digitally coded optical signal, similar to the input optical signal. In this way, the respective optical pulse signals of the regenerated output optical signal is a portion of the optical clock sequence which is regenerated by the optical clock extraction apparatus 111. Thus, a jitter component in the output optical signal is smaller than the input optical signal.

Examples of the all-optical gate 113 suitable for the optical signal regeneration apparatus 110 shown in FIG. 13 are described in, for instance, Japanese Patent No. 2531443, Japanese Patent No. 2629624, the publication (IEEE Photonics Technology Letters, volume 10, No. 11, 1998, pages 1575 to 1577), the publication (Laser Research, volume 27, No. 4, 1999, pages 257 to 261), the publication (Electronics Letters, volume 35, No. 23, 1999, pages 2030 to 2031), and the publication (Japanese Applied Physics Institute Lecture Paper No. 3, No. 3p-ZB-8, 1999, page 1013).

Also, the above-described all-optical switch is utilized in the optical signal regeneration apparatus described in the publication (Technical Digest of the 23rd European Conference on Optics Communication (ECOC '97), volume 2, 1997, pages 269 to 272), the publication (Electronics Letters, volume 34, No. 24, 1998, pages 2340 to 2342), and the publication (Electronics Letters, volume 35, No. 17, 1999, pages 1477 to 1478). These optical signal regeneration apparatuses can reduce not only the jitter components of the input signals, but also the intensity noise. In these publications is described the fact that when a non-linear phase shift within the all-optical switch is set to π, the intensity noise is suppressed based on the sine function transmission characteristic of the interferometer provided in the all-optical switch.

The setting position of the optical combiner for connecting the signal input port of the clock extracting apparatus according to the present invention can be freely selected to any positions other than the portion from the semiconductor optical amplifier 1 of the circular optical waveguide to the delay interferometer 2.

### Eight Embodiment

FIG. 14 is a block diagram showing the structure of the optical clock extraction apparatus according to an eighth embodiment of the present invention. Referring to FIG. 14, the optical clock extraction apparatus according to the eighth embodiment of the present invention has the same structure as that of the optical clock extraction apparatus according to the seventh embodiment of the present invention. However, the optical clock extraction apparatus in the eighth embodiment is different from that of the optical clock extraction apparatus in the seventh embodiment in that a signal input port 104 and an optical combiner 103 are provided at positions different from those of the optical clock extraction apparatus in the seventh embodiment, and an optical fiber type optical amplifier 91 is further provided. It should be noted that the same structural elements as those of the eighth embodiment are allocated the same reference numerals. Also, the operations of the same structural elements are same between the seventh embodiment and the eighth embodiment. Furthermore, the operations of the optical clock extraction apparatus according to the eight embodiment of the present invention are similar to those of the optical clock extraction apparatus according to the seventh embodiment of the present invention.

### Ninth Embodiment

FIG. 15 is a block diagram showing the structure of an optical clock extraction apparatus according to a ninth embodiment of the present invention. Referring to FIG. 15, the optical clock extraction apparatus according to the ninth embodiment of the present invention has basically the same structure as that of the optical pulse signal generation apparatus according to the first embodiment of the present invention. However, the optical clock extraction apparatus in the ninth embodiment is different from the optical pulse signal generation apparatus in the first embodiment in that a signal input port 104 and an optical combiner 103 are added, and the delay interferometer 7 is replaced by three stages of delay interferometers 7-1 to 7-3. It should be noted that the same structural elements of the ninth embodiment as those of the first embodiment are allocated with the same reference numerals shown in the first embodiment. Also, the operations of the same structural elements are same as those of the corresponding structural elements in the first embodiment of the present invention.

In the optical clock extraction apparatus according to the ninth embodiment of the present invention, the delay interferometer 7 is composed of the three stages of the delay interferometers 7-1 to 7-3. However, the three stages of the delay interferometers 7-1 to 7-3 may be replaced by two stages of interferometers, or more than four stages of interferometers. The delay time of each stage of these delay interferometers 7-1 to 7-3 is set to an integral times of a pulse signal interval of an input signal.

Since the three stages of the delay interferometers 7-1 to 7-3 are employed, the optical clock extraction apparatus according to the ninth embodiment of the present invention can have an “inter-bit energy distribution function” stronger than those of the seventh embodiment and the eighth embodiment of the present invention. As a result, the time duration required to extract the optical clock by the optical clock extraction apparatus according to the ninth embodiment of the present invention is shorter than those of the seventh embodiment and the eighth embodiment of the present invention.

### Tenth Embodiment

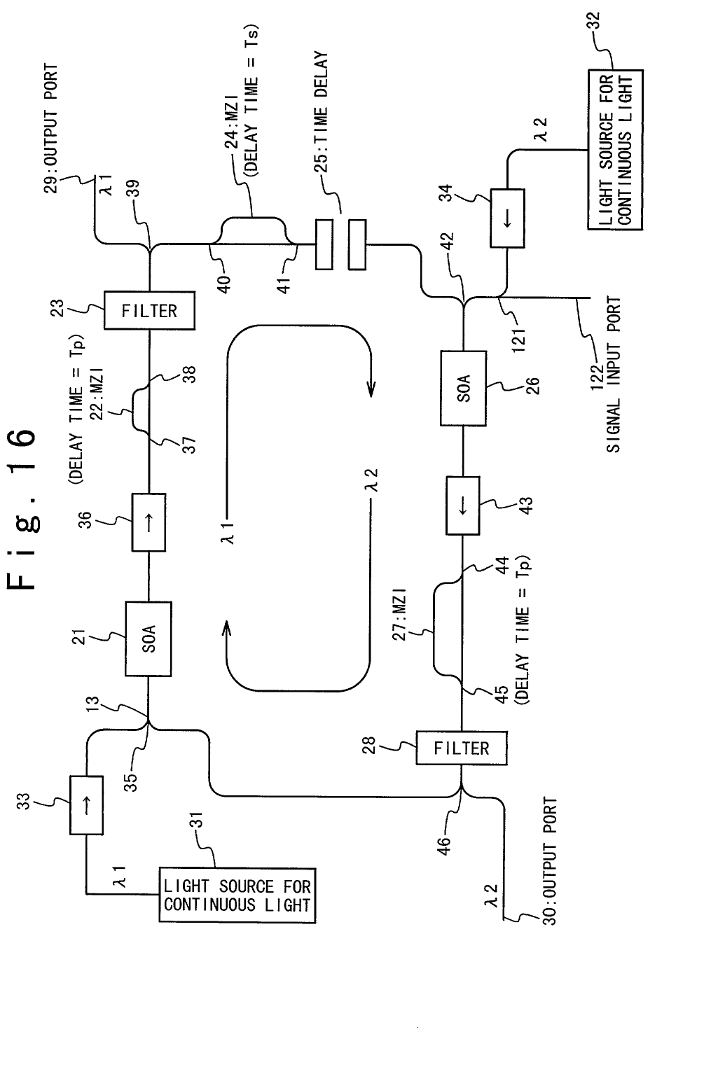

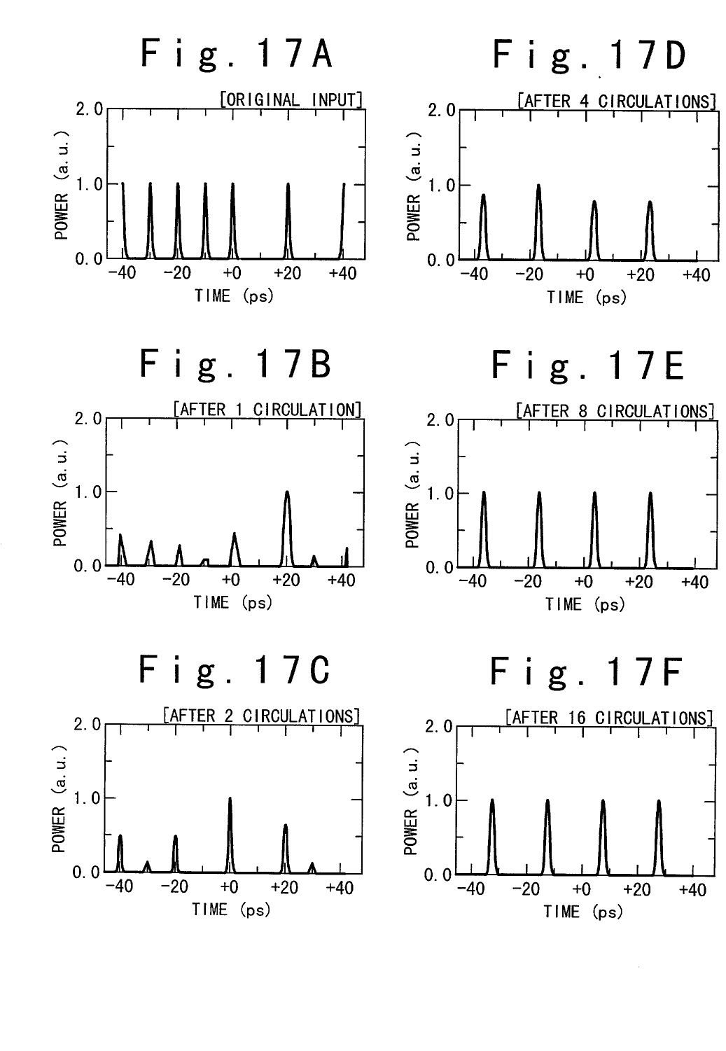

FIG. 16 is a block diagram showing the structure of an optical clock extraction apparatus according to the tenth embodiment of the present invention. Referring to FIG. 16, the optical clock extraction apparatus according to the tenth embodiment of the present invention has basically the same structure as that of the optical pulse signal generation apparatus according to the second embodiment of the present invention. However, the optical clock extraction apparatus in the tenth embodiment is difference from the optical pulse signal generation apparatus in the second embodiment in that a signal input port 122 and an optical combiner 121 are additionally provided. It should be noted that the same structural elements of the tenth embodiment as those of the second embodiment are allocated with the same reference numerals. Also, the same operations as those of the second embodiment are carried out in the tenth embodiment of the present invention.

The optical clock extraction apparatus according to the tenth embodiment of the present invention does not have the polarizer 4, so that there is no adverse influence caused by polarization orientation of an input signal, different from the above-described seventh embodiment and ninth embodiment of the present invention. Other functions and operation characteristics of the optical clock extraction apparatus according to the tenth embodiment are same as those of the seventh embodiment and the eighth embodiment of the present invention.

The optical clock extraction apparatus according to the tenth embodiment of the present invention has a frequency division of an optical clock signal in addition to the operation for extracting the optical clock. For example, it is supposed that an optical clock is inputted to any one of the optical clock extraction apparatuses according to the seventh, eighth and tenth embodiment of the present invention, and either of the delay time of the delay interferometer 7 or the delay time of the delay interferometer 24 is set to 1/16 of the input clock frequency. In this case, a 16-frequency-divided optical clock is generated. In other words, any one of the optical clock extraction apparatuses according to the seventh, eighth and tenth embodiments is capable of frequency division of the optical clock frequency.

In case of the optical clock extraction apparatus according to the ninth embodiment of the present invention, it is supposed that the delay time of at least one of the three stages of the delay interferometers 7-1 to 7-3 is set to be 16 times longer than the optical pulse signal interval of the input clock, and the delay times of the remaining two stages of the delay interferometers are set to a value of an integral times of 16 times of the optical pulse signal interval involving one time. In this case, a 1/16 frequency divisional optical clock is generated. Furthermore, the optical clock extraction apparatus according to the tenth embodiment of the present invention can carry out the above-described clock extracting operation and the above-mentioned clock frequency dividing operation at the same time.

FIG. 17A to FIG. 17F are diagrams showing a basic concept of a simultaneous operation of the clock extracting operation and the clock frequency dividing operation carried out by the optical clock extraction apparatus according to the tenth embodiment of the present invention. As shown in FIG. 17A, it is supposed that an input optical signal has the 8-bit period bit of “11110101”, the pulse width of 1.5 ps, and the repetition frequency of 100 GHz. In this case, the delay time of the delay interferometer 27 is 20 ps.

As shown in FIG. 17B to FIG. 17F, the optical clock extraction apparatus according to the tenth embodiment of the present invention generates a frequency-divided optical clock having the frequency of 50 GHz. The clock pulse width is approximately 1.5 ps.

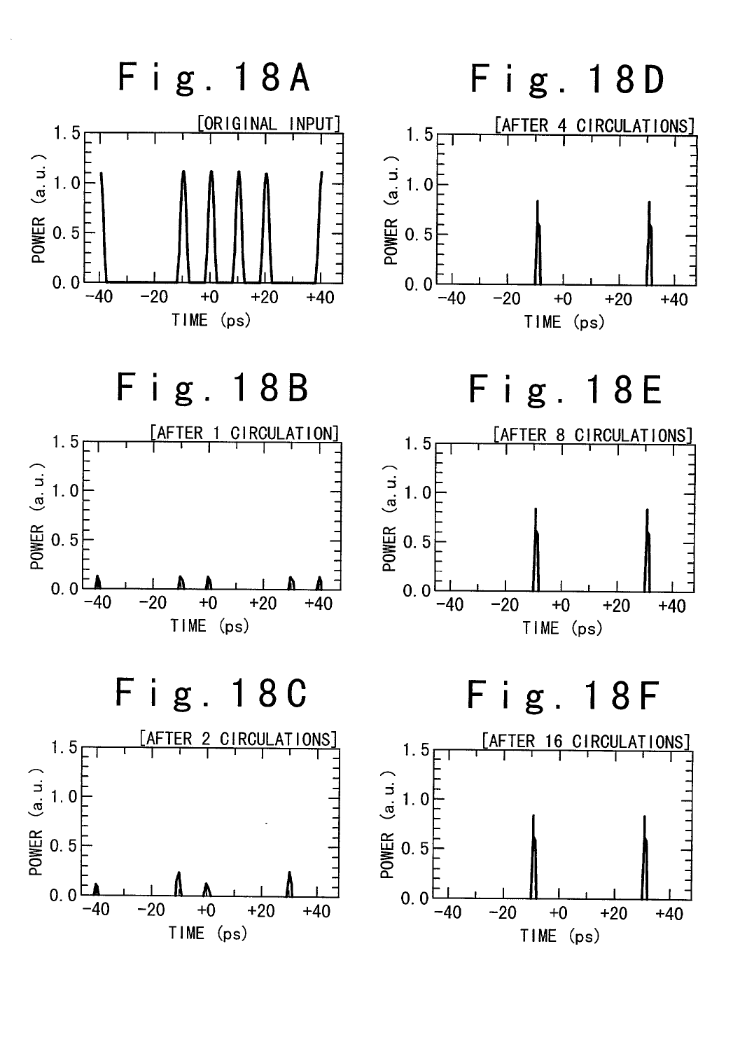

FIG. 18A to FIG. 18F are diagrams showing the clock extracting operation and the frequency-dividing operation of the optical clock extraction apparatus according to the tenth embodiment of the present invention. In FIG. 18, when the delay time of the delay interferometer 27 is 40 ps, a ¼ frequency-divided optical clock (25 GHz) is generated from the optical signal having the 8-bit period of “11110101”.

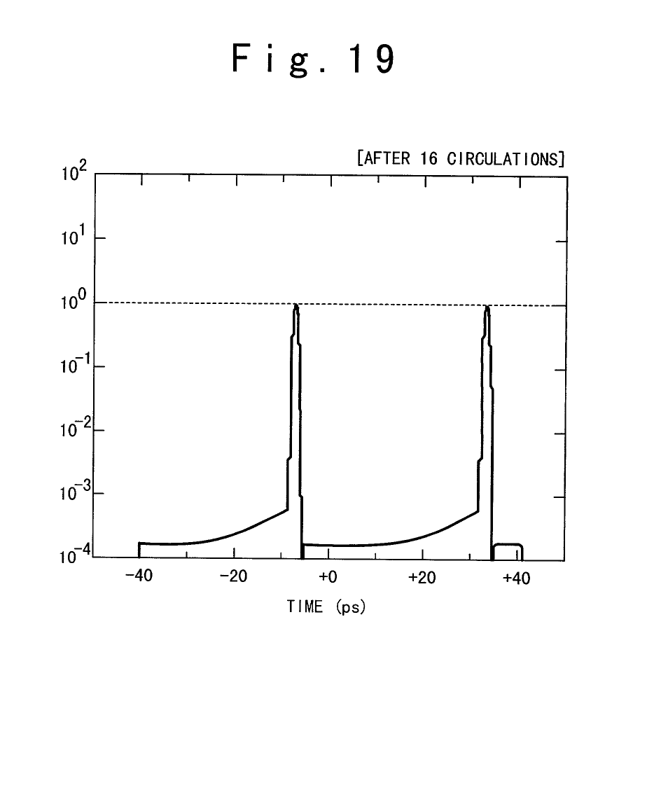

Also, when the delay time “Tp” of the delay interferometer 22 is 1.1 ps, the pulse width of an output optical clock is 1.0 ps, and this value is shorter than the pulse width of the input optical signal. Furthermore, the phase bias of the delay interferometer 22 is optimized in accordance with the bias optimizing operation described in the publication (Optics Letters, volume 23, No. 23, 1998, pages 1846 to 1848). As a result of optimization of the phase bias, it is possible to obtain an output optical clock quenching ratio equal to or larger than 30 dB, as shown in FIG. 19. The non-linear phase shift amount of the operation example is 0.94π, and the phase bias optimum value is 1.027π.

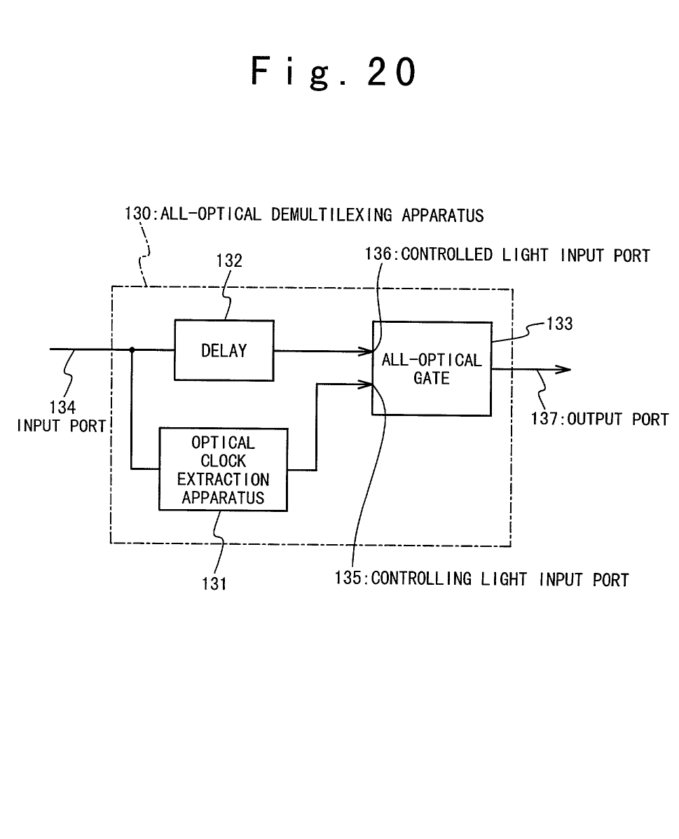

FIG. 20 is a block diagram showing the structure of the all-optical demultiplexing apparatus using the clock extracting and frequency-dividing operation of the optical clock extraction apparatus according to the present invention. Referring to FIG. 20, the all-optical multiplexing apparatus 130 is composed of an optical clock extraction apparatus 131, a delay 132 and an all-optical gate 133.

As one example, the demultiplexing operation for extracting a 16:1 time division demultiplexing optical signal (10 Gbps) from a 160-Gbps optical signal will now be described with reference to FIG. 20. The optical clock extraction apparatus 131 generates a 10-GHz frequency-divided optical clock from the 160-Gbps optical signal. The 10-GHz frequency-divided optical clock is entered into a control light input port 135 of the all-optical gate 133 so as to control the all-optical gate 133. At this time, the all-optical gate 133 opens a switch window in a 10-GHz time period. The switch window width is set equal to or shorter than 10 ps. As a result, only the optical pulse signal coincident with the 10-GHz time period of the switch window among the 160-Gbps optical signal entered into the control input port 136 is sent out to the output port 137. That is, 10-Gbps optical signal which is demultiplexed from 16:1 time division is sent out to the output port 137.

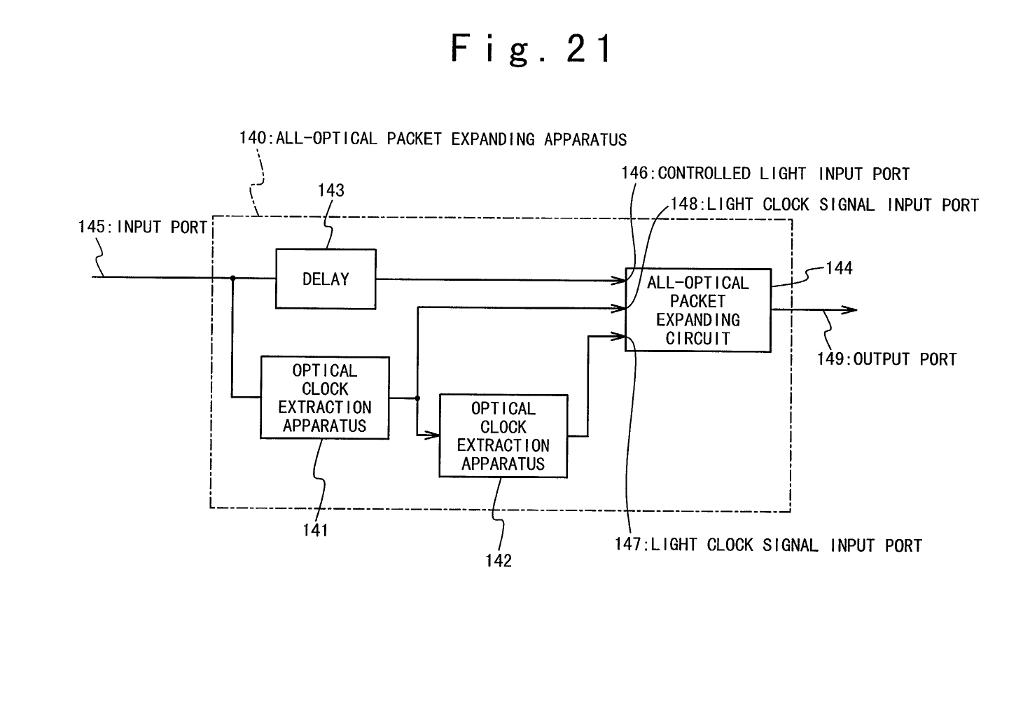

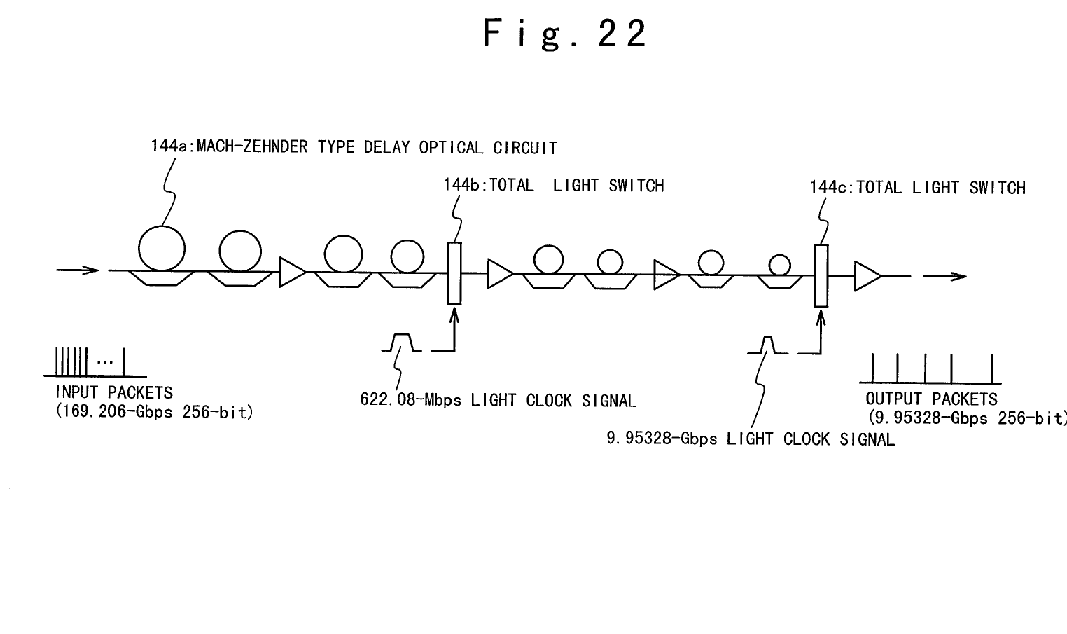

FIG. 21 is a block diagram showing the structure of an all-optical packet expanding apparatus using the clock extracting and frequency-dividing operation of the optical clock extraction apparatus according to the present invention. FIG. 22 is a diagram showing a structural example when a Mach-Zehnder type delay optical circuit is used as a packet expanding optical circuit of FIG. 21. Referring to FIG. 21, the all-optical packet expanding apparatus 140 is composed of optical clock extraction apparatuses 141 and 142, a delay 143, and an all-optical packet expanding optical circuit 144. Also, in FIG. 22, the all-optical packet expanding optical circuit 144 is composed of a Mach-Zehnder type delay optical circuit (otherwise, a loop type delay optical circuit) 144a, all-optical switches 144b and 144c.

Referring now to FIG. 21 and FIG. 22, the expanding operation of a 169.206-Gbps 256-bit optical packet to 9.95328-Gbps 256-bit optical packet (expansion ratio=17 times) will be described below as one example. The optical clock extraction apparatus 141 generates a 1/17 frequency-divided optical clock (9.95328 GHz) from the 169.206-Gbps optical packets. The optical clock extraction apparatus 142 further generates a 1/16 frequency-divided clock (622.08 MHz) from the 9.95328-Gbps optical packets. The 622.08-MHz optical clock is entered via an optical clock input port 147 of the all-optical packet expanding optical circuit 144 to a control port of a first stage of all-optical switch (all-optical switch 144b) provided in the all-optical packet expanding optical circuit 144. The 9.95328-GHz optical clock is entered via an optical clock input port 148 of the all-optical packet expanding optical circuit 144 to a control port of a second stage of all-optical switch (all-optical switch 144c) provided in the all-optical packet expanding optical circuit 144. It should be understood that the delay times of the first to eighth stages of the delay optical circuits are 12.10 ns, 6.052 ns, 3.026 ns, 1.513 ns, 756.5 ps, 189.1 ps, and 94.56 ps, respectively.

The all-optical switch 144b opens the switch window having the repetition frequency of 622.08 MHz and the width of 95 ps, and expands the 169.206-Gbps 256-bit optical packet by 17 times in units of 16 bits. Also, the all-optical switch 144c opens the switch window having the repetition frequency of 9.95328 GHz and the width of approximately 4 ps, and expands the interval between the respective signal bits by 17 times.

The all-optical packet expanding optical circuit 144 expands the 169.206-Gbps 256-bit optical packets to the 9.9532-Gbps 256-bit optical packets through the above sequence of operations, and then sends out the 9.9532-Gbps 256-bit optical packet to the output port 149. The structural example and operation example of the all-optical packet expanding optical circuit using the all-optical gate controlled by an electric signal instead of the all-optical switch are described in, for example, the publication (IEICE Transactions on Communications, volume E81-B, No 8, 1998, pages 1681 to 1686), (1999-year conference on Japanese Electronic Information Communication Society, B-10-139, page 316), (1999-year conference on Japanese Electronic Information Communication Society, B-10-141, page 318), and (Technical Digest of the 25th European Conference on Optical Communication (ECOC '99), volume 1, pages 256 to 257, Nice, France, Sep. 26-30, 1999).

It should be understood that the operations of the all-optical packet expanding operation circuit described with reference to FIG. 22 are similar to those of the packet expanding optical circuit as described in “1999-year conference on Japanese Electronic Information Communication Society” B-10-141, page 318, except that the signal rate is 64 times faster than that of the latter, and the electric controlled optical switch is replaced by the all-optical switch. Also, the Mach-Zehnder type delay optical circuit may be replaced by the loop type delay optical circuits as described in, for example, the publication (IEICE Trans. Communication, volume E81-B, No 8, pages 1681 to 1686, 1998), (1999-year conference on Japanese Electronic information Communication Society, B-10-140, page 317), and (Technical Digest of the 25th European Conference on Optical Communication (ECOC '99), volume 1, pages 256 to 257, Nice, France, Sep. 26-30, 1999).

### Eleventh Embodiment

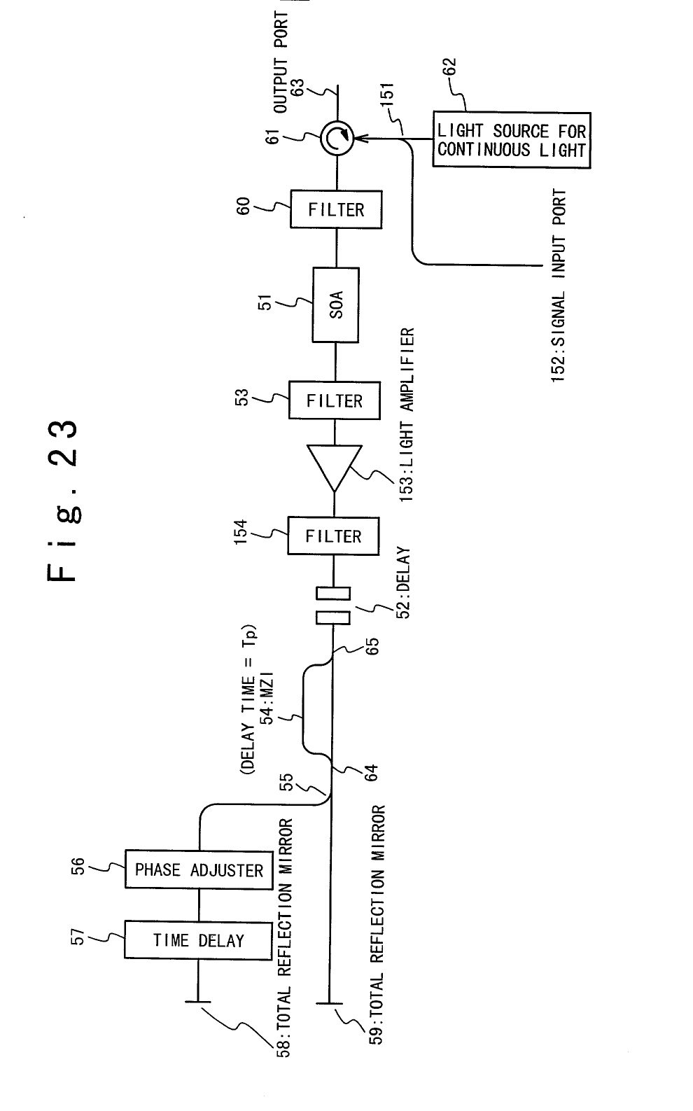

FIG. 23 is a block diagram showing the structure of the optical clock extraction apparatus according to the eleventh embodiment of the present invention. Referring to FIG. 23, the optical clock extraction apparatus according to the eleventh embodiment of the present invention has basically the same structure as that of the optical clock extraction apparatus according to the third embodiment of the present invention. However, the optical clock extraction apparatus in the eleventh embodiment is different from the optical clock extraction apparatus in the third embodiment in that a signal input port 152, an optical combiner 151, and a fiber type optical amplifier 153 are additionally provided. It should be noted that the same structural elements of the eleventh embodiment as those of the third embodiment are allocated with the same reference numerals. Also, the operations of the same structural elements having the same reference numerals are same as those in the third embodiment of the present invention.

In the optical clock extraction apparatus according to the eleventh embodiment of the present invention, the optical pulse signal and the continuous wave light are propagated through the semiconductor optical amplifier 51 in the opposing directions. As a result, an optical pulse width of an optical clock pulse signal generated by the optical clock extraction apparatus according to the eleventh embodiment of the present invention can be made wider than the optical pulse width of the optical clock pulse signal generated in the seventh embodiment through the tenth embodiment of the present invention. Other basic clock extracting operation and basic clock frequency-dividing operation of the eleventh embodiment are similar to those of the seventh to tenth embodiments according to the present invention.

### Twelfth Embodiment

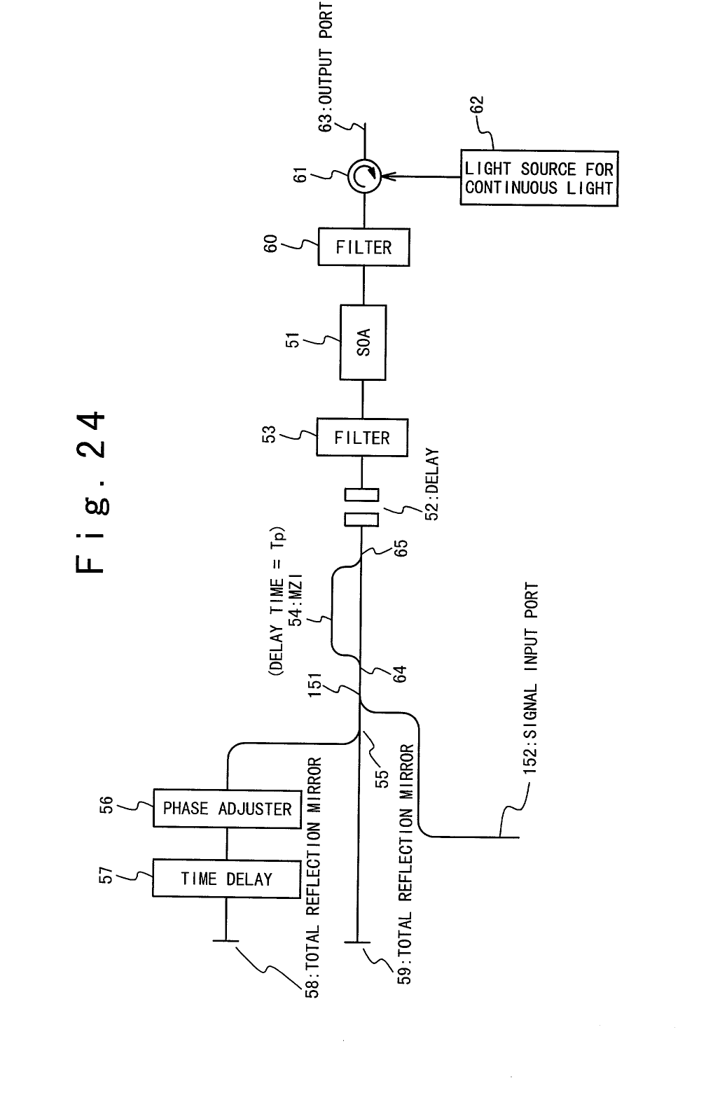

FIG. 24 is a block diagram showing the structure of an optical clock extraction apparatus according to the twelfth embodiment of the present invention. Referring to FIG. 14, the optical clock extraction apparatus according to the twelfth embodiment of the present invention has basically the same structure as that of the optical clock extraction apparatus according to the eleventh embodiment of the present invention. However, the optical clock extraction apparatus in the twelfth embodiment is different from the optical clock extraction apparatus in the eleventh embodiment in that a signal input port 152 and an optical combiner 151 are provided at positions different from those of the optical clock extraction apparatus according to the eleventh embodiment. It should be noted that the same structural elements of the twelfth embodiment as those of the eleventh embodiment are allocated with the same reference numerals. Also, the operations of the same structural elements in the twelfth embodiment are same as those of corresponding structural elements in the eleventh embodiment of the present invention.

Both of the signal input port 152 and the optical combiner 151 are arranged between the delay interferometer 54 and the optical splitter 55, and may be arranged at any places except for the path between the semiconductor optical amplifier 51 and the delay interferometer 54. The basic clock extracting operation and the basic clock frequency-dividing operation of the optical clock extraction apparatus according to the twelfth embodiment of the present invention are same as those of the eleventh embodiment of the present invention.

### Thirteenth Embodiment

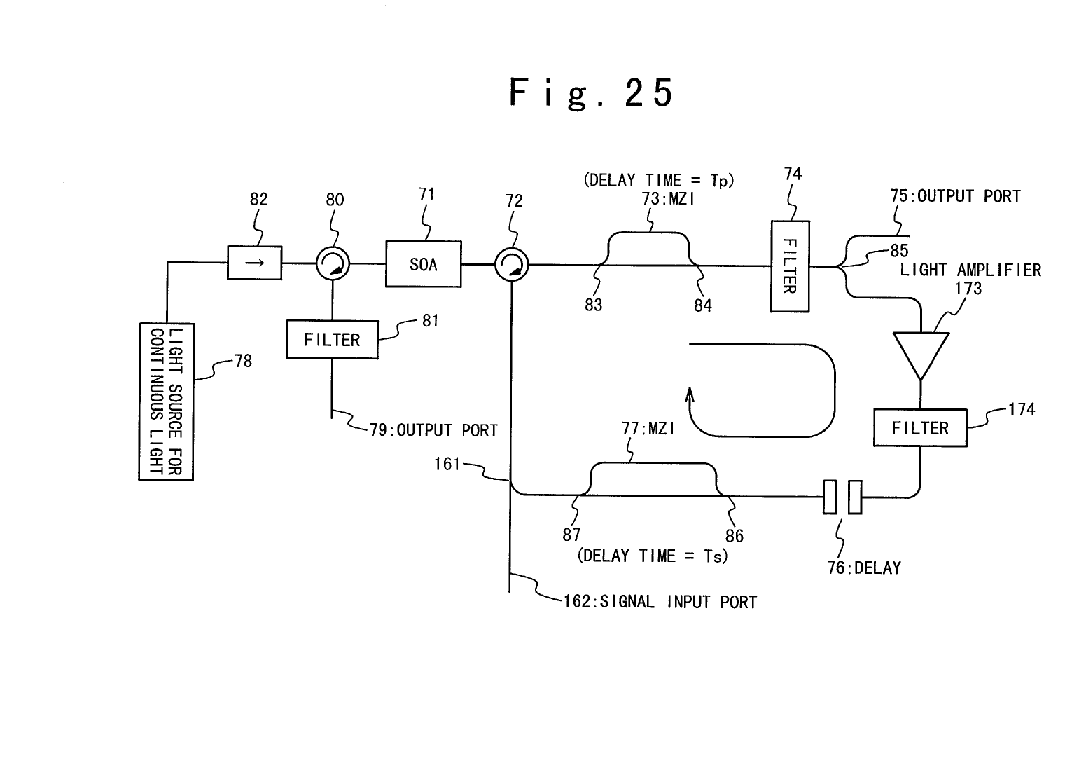

FIG. 25 is a block diagram showing the structure of the optical clock extraction apparatus according to a 13th embodiment of the present invention. Referring to FIG. 25, the optical clock extraction apparatus according to the thirteenth embodiment of the present invention has basically the same structure as that of the optical clock extraction apparatus according to the fourth embodiment of the present invention. However, the optical clock extraction apparatus in the thirteenth embodiment is different from the optical clock extraction apparatus in the fourth embodiment in that a signal input port 162, an optical combiner 161, and a fiber type optical amplifier 163 are additionally provided. It should be noted that the same structural elements of the thirteenth embodiment as those of the fourth embodiment are allocated with the same reference numerals. Also, the operations of the same structural elements in the thirteenth embodiment are same as those of corresponding structural elements in the fourth embodiment of the present invention.

Also, in the optical clock extraction apparatus according to the thirteenth embodiment of the present invention, the optical pulse signal and the continuous wave light are propagated through the semiconductor optical amplifier 51 in the opposing directions. As a result, an optical pulse width of an optical clock pulse signal generated by the optical clock extraction apparatus according to the thirteenth embodiment of the present invention can be made wider than the optical pulse width of the optical clock pulse signal generated in the seventh embodiment through the tenth embodiment of the present invention. Other basic clock extracting operation and basic clock frequency-dividing operation of the thirteenth embodiment are same as those of the seventh to tenth embodiments according to the present invention.

### Fourteenth Embodiment

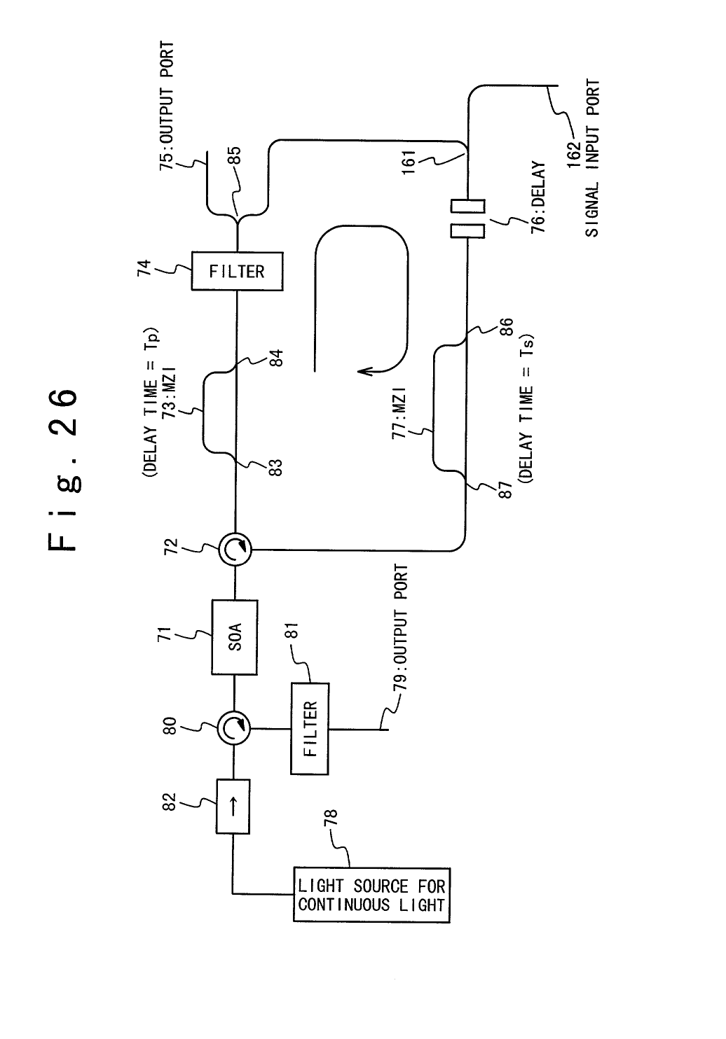

FIG. 26 is a block diagram showing the structure of an optical clock extraction apparatus according to the fourteenth embodiment of the present invention. Referring to FIG. 26, the optical clock extraction apparatus according to the fourteenth embodiment of the present invention has basically the same structure as that of the optical clock extraction apparatus according to the thirteenth embodiment of the present invention. However, the optical clock extraction apparatus in the fourteenth embodiment is different from the optical clock extraction apparatus in the thirteenth embodiment in that a signal input port 162 and an optical combiner 161 are provided at positions different from those of the optical clock extraction apparatus according to the thirteenth embodiment. It should be noted that the same structural elements of the fourteenth embodiment as those of the thirteenth embodiment are allocated with the same reference numerals. Also, the operations of the same structural elements in the fourteenth embodiment are same as those of corresponding structural elements in the thirteenth embodiment of the present invention.

Both of the signal input port 162 and the optical combiner 161 are arranged between the delay interferometer 77 and the optical circulator 72, and may be arranged at any places except for the path between the semiconductor optical amplifier 71 and the delay interferometer 74. The basic clock extracting operation and the basic clock frequency-dividing operation of the optical clock extraction apparatus according to the fourteenth embodiment of the present invention are same as those of the thirteenth embodiment of the present invention.

As previously described, the optical pulse signal generation apparatus according to the present invention does not contain a non-linear optical fiber equal to or longer than 10 meters, and a rare earth doped optical fiber. As a result, the optical pulse signal generation apparatus of the present invention can be made compact, as compared with the conventional optical pulse signal generation apparatus. It could be expected in near future that the optical pulse signal generation apparatus according to the present invention can be manufactured as an integrated device by use of a hybrid integration packaging technology of the quartz optical waveguide and the semiconductor optical waveguide as described in the publication (Electronics Latter, volume 34, No. 10, pages 986 to 987, 1998).

Also, the electric power of the electric clock signal required to synchronize the frequency of the optical pulse signal generation apparatus according to the present invention can be reduced, as compared with that of the conventional optical pulse signal generation apparatus.

Also, the optical clock extraction apparatus according to the present invention can extract the optical clock having the narrow pulse width from the high speed optical signal having the high repetition frequency. The optical clock pulse signal outputted from the optical clock extraction apparatus of the present invention is approximated to the Fourier transformation limit, so that the quenching ratio is large, and the optical clock pulse signal can contain only a small amount of jitter components and low intensity noise.

Furthermore, the optical clock extraction apparatus according to the present invention can carry out both of the clock extracting operation and the clock frequency-dividing operation at the same time. It should also be noted that the frequency division ratio is not limited to 2, but may be set to an arbitrary integer ratio.

It should be noted that in the first embodiment and the subsequent embodiments, one of the transmission wavelengths of the delay interferometer (MZI) 7, 24 or 77 is tuned to be equal or close the wavelength of the continuous light from the light source of continuous light 8 by precisely adjusting the delay time.

Also, in the first embodiment and the subsequent embodiments, when an optical pulse train is stationarily circulating an optical loop structure in general, the repetition frequency of the circulating optical pulse train must be equal to harmonics of the loop frequency. This is a requirement derived from the stationary conditions. The loop frequency is the inverse of a pulse circulation time. However, when the harmonic number or the ratio of the pulse repetition frequency to the loop frequency is large, the repetition frequency is not always a single frequency but can be multiple frequencies. In such a case, more than one types of optical pulse trains co-circulates the loop. The repetition frequency of one type of pulse train A differs from that of another type of pulse train B by the loop frequency or its harmonics. In other words, the harmonic number of pulse train A differs from that of pulse train B by one or a small integer. Sometimes, several types of weak pulse trains are simultaneously superimposed on a dominant pulse train in the loop structure to cause supermode noise to the dominant pulse train.

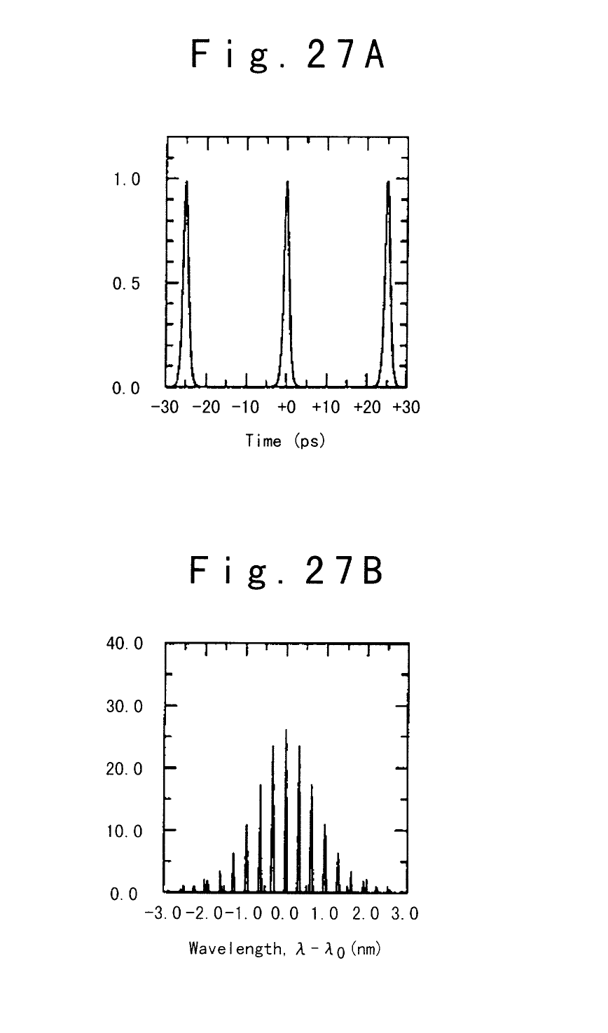

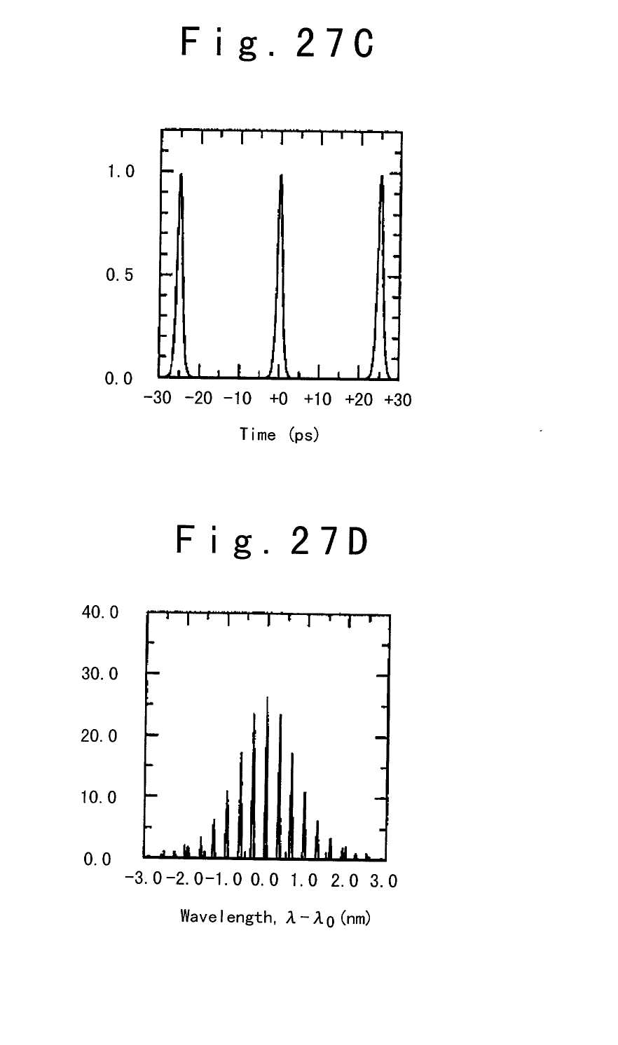

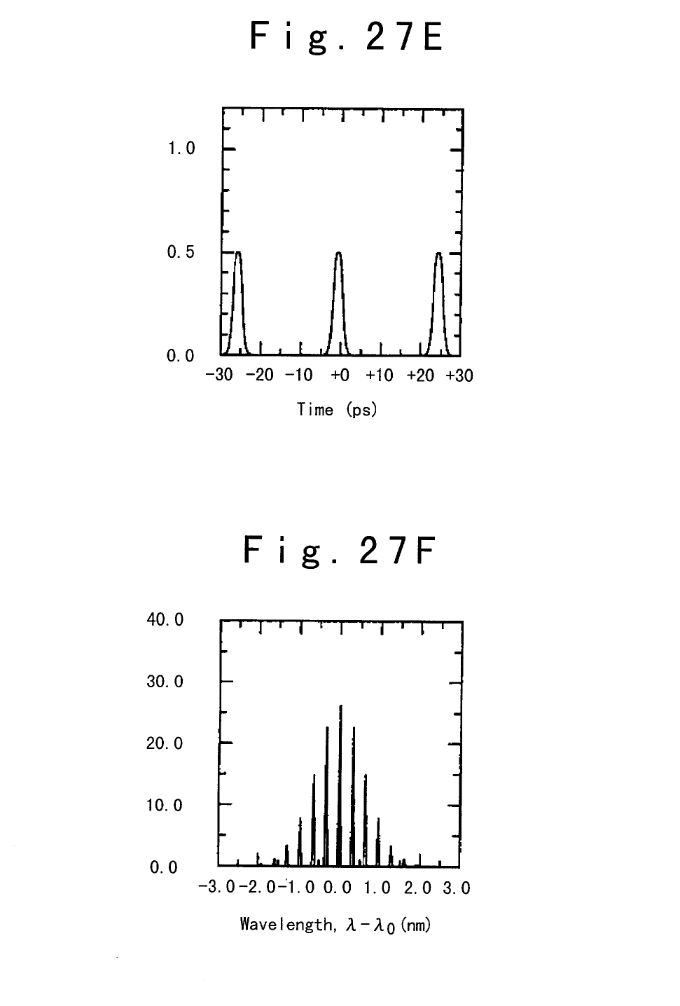

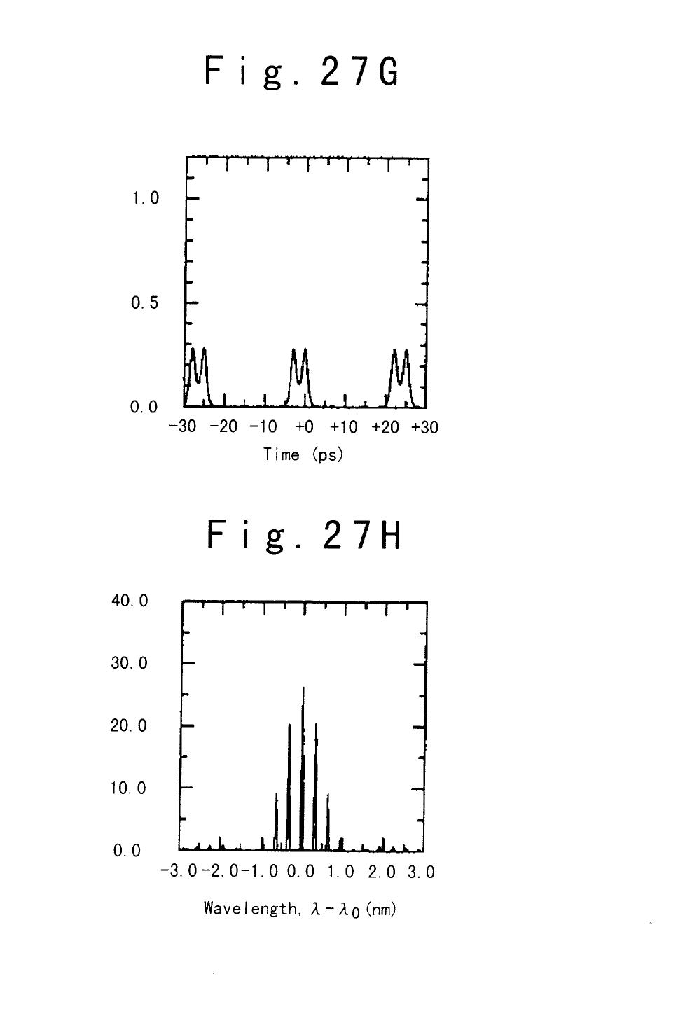

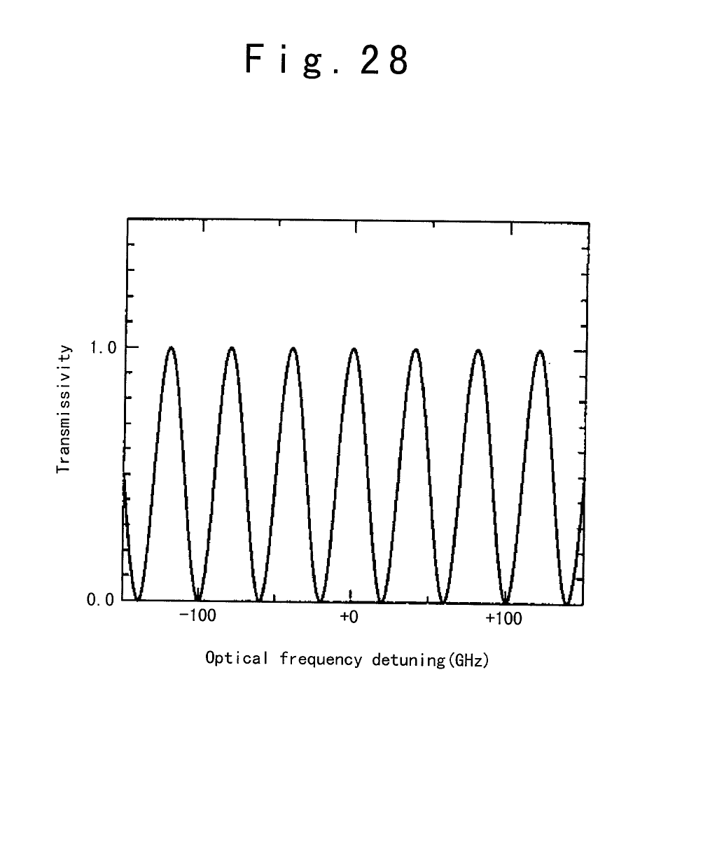

Each of the delay interferometers (MZI) 7 in FIGS. 1, 9 to 11, and 14, the delay interferometers (MZI) 24 in FIGS. 6 and 16, the delay interferometers (MZI) 77 in FIGS. 8, 25 and 26 has a function to suppress the supermode noise, as follows. When a pulse train having the repetition frequency of 40.000 GHz and the FWHM pulse width of 1.5 ps (FIGS. 27A and 27B) enters MZI having the delay time of 25.000 ps, the MZI outputs the pulse train as it is (FIG. 27C and 27D). The pulse shape at the MZI output (FIG. 27C) does not change from that at the MZI input (FIG. 27A). The 40-GHz-spaced optical spectral components of the pulse train at the MZI output (FIG. 27D) do not change from those at the MZI input (FIG. 27B), either. This is because the MZI has sinusoidal transmissivity with the period of (25.000 ps)⁻¹=40.000 GHz with respect to the optical frequency (FIG. 28). The optical frequency difference of 40.000 GHz corresponds to a 0.32 nm wavelength difference in the vicinity of the optical communication wavelength of 1.55 μm. The MZI passes all of the 40-GHz-spaced spectral components of the input pulse train.

When a pulse train having the repetition frequency of 42.400 GHz for example happens to co-circulate the loop with the 40.000-GHz pulse train, the MZI weakens the 42.400-GHz pulse train (FIGS. 27E and 27F). When a pulse train having the repetition frequency of 44.800 GHz happens to co-circulate the loop, the MZI weakens and also breaks up the 44.800-GHz pulse train (FIGS. 27G and 27H). When the repetition frequency is smaller than 40.000 GHz, the MZI weakens and breaks up the pulse train, as well. This function of the MZI will be described below.

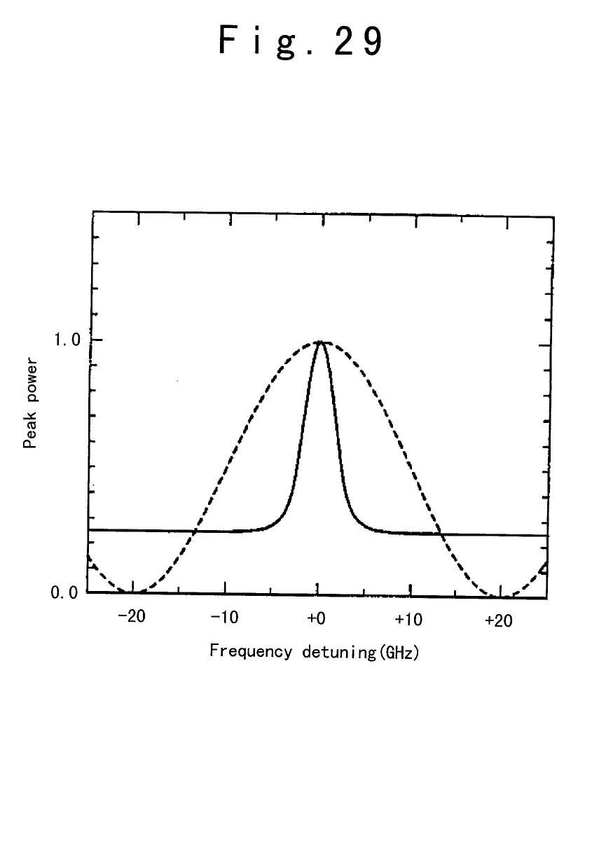

When the repetition frequency increases or decreases from 40.000 GHz, the optical-frequency spacing between the discrete spectral components increases or decreases from 40.000 GHz. Although the central spectral component stays at the transmissivity peak of the MZI, blue and red spectral components walk off from the 40-GHz-spaced transmissivity peaks of the MZI. The longer or the shorter the wavelength of the spectral components is, the more the MZI suppresses the component, as shown in FIGS. 27F and 27H. The solid curve in FIG. 29 shows the decrease in the pulse peak intensity of a pulse train at the MZI output as a function of the repetition frequency detuning from 40.000 GHz. The FWHM bandwidth of this curve is 4.8 GHz.

The output spectra in FIGS. 27D and 27H are calculated with using the following equation,

$${S}_{2} ( ϖ ) = \frac{1 + exp ( i \cdot ϖ \cdot Δ t )}{2} {S}_{1} ( ϖ )$$

where S₁(ω) and S₂(ω) represent the complex spectra at the MZI input and output, respectively, i represents \sqrt{−1}, ω represents angular frequency, and Δt represents the delay time of the MZI. The waveforms at the MZI output (FIGS. 27C, 27E, and 27G) are calculated by Fourier-transforming the respective complex spectra of S₂(ω).

When the loop frequency is designed to be 100 MHz, the repetition frequency of 40.000 GHz is the 400th harmonic of the loop frequency. While the 40-GHz MZI passes the 400th-harmonic pulse train, it suppresses peak intensities of the 399th-harmonic 39.900-GHz and 401st-harmonic 40.100-GHz pulse trains by 0.3%. The 398th-harmonic and 402nd-harmonic pulse trains are suppressed by 0.7%. Thus, the MZI suppresses pulse trains having repetition frequencies other than 40 GHz. Consequently, the MZI suppresses the supermode noise.

The dashed curve in FIG. 29 shows the MZI transmissivity as a function of the optical frequency detuning (FIG. 28), for comparison. It indicates that the repetition-frequency bandwidth of the MZI with respect to a pulse train is significantly narrower than its optical-frequency bandwidth with respect to continuous-wave light. When the width of each pulse is narrowed from 1.5 ps, the repetition-frequency bandwidth is further narrowed from 4.8 GHz and consequently the MZI suppresses the supermode noise more effectively.

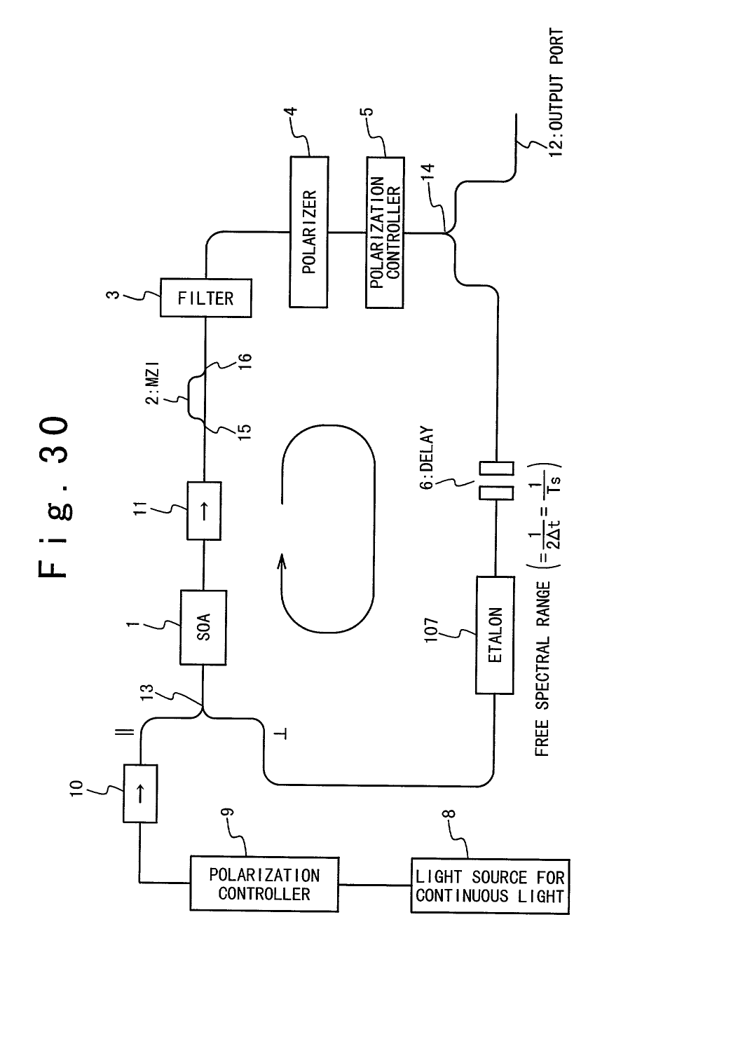

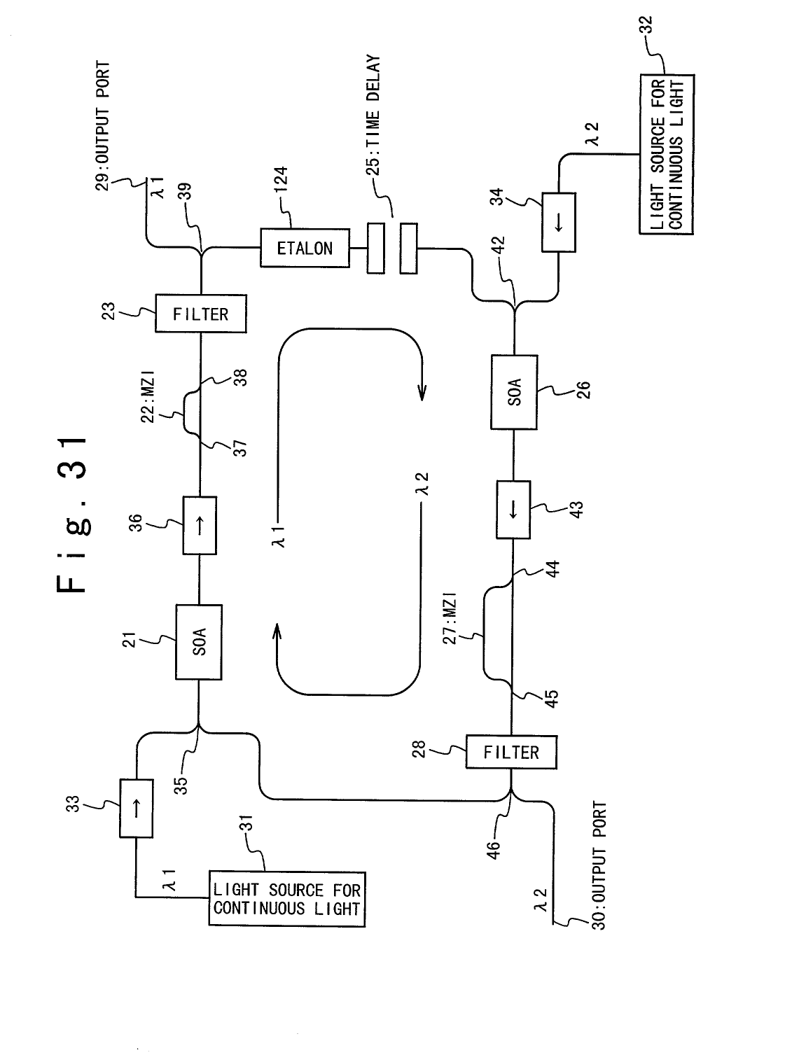

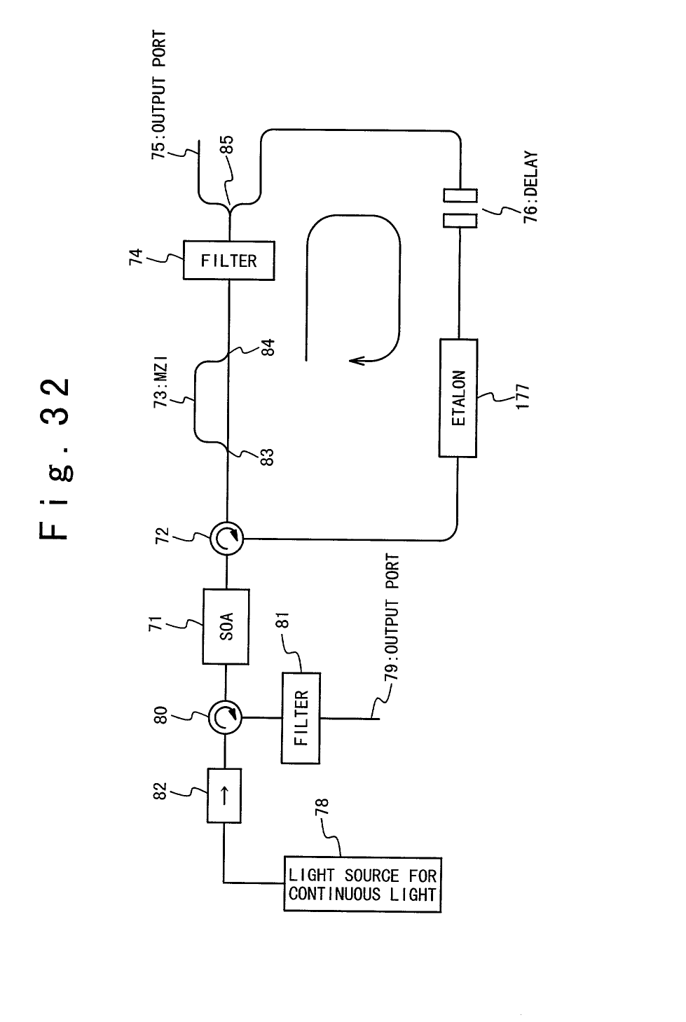

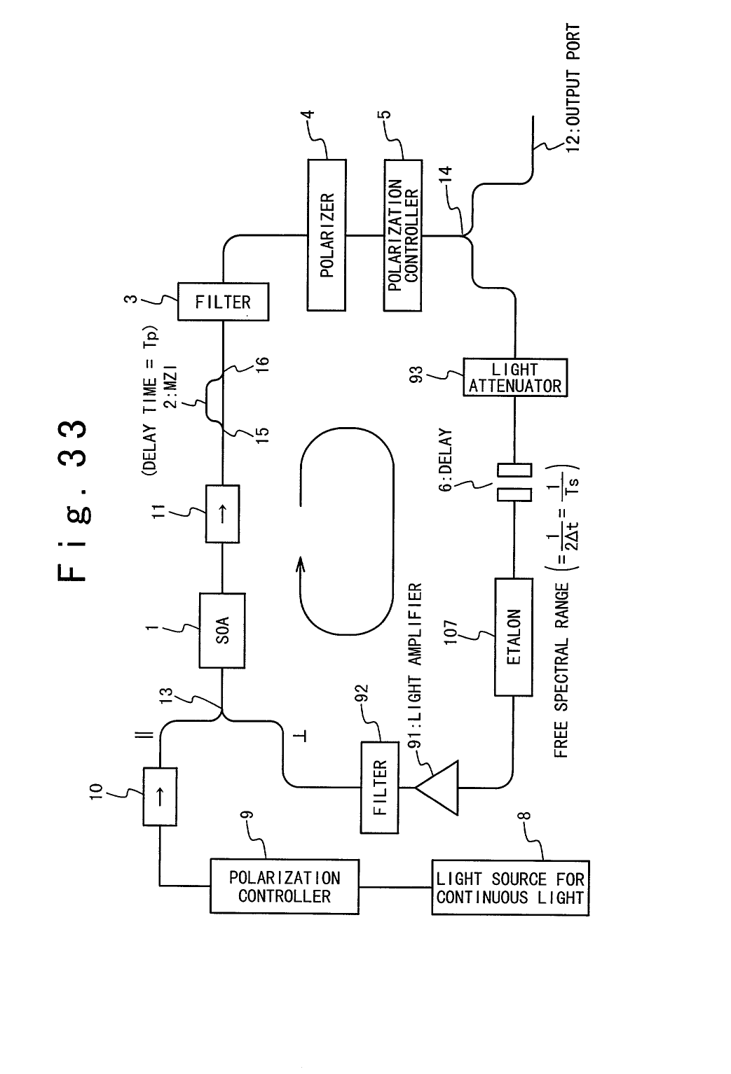

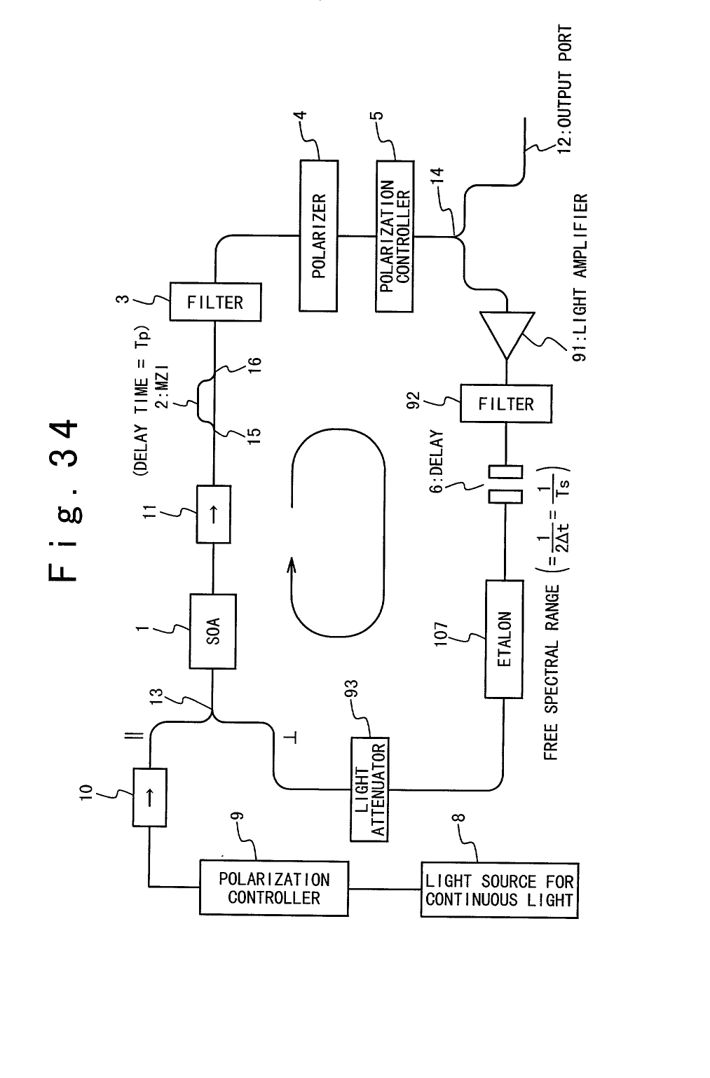

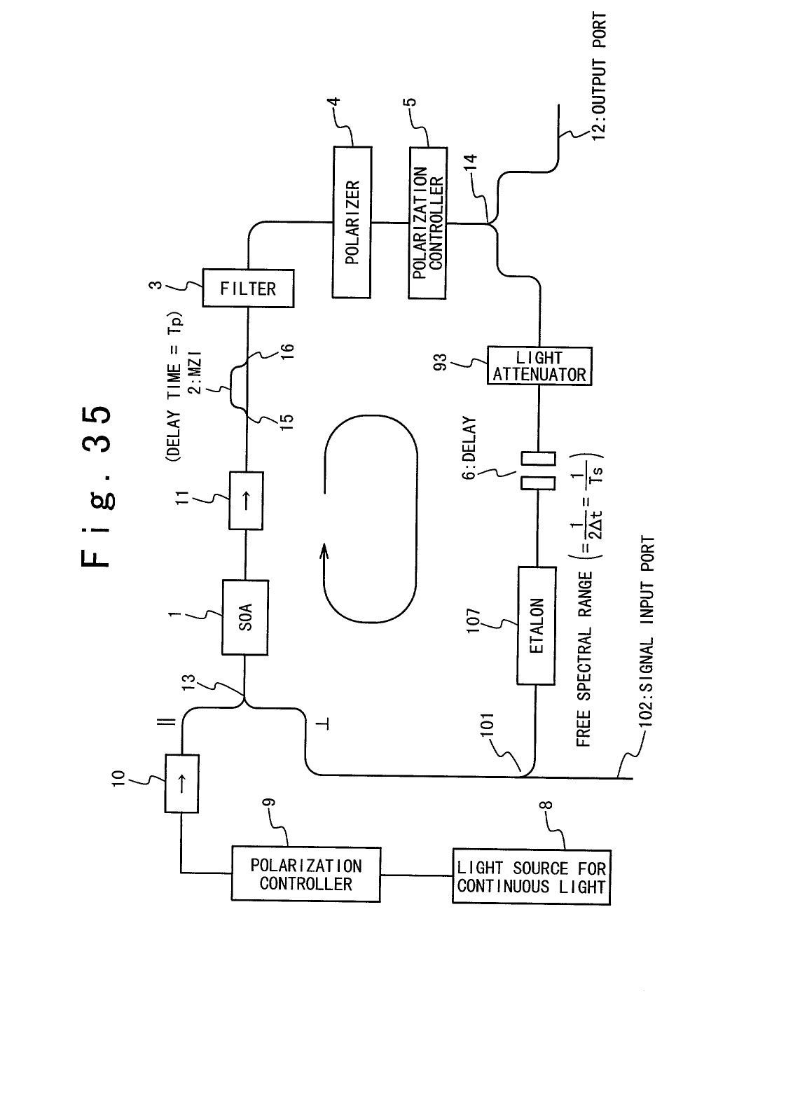

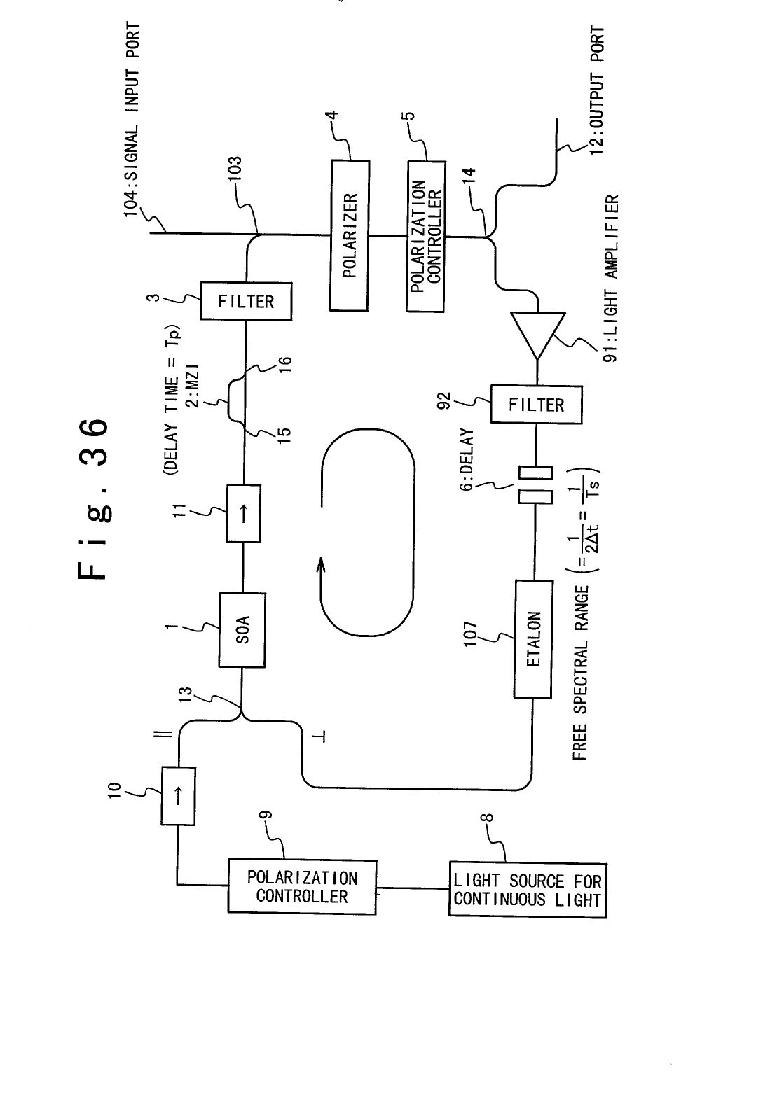

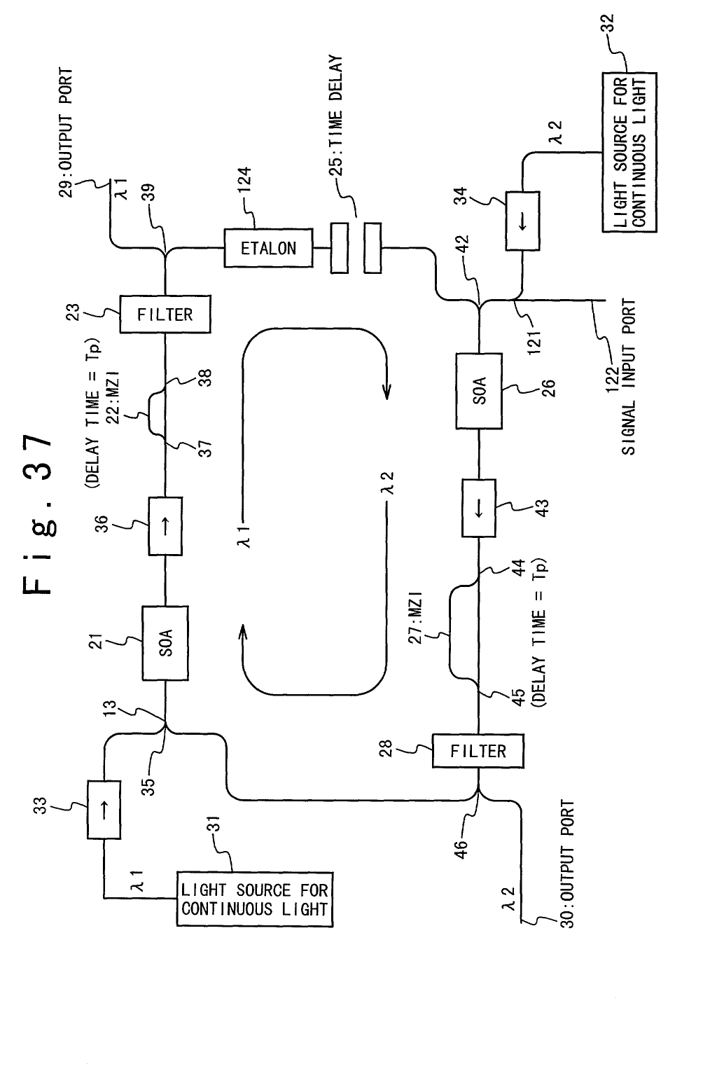

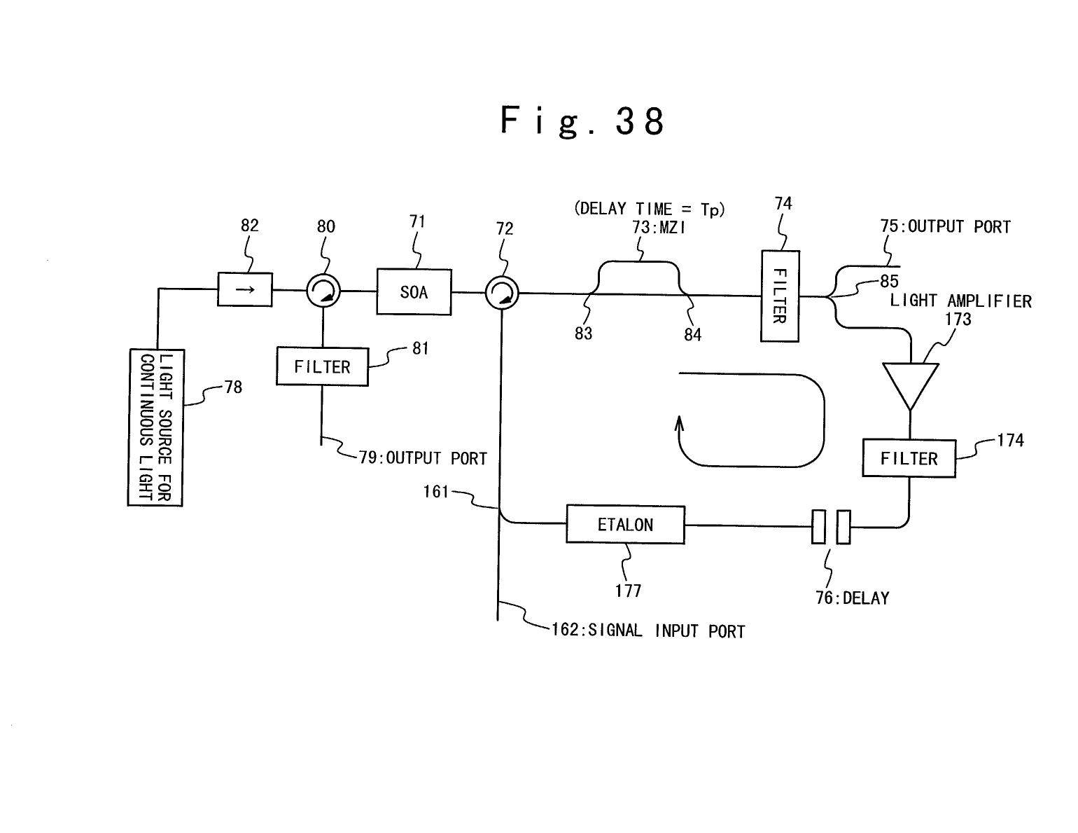

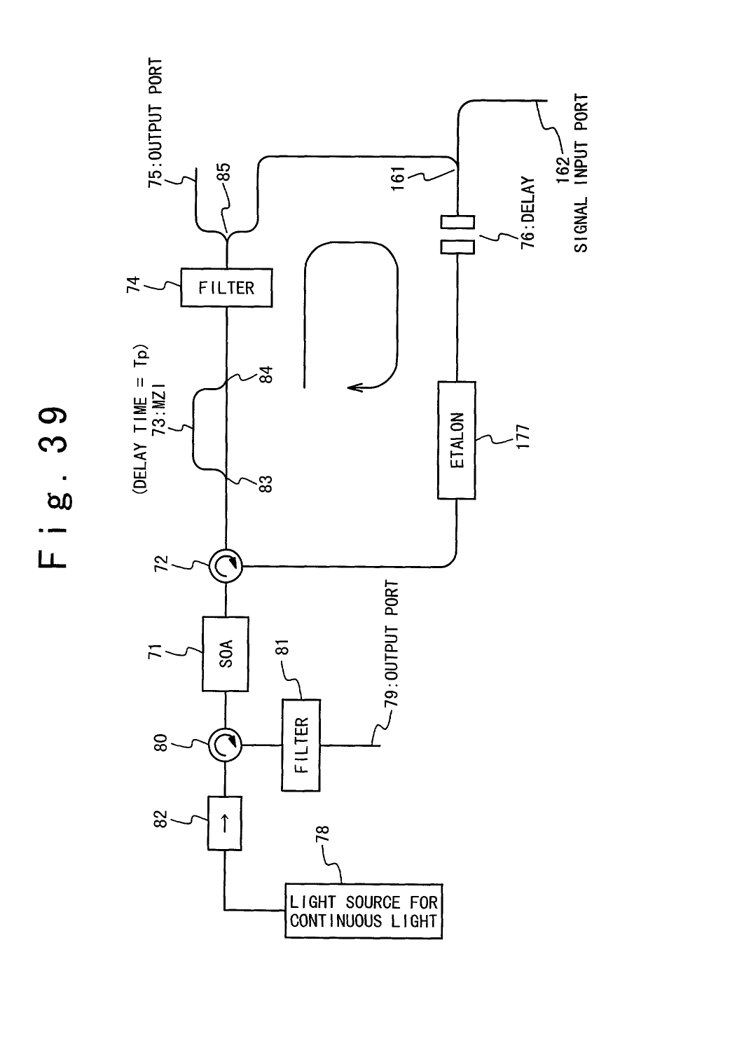

FIGS. 30 to 39 are block diagrams showing the structures of the optical pulse signal generating apparatuses according to modifications of the above embodiments of the present invention, respectively. In these modifications, each of the delay interferometers 7, 24 and 77 in the embodiments is replaced with a Fabry-Perot etalon 107, 124 or 177, for example. One of the transmission wavelengths of the etalon is tuned to be equal or close to the wavelength of the continuous light from the light source of continuous light 8 by adjusting the etalon gap. The optical pulse signal generating apparatus according to each modification generates pulses with the repetition frequency that is equal to the free spectral range of the etalon.

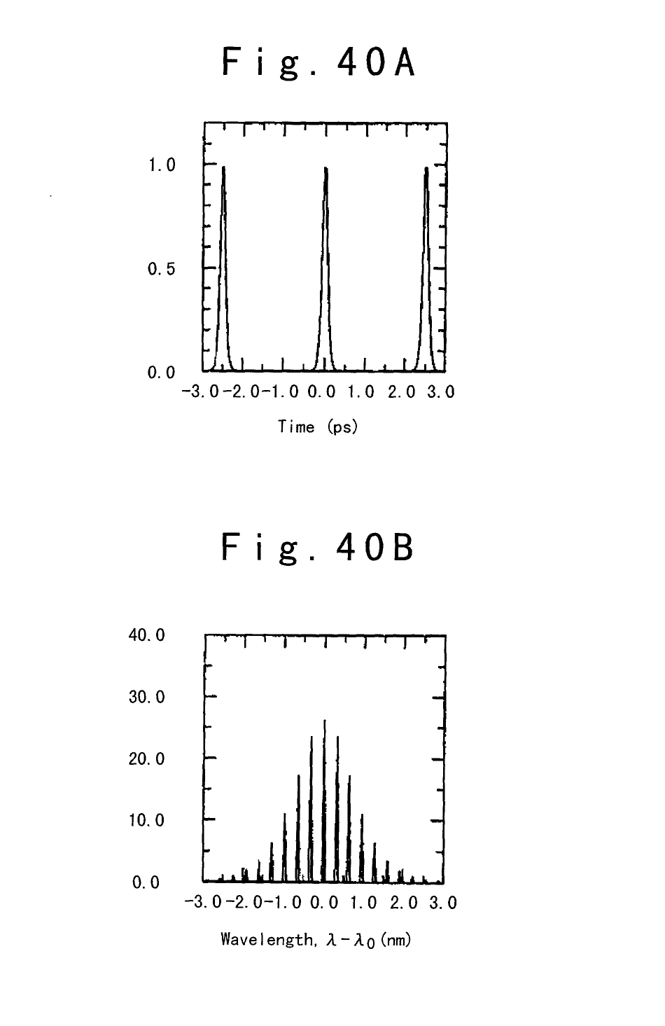

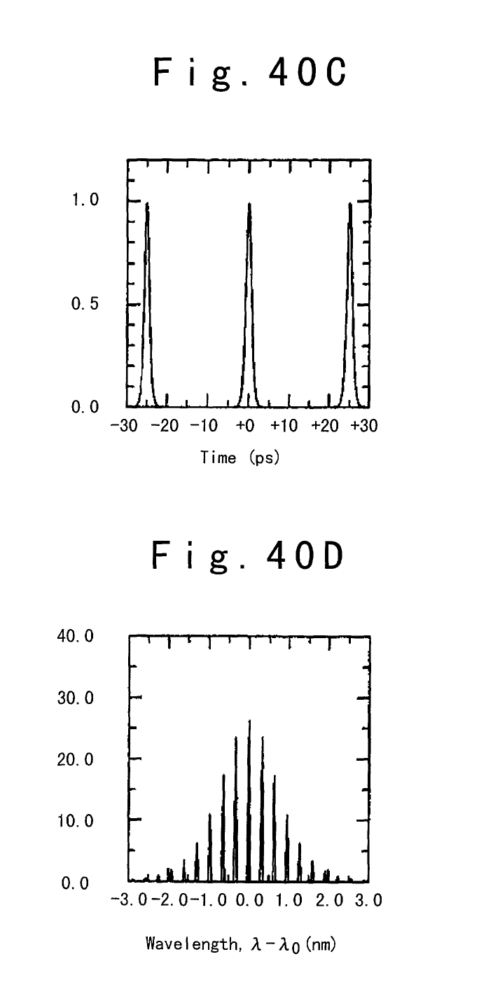

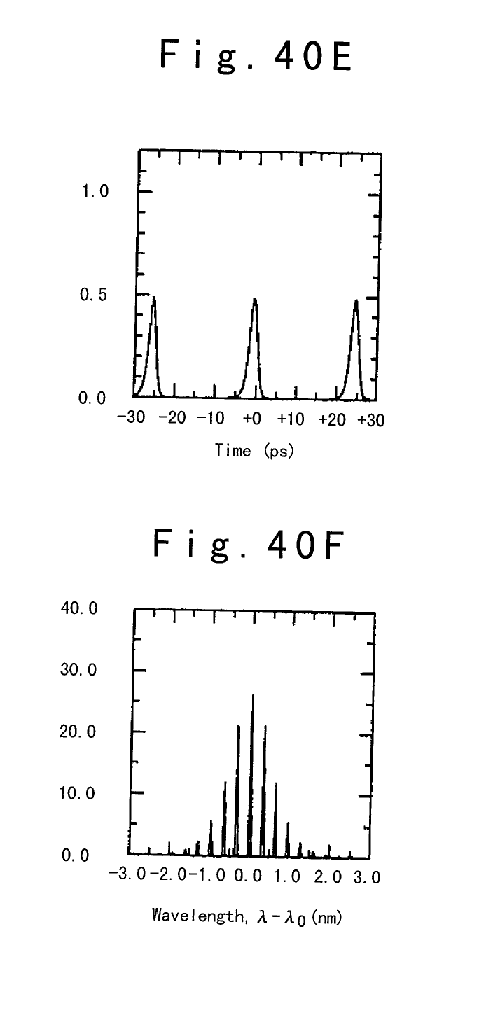

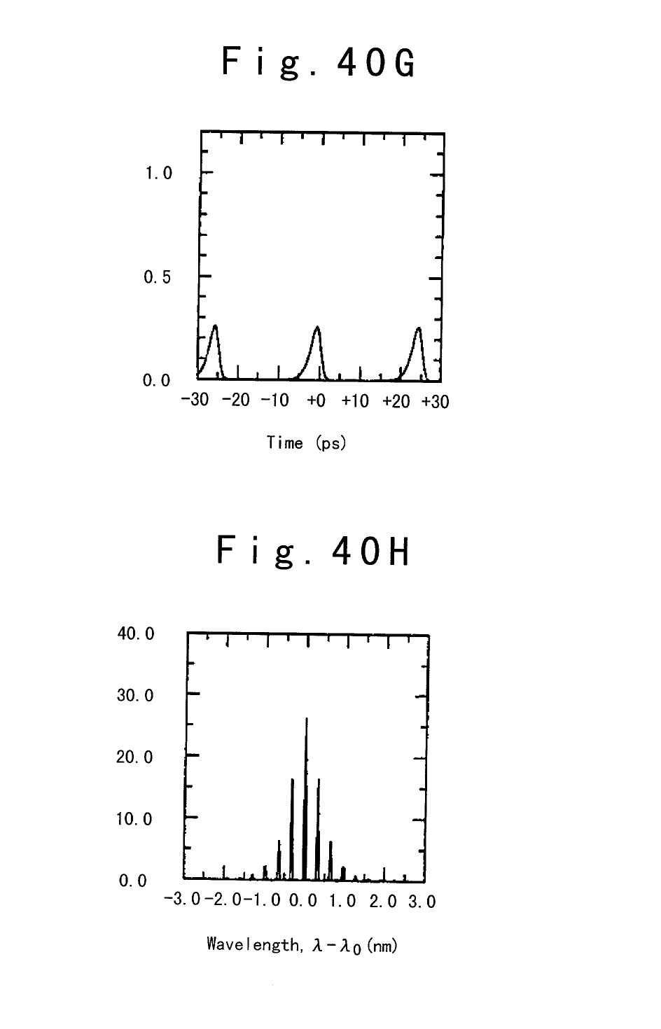

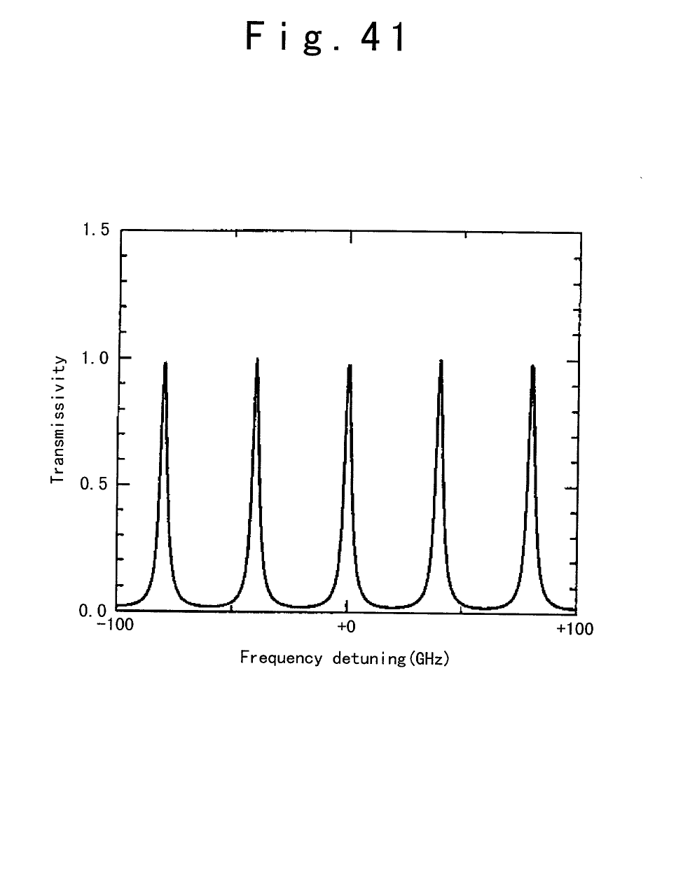

The etalon has a function to suppress the supermode noise, as follows. When a pulse train having the repetition frequency of 40.000 GHz and the FWHM pulse width of 1.5 ps (FIGS. 40A and 40B) enters an etalon having the free spectral range of 40.000 GHz (=½Δt) and the finesse of 50, the etalon outputs the pulse train as it is (FIGS. 40C and 40D). The pulse shape at the etalon output (FIG. 40C) does not change from that at the etalon input (FIG. 40A). The 40-GHz-spaced optical spectral components of the pulse train at the etalon output (FIG. 40D) do not change from those at the etalon input (FIG. 40B), either. This is because the etalon has a periodical transmissivity with the period of 40 GHz with respect to the optical frequency (FIG. 41). The optical frequency difference of 40 GHz corresponds to a 0.32-nm wavelength difference in the vicinity of the optical communication wavelength of 1.55 μm. The etalon passes all of the 40-GHz-spaced spectral components of the 40-GHz pulse train.

The above phenomenon in the time domain will be described as follows. When a pulse A of a 40-GHz pulse train enters the 40-GHz etalon, a part (component A1) of the pulse passes through the first mirror and the second mirror and reaches the etalon output. Another part (component A2) of the pulse passes through the first mirror, is reflected by the second mirror to propagate back to the first mirror, is reflected by the first mirror to propagate to the second mirror again, passes through the second mirror, and then reaches the etalon output. Still another part (component A3) propagates back and forth the etalon mirrors gap twice and reaches the output. Thus, the component A2 reaches the output a specific propagation time (2Δt (=Ts)) later than the component A1. The component A3 reaches the output twice of the specific propagation time (2×2Δt) later than the component A1. When the free spectral range is tuned to be equal to the repetition frequency of the pulse train, 2Δt equals to the pulse distance of the pulse train. Consequently, the component A2 reaches the etalon output at the same time as the next pulse B reaches the output. The component A3 reaches the etalon output at the same time as the second next pulse C reaches the output. Thus, the 40-GHz pulse train passes through the 40-GHz etalon without changing its waveform.

When a pulse train having the repetition frequency of 39.400 GHz for example happens to co-circulate the loop with the 40.000-GHz pulse train, the etalon weakens the 39.400-GHz pulse train (FIGS. 40E and 40F). When a pulse train having the repetition frequency of 38.800 GHz happens to co-circulate the loop, the etalon weakens the 38.800-GHz pulse train more strongly (FIGS. 40G and 40H). When the repetition frequency is larger than 40.000 GHz, the etalon weakens the pulse train, as well. This function of the etalon will be described as follows.

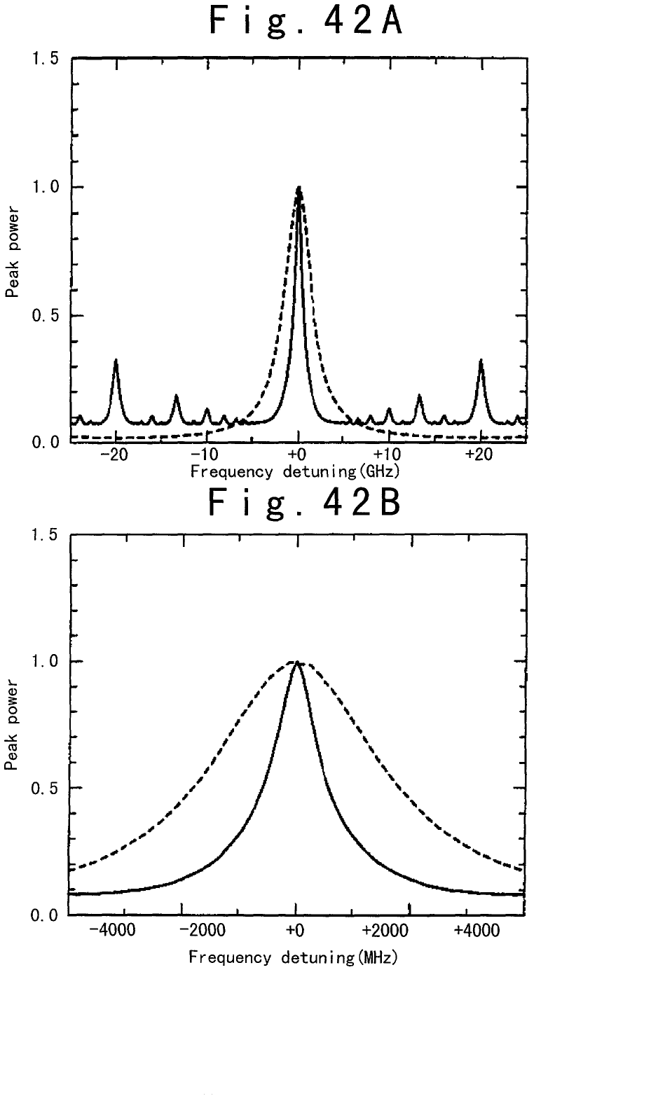

When the repetition frequency increases or decreases from 40.000 GHz, the optical-frequency spacing between the discrete spectral components stays at the transmissivity peaks of the etalon. The longer or the shorter the wavelength of the spectral component is, the more the etalon suppresses the component, as shown in FIGS. 40F and 40H. The solid curve in FIGS. 42 and 42B shows the decrease in the pulse peak intensity of a pulse train at the etalon output as a function of the repetition frequency detuning from 40.000 GHz. The FWHM bandwidth of this curve is 1.1 GHZ.

The output spectra in FIGS. 40F and 40H are calculated with using the following equation,

$${S}_{2} ( ϖ ) = \frac{1 - R}{1 - R \cdot exp ( i \cdot δ )} {S}_{1} ( ϖ )$$

when δ=2·Δt·ω, where S₁(ω) and S₂(ω) represent the complex spectra at the etalon input and output, respectively, Δt represents the time for the optical components to propagate the etalon gap from the one end to the other end, and R represents the reflectivity of the etalon mirrors. The R is related to the finesse as,

$$finesse = \frac{4 R}{{( 1 - R )}^{2}}$$

The above relationship between S₁(ω) and S₂(ω) will be described in details in the “Principles of Optics” written by Max Born and Emil Wolf, for example. The waveforms at the etalon output (FIGS. 40C, 40E and 40G) are calculated by Fourier-transforming the respective complex spectra of S₂(ω).

When the loop frequency is designed to be 80 MHz, the repetition frequency of 40.000 GHz is the 500th harmonic of the loop frequency. While the 40-GHz MZI passes the 500th-harmonic pulse train, it suppresses peak intensities of the 499th-harmonic 39.920-GHz and 501th-harmonic 40.080-GHz pulse trains by 4%. The 498th-harmonic and 502th-harmonic pulse trains are suppressed by 12%. Thus, the etalon suppresses pulse trains having repetition frequencies other than 40 GHz. In other words, the etalon suppresses pulse trains having harmonic numbers other than 500. Consequently, the etalon suppresses the supermode noise.

The dashed curves in FIGS. 42A and 42B show the etalon transmissivity as a function of the optical frequency detuning (FIG. 41), for comparison. The dashed curves indicate that the repetition-frequency bandwidth of the etalon with respect to a pulse train is significantly narrower than its optical-frequency bandwidth with respect to continuous-wave light. When the width of each pulse is narrowed from 1.5 ps, the repetition-frequency bandwidth is further narrowed from 1.1 GHz and consequently the etalon suppresses the supermode noise more effectively.

Because an etalon having a larger finesse exhibits a narrower bandwidth than that of the solid curves in FIGS. 42A and 42B, such an etalon suppresses supermode noise more effectively. When the loop structure is relatively large, i.e., when the loop frequency is relatively low and the harmonic number is relatively large, the etalon having a large finesse is more favorable than the delay interferometer 7, 24 or 77 in the above embodiments, for sufficiently suppressing the supermode noise.

In place of the etalon, any type of optical component that is designed and fabricated to exhibit an appropriate free spectral range and an appropriate finesse as described above can be used in the present invention. A sampled chirped fiber grating, a ring resonator, or a photonic crystal structure can be used instead of the etalon. For example, S. Y. Set et al. shows a sampled fiber grating that exhibits the free spectral range of 40 GHz and the finesse of 10 in the digest of technical papers (21st annual meeting of the Laser Society of Japan, Tokyo, Jan. 30-31, 2001, page 202). Any combination of delay interferometers, etalon, and above-mentioned optical components can be used in the present invention, too.

As previously described in detail, in accordance with the optical pulse signal generation apparatus of the present invention, the following effects can be achieved. That is, There are provided the continuous wave light source for outputting the continuous wave light, the semiconductor optical amplifier by which the continuous wave light supplied from the continuous wave light source is amplified, while the amplified continuous wave light passes therethrough, and the spontaneous emission light is generated, and the circular optical light waveguide for circulating both of the continuous wave light and the spontaneous emission light, which are supplied from the semiconductor optical amplifier. Therefore, the optical pulse signal generates apparatus for generating the optical pulse sequence having the specific pulse width, the specific repetition frequency, and the specific wavelength. As a consequence, the optical pulse signal generation apparatus can be made compact and can have the wide wavelength range, and furthermore, can have the long-term stable operation reliability and the mass production adaptability. Also, the electric power of the high frequency electric clock signal input required by the optical clock pulse signal generator can be made relatively low.

Also, the circular optical waveguide is composed of at least the delay interferometer for generating the optical pulse signal from the continuous wave light supplied from the semiconductor optical amplifier, the delay for delaying the optical pulse signal outputted from the delay interferometer, the second delay interferometer whose delay time is longer than that of the delay interferometer and is equal to an integral times of the input pulse signal interval, and the signal light input port for inputting the signal light. As a result, the optical clock pulse signal whose pulse width short and is approximated to the Fourier transformation limit can be generated in high speed.

Furthermore, the circular optical waveguide is composed of at least the delay interferometer for generating the optical pulse signal from the continuous wave light supplied from the semiconductor optical amplifier, the delay for delaying the optical pulse signal derived from the delay interferometer, the second delay interferometer whose delay time is longer than that of the delay interferometer and is equal to the value obtained by multiplying the input pulse signal interval by the integer, and the optical clock input port for inputting the optical clock pulse sequence. As a result, the high speed optical clock can be processed in high speed. Also, the optical clock frequency-dividing apparatus can have both of the operation capable of removing the jitter components contained in the input optical clock pulse signal, and the frequency-dividing operation having the necessary frequency dividing ratio, and furthermore, can output the frequency-divided optical clock approximated to the Fourier transform limit.

Moreover, the circular optical waveguide is composed of at least the delay interferometer for generating the optical pulse signal from the continuous wave light supplied from the semiconductor optical amplifier, the delay for delaying the optical pulse signal derived from the delay interferometer, the second delay interferometer whose delay time is longer than that of the delay interferometer and is equal to the value obtained by multiplying the input pulse signal interval by the integer, and the signal light input port for inputting the signal light. As a result, the optical pulse signal extracting frequency-dividing apparatus can have the merit that both the clock extracting operation and the clock frequency-dividing operation can be simultaneously carried out in high speed and in high performance.

It should be noted that in the above embodiments, the components having the same name may have the same or similar function. Also, it would be apparent to an ordinary skilled person that a part or whole of either of the above embodiments may be applied to the other embodiments.

What is claimed is:

1. An optical pulse signal generating apparatus comprising:
a circular optical waveguide in which a circulating optical signal can circulate in a direction;
a first optical combiner provided in said circular optical waveguide and inputting an externally inputted optical signal to combine said externally inputted optical signal and said circulating optical signal in said circular optical waveguide to produce a combination optical signal;
an optical converter provided in said circular optical waveguide and having a semiconductor optical amplifier which amplifies said combination optical signal and emits an amplified optical signal including an amplified spontaneous emission (ASE) optical signal, wherein said optical converter outputs an optical pulse sequence signal from said combination optical signal via said amplified optical signal; and
a first optical splitter outputting said optical pulse sequence signal from said circular optical waveguide,
wherein a portion of said generated optical pulse sequence signal circulates in said circular optical waveguide to reach said first optical combiner, and said generated optical pulse sequence signal finally has a specific pulse width and a specific repetition frequency.

2. The optical pulse signal generating apparatus according to claim 1, further comprising:
a continuous wave light source generating a continuous wave optical signal; and
an optical signal supplying unit which polarizes said continuous wave optical signal and supplies the polarized continuous wave optical signal as said input optical signal to said first optical combiner.

3. The optical pulse signal generating apparatus according to claim 2, further comprising:
a removing unit provided in said circular optical waveguide and removing a remaining portion of said generated optical pulse sequence signal other than said portion.

4. The optical pulse signal generating apparatus according to claim 3, wherein said remaining portion has a polarization direction orthogonal to a polarization direction of said polarized continuous wave optical signal outputted from said optical signal supplying unit.

5. The optical pulse signal generating apparatus according to claim 1, wherein said optical converter comprises:
said semiconductor optical amplifier;
a first delay interferometer generating said optical pulse signal from said amplified optical signal outputted from said semiconductor optical amplifier; and
a first optical filter filtering said optical pulse signal to generate said optical pulse sequence signal.

6. The optical pulse signal generating apparatus according to claim 1, wherein said semiconductor optical amplifier carries out phase modulation and intensity modulation to said combination optical signal.

7. The optical pulse signal generating apparatus according to claim 5, wherein said first delay interferometer is given a predetermined initial phase bias and accomplishes an optical phase adjusting function using said initial phase bias.

8. The optical pulse signal generating apparatus according to claim 7, wherein said first delay interferometer passes said amplified optical signal for a time period from when an optical component with a smaller delay of said amplified optical signal starts to rise to when anther optical component with a larger delay thereof starts to fall, to generate said optical pulse signal.

9. The optical pulse signal generating apparatus according to claim 5, wherein said first optical filter removes said ASE optical signal to determine a center wavelength and width of a transmission spectrum of said optical pulse sequence signal such that said optical pulse sequence signal is outputted.

10. The optical pulse signal generating apparatus according to claim 1, further comprising:
a time delay provided in said circular optical waveguide after said optical converter in said direction to adjust a circulating time of said circulating optical signal.

11. The optical pulse signal generating apparatus according to claim 1, further comprising:
a second delay interferometer provided in said circular optical waveguide after said optical converter in said direction to uniformly distribute power of said optical pulse sequence signal between optical pulses, and to control a time interval between said optical pulses.

12. The optical pulse signal generating apparatus according to claim 1, further comprising:
an etalon provided in said circular optical waveguide after said optical converter in said direction.

13. The optical pulse signal generating apparatus according to claim 1, wherein an amplification of said semiconductor optical amplifier is larger than an optical circulation loss in said circular optical waveguide, and
wherein said optical pulse signal generating apparatus further includes:
an optical attenuator attenuating said optical pulse sequence signal such that said amplification of said semiconductor optical amplifier is equal to a sum of an attenuation by said optical attenuator and said optical circulation loss.

14. The optical pulse signal generating apparatus according to claim 1, wherein an amplification of said semiconductor optical amplifier is smaller than an optical circulation loss in said circular optical waveguide, and
wherein said optical pulse signal generating apparatus further includes:
an optical amplifier having an amplification and provided in said circular optical waveguide, a sum of said amplification of said semiconductor optical amplifier and said amplification of said optical amplifier is larger than said optical circulation loss; and
an optical attenuator attenuating said optical pulse sequence signal such that said sum of said amplification of said semiconductor optical amplifier and said amplification of said optical amplifier is equal to a sum of an attenuation by said optical attenuator and said optical circulation loss.

15. The optical pulse signal generating apparatus according to any of claims 1 to 14, further comprising:
an original signal optical combiner provided in said circular optical waveguide and synthesizing an original optical signal to said circulating optical signal.

16. The optical pulse signal generating apparatus according to claim 15, wherein said optical pulse sequence signal outputted from said first optical splitter has a same frequency as a frequency of said original optical signal.

17. The optical pulse signal generating apparatus according to claim 15, wherein said optical converter includes said first delay interferometer provided in said circular optical waveguide and generating said optical pulse signal from said amplified optical signal outputted from said semiconductor optical amplifier, and
said first delay interferometer has a delay time an integral times more than said frequency of said original optical signal.

18. The optical pulse signal generating apparatus according to claim 17, further comprising said second delay interferometer provided in said circular optical waveguide to uniformly distribute power of said optical pulse sequence signal between optical pulses, and to control a time interval between said optical pulses, and
said second delay interferometer has a delay time said integral times more than said frequency of said original optical signal.

19. An optical pulse signal generating apparatus comprising:
a circular optical waveguide in which a traveling optical signal can circulate in a direction;
a first optical combiner provided in said circular optical waveguide and inputting a first externally inputted optical signal to combine said first externally inputted optical signal and a first optical pulse sequence signal as said traveling optical signal in said circular optical waveguide to produce a first combination optical signal;
a first optical converter provided in said circular optical waveguide and converting said first combination optical signal into a second optical pulse sequence signal with a first wavelength;
a first optical splitter provided in said circular optical waveguide and outputting said second optical pulse sequence signal from said circular optical waveguide;
a second optical combiner provided in said circular optical waveguide and synthesizing a second externally inputted optical signal and said second optical pulse sequence signal as said traveling optical signal in said circular optical waveguide to produce a second combination optical signal;
a second optical converter provided in said circular optical waveguide and converting said second combination optical signal into said first optical pulse sequence signal with a second wavelength; and
a second optical splitter provided in said circular optical waveguide and outputting said first optical pulse sequence signal from said circular optical waveguide.

20. The optical pulse signal generating apparatus according to claim 19, wherein said first optical converter includes a first semiconductor optical amplifier which amplifies said first combination optical signal and emits a first amplified optical signal including a first amplified spontaneous emission (ASE) optical signal, wherein said first optical converter outputs said second optical pulse sequence signal from said first combination optical signal via said first amplified optical signal, and
said second optical converter includes a second semiconductor optical amplifier which amplifies said second combination optical signal and emits a second amplified optical signal including a second amplified spontaneous emission (ASE) optical signal, wherein said second optical converter outputs said first optical pulse sequence signal from said second combination optical signal via said second amplified optical signal.

21. The optical pulse signal generating apparatus according to claim 19, further comprising:
a first continuous wave light source generating a first continuous wave optical signal to supply to said first optical combiner as said first externally inputted optical signal; and
a second continuous wave light source generating a second continuous wave optical signal to supply to said second optical combiner as said second externally inputted optical signal.

22. The optical pulse signal generating apparatus according to claim 20, wherein said first optical converter comprises:
said first semiconductor optical amplifier;
a first delay interferometer generating a first optical pulse signal from said first amplified optical signal outputted from said first semiconductor optical amplifier; and
a first optical filter filtering said first optical pulse signal to generate said second optical pulse sequence signal, and
said second optical converter comprises:
said second semiconductor optical amplifier;
a second delay interferometer generating a second optical pulse signal from said second amplified optical signal outputted from said second semiconductor optical amplifier; and
a second optical filter filtering said second optical pulse signal to generate said first optical pulse sequence signal.

23. The optical pulse signal generating apparatus according to claim 20, wherein said first semiconductor optical amplifier carries out phase modulation and intensity modulation to said first combination optical signal, and
said second semiconductor optical amplifier carries out phase modulation and intensity modulation to said second combination optical signal.

24. The optical pulse signal generating apparatus according to claim 22, wherein said first and second delay interferometers are given predetermined initial phase biases and accomplish optical phase adjusting functions using said initial phase biases, respectively.

25. The optical pulse signal generating apparatus according to claim 22, wherein said first optical filter removes said first ASE optical signal from said second optical pulse sequence signal to determine said first wavelength and a width of a transmission spectrum of said second optical pulse sequence signal, and
said second optical filter removes said second ASE optical signal from said first optical pulse sequence signal to determine said second wavelength and a width of a transmission spectrum of said first optical pulse sequence signal.

26. The optical pulse signal generating apparatus according to claim 19, further comprising:
a time delay provided in said circular optical waveguide to adjust a circulating time of said traveling optical signal.

27. The optical pulse signal generating apparatus according to claim 19, further comprising:
a third delay interferometer provided in said circular optical waveguide to remove supermode noise.

28. The optical pulse signal generating apparatus according to claim 19, further comprising:
an etalon provided in said circular optical waveguide to remove supermode noise.

29. The optical pulse signal generating apparatus according to claim 19, wherein a sum of amplifications of said first and second semiconductor optical amplifiers is larger than an optical circulation loss in said circular optical waveguide, and
wherein said optical pulse signal generating apparatus further includes:
an optical attenuator attenuating said fist or second optical pulse sequence signal such that said sum of the amplifications of said first and second semiconductor optical amplifiers is equal to a sum of an attenuation by said optical attenuator and said optical circulation loss.

30. The optical pulse signal generating apparatus according to claim 19, wherein a sum of amplifications of said first and second semiconductor optical amplifiers is smaller than an optical circulation loss in said circular optical waveguide, and
wherein said optical pulse signal generating apparatus further includes:
an optical amplifier having an amplification and provided in said circular optical waveguide, a sum of said sum of said amplifications of said first and second semiconductor optical amplifiers and said amplification of said optical amplifier is larger than said optical circulation loss; and
an optical attenuator attenuating said first or second optical pulse sequence signal such that said sum of said amplification of said semiconductor optical amplifier and said amplification of said optical amplifier is equal to a sum of an attenuation by said optical attenuator and said optical circulation loss.

31. The optical pulse signal generating apparatus according to any of claims 19 to 30, further comprising:
an original signal optical combiner provided in said circular optical waveguide and synthesizing an original optical signal to said circulating optical signal.

32. The optical pulse signal generating apparatus according to claim 31, wherein said second optical pulse sequence signal outputted from said first optical splitter has a same frequency as a frequency of said original optical signal, and
said first optical pulse sequence signal outputted from said second optical splitter has the same frequency as said frequency of said original optical signal.

33. The optical pulse signal generating apparatus according to claim 31, wherein said first optical converter includes said first delay interferometer provided in said circular optical waveguide and generating said first optical pulse signal from said first amplified optical signal outputted from said first semiconductor optical amplifier,
said first delay interferometer has a delay time an integral times more than a frequency of said original optical signal,
said second optical converter includes said second delay interferometer provided in said circular optical waveguide and generating said second optical pulse signal from said second amplified optical signal outputted from said second semiconductor optical amplifier, and
said second delay interferometer has a delay time said integral times more than said frequency of said original optical signal.

34. The optical pulse signal generating apparatus according to any of claims 19 to 30, further comprising:
an original signal optical combiner synthesizing an original optical signal and said second externally inputted optical signal into a combination optical signal to output said combination optical signal to said second optical combiner in place of said second externally inputted optical signal.

35. The optical pulse signal generating apparatus according to claim 34, wherein said second optical pulse sequence signal outputted from said first optical splitter has a same frequency as a frequency of said original optical signal, and
said first optical pulse sequence signal outputted from said second optical splitter has the same frequency as said frequency of said original optical signal.

36. The optical pulse signal generating apparatus according to claim 34, wherein said first optical converter includes said first delay interferometer provided in said circular optical waveguide and generating said first optical pulse signal from said first amplified optical signal outputted from said first semiconductor optical amplifier,
said first delay interferometer has a delay time an integral times more than a frequency of said original optical signal,
said second optical converter includes said second delay interferometer provided in said circular optical waveguide and generating said second optical pulse signal from said second amplified optical signal outputted from said second semiconductor optical amplifier, and
said second delay interferometer has a delay time said integral times more than said frequency of said original optical signal.

37. An optical pulse signal generating apparatus comprising:
an optical waveguide in which a traveling optical signal can travel in either direction;
a total reflection mirror provided at one end of said optical waveguide;
an optical circulator provided at the other end of said optical waveguide, supplying an external input optical signal to said optical waveguide as a first traveling optical signal traveling in a first direction from said optical circulator to said total reflection mirror, and outputting an optical pulse sequence signal on said optical waveguide as a second traveling optical signal traveling in a second direction from said total reflection mirror to said optical circulator;
a first optical filter passing said first traveling optical signal, and removing an amplified spontaneous emission (ASE) optical signal from said second traveling optical signal to supply to said optical circulator;
a semiconductor optical amplifier emitting an amplified spontaneous emission (ASE) optical signal, and amplifying said first and second traveling optical signals and outputting amplified optical signals including said ASE optical signals into said first and second directions;
a second optical filter passing said second traveling optical signal to said semiconductor optical amplifier, and removing said amplified spontaneous emission (ASE) optical signal from said first traveling optical signal;
a delay interferometer generating said optical pulse sequence signal from said first traveling optical signal traveling from said semiconductor optical amplifier in said first direction and said second traveling optical signal traveling from said total reflection mirror in said second direction.

38. The optical pulse signal generating apparatus according to claim 37, further comprising:
a continuous wave light source generating and supplying a continuous wave optical signal as said external input optical signal to said optical circulator.

39. The optical pulse signal generating apparatus according to claim 37, wherein said semiconductor optical amplifier carries out phase modulation and intensity modulation to said first and second optical signals.

40. The optical pulse signal generating apparatus according to claim 37, wherein said delay interferometer is given a predetermined initial phase bias and accomplishes an optical phase adjusting function using said initial phase bias.

41. The optical pulse signal generating apparatus according to claim 37, wherein said delay interferometer passes said first traveling optical signal for a time period from when an optical component with a smaller delay of said first traveling optical signal starts to rise to when anther optical component with a larger delay thereof starts to fall, and passes said second traveling optical signal for a time period from when an optical component with a smaller delay of said second traveling optical signal starts to rise to when anther optical component with a larger delay thereof starts to fall, to generate said optical pulse sequence signal.

42. The optical pulse signal generating apparatus according to claim 37, further comprising:
a time delay provided in said optical waveguide to adjust raveling times of said first and second traveling optical signals.

43. The optical pulse signal generating apparatus according to claim 37, further comprising:
an optical adjusting unit provided between said total reflection mirror and said delay interferometer and adjusting a phase and delay time of said first traveling optical signal.

44. The optical pulse signal generating apparatus according to claim 43, further comprising:
another optical waveguide;
an additional total reflection mirror connected to one end of said another optical waveguide; and
an optical splitting and synthesizing unit connected to said optical adjusting unit, said another optical waveguide and said delay interferometer, and splitting said first traveling optical signal to two components, which are traveled to said total reflection mirror through said optical adjusting unit and to said additional total reflection mirror, and synthesizing optical signals reflected by said total reflection mirror and said additional total reflection mirror.

45. The optical pulse signal generating apparatus according to any of claims 37 to 44, further comprising:
an original signal optical combiner synthesizing an original optical signal and said external input optical signal to produce a combination optical signal and outputting said combination optical signal to said optical circulator in place of said external input optical signal.

46. The optical pulse signal generating apparatus according to claim 45, wherein said optical pulse sequence signal outputted from said optical circulator has a same frequency as a frequency of said original optical signal.

47. The optical pulse signal generating apparatus according to claim 45, wherein said delay interferometer has a delay time an integral times more than a frequency of said original optical signal.

48. The optical pulse signal generating apparatus according to any of claims 37 to 44, further comprising:
an original signal optical combiner synthesizing an original optical signal into said optical waveguide.

49. The optical pulse signal generating apparatus according to claim 48, wherein said optical pulse sequence signal outputted from said optical circulator has a same frequency as a frequency of said original optical signal.

50. The optical pulse signal generating apparatus according to claim 48, wherein said delay interferometer has a delay time an integral times more than a frequency of said original optical signal.

51. An optical pulse signal generating apparatus comprising:
a first optical waveguide in which a traveling optical signal can travel;
a circular optical waveguide in which a circulating optical signal can circulate in a direction;
a semiconductor optical amplifier provided in said first optical waveguide and amplifying an input optical signal traveling in a first direction to said circular optical waveguide to emit a first amplified optical signal including an amplified spontaneous emission (ASE) optical signal, and an output optical signal traveling in a second direction from said circular optical waveguide to emit a second amplified optical signal including an amplified spontaneous emission (ASE) optical signal,
a first optical circulator connected to said first optical waveguide and said circular optical waveguide and outputting said first amplified optical signal to said circular optical waveguide as said circulating optical signal and outputting said circulating optical signal to said first optical waveguide as said output optical signal;
a first delay interferometer provided in said circular optical waveguide and generating an optical pulse signal from said circulating optical signal; and
a first optical filter provided in said circular optical waveguide and filtering said optical pulse signal to generate said optical pulse sequence signal as said circulating optical signal.

52. The optical pulse signal generating apparatus according to claim 51, further comprising:
a second optical waveguide;
a second optical circulator provided in said optical waveguide in said second direction from said semiconductor optical amplifier and connected to said second optical waveguide, wherein said second optical circulator outputs said input optical signal to said semiconductor optical amplifier and said second amplified optical signal to said second optical waveguide; and
a second optical filter provided in said second optical waveguide and filtering said second amplified optical signal to produce a first output optical pulse sequence signal.

53. The optical pulse signal generating apparatus according to claim 52, wherein said second optical filter removes said ASE optical signal from said second amplified optical signal.

54. The optical pulse signal generating apparatus according to claim 51, further comprising:
an optical splitter provided in said circular optical waveguide and outputting said circulating optical signal as a second output optical pulse sequence signal.

55. The optical pulse signal generating apparatus according to claim 51, further comprising:
a continuous wave light source generating a continuous wave optical signal to output to said first optical waveguide.

56. The optical pulse signal generating apparatus according to claim 51, wherein said semiconductor optical amplifier carries out phase modulation and intensity modulation to said combination optical signal.

57. The optical pulse signal generating apparatus according to claim 51, wherein said first delay interferometer is given a predetermined initial phase bias and accomplishes an optical phase adjusting function using said initial phase bias.

58. The optical pulse signal generating apparatus according to claim 51, wherein said first delay interferometer passes said amplified optical signal for a time period from when an optical component with a smaller delay of said amplified optical signal starts to rise to when anther optical component with a larger delay thereof starts to fall, to generate said optical pulse signal.

59. The optical pulse signal generating apparatus according to claim 51, wherein said first optical filter removes said ASE optical signal from said circulating optical signal.

60. The optical pulse signal generating apparatus according to claim 51, further comprising:
a time delay provided in said circular optical waveguide to adjust a circulating time of said circulating optical signal.

61. The optical pulse signal generating apparatus according to claim 51, further comprising:
a second delay interferometer provided in said circular optical waveguide to uniformly distribute power of said optical pulse sequence signal between optical pulses, and to control a time interval between said optical pulses.

62. The optical pulse signal generating apparatus according to claim 51, further comprising:
an etalon provided in said circular optical waveguide to reduce supermode noise.

63. The optical pulse signal generating apparatus according to claim 51, wherein an amplification of said semiconductor optical amplifier is larger than an optical circulation loss in said circular optical waveguide, and
wherein said optical pulse signal generating apparatus further includes:
an optical attenuator attenuating said optical pulse sequence signal such that said amplification of said semiconductor optical amplifier is equal to a sum of an attenuation by said optical attenuator and said optical circulation loss.

64. The optical pulse signal generating apparatus according to claim 51, wherein an amplification of said semiconductor optical amplifier is smaller than an optical circulation loss in said circular optical waveguide, and
wherein said optical pulse signal generating apparatus further includes:
an optical amplifier having an amplification and provided in said circular optical waveguide, a sum of said amplification of said semiconductor optical amplifier and said amplification of said optical amplifier is larger than said optical circulation loss; and
an optical attenuator attenuating said optical pulse sequence signal such that said sum of said amplification of said semiconductor optical amplifier and said amplification of said optical amplifier is equal to a sum of an attenuation by said optical attenuator and said optical circulation loss.

65. The optical pulse signal generating apparatus according to any of claims 51 or 53 to 64, further comprising:
an original signal optical combiner provided in said circular optical waveguide and synthesizing an original optical signal to said circulating optical signal,
a second optical waveguide;
a second optical circulator provided in said optical waveguide in said second direction from said semiconductor optical amplifier and connected to said second optical waveguide, wherein said second optical circulator outputs said input optical signal to said semiconductor optical amplifier and said second amplified optical signal to said second optical waveguide; and
a second optical filter provided in said second optical waveguide and filtering said second amplified optical signal to produce a first output optical pulse sequence signal.

66. The optical pulse signal generating apparatus according to claim 65, wherein said first output optical pulse sequence signal has a same frequency as a frequency of said original optical signal.

67. The optical pulse signal generating apparatus according to claim 65, wherein said first delay interferometer has a delay time an integral times more than a frequency of said original optical signal.

68. The optical pulse signal generating apparatus according to claim 65, wherein when said optical pulse signal generating apparatus includes said second delay interferometer, said second delay interferometer has a delay time said integral times more than said frequency of said original optical signal.

69. An optical pulse signal regeneration apparatus comprising:
a delay delaying an input light pulse signal;
an optical pulse signal generating unit generating an optical pulse sequence signal from said input light pulse signal; and
an optical gate gating said optical pulse sequence signal using said delayed light pulse signal as a control signal.

70. The optical pulse signal regeneration apparatus according to claim 69, wherein said optical pulse signal generating unit comprises:
a circular optical waveguide in which a circulating optical signal can circulate in a direction;
a first optical combiner provided in said circular optical waveguide and inputting an externally inputted optical signal to combine said externally inputted optical signal and said circulating optical signal in said circular optical waveguide to produce a combination optical signal;
an original signal optical combiner provided in said circular optical waveguide and synthesizing said input light pulse signal as an original optical signal to said circulating optical signal;
an optical converter provided in said circular optical waveguide and having a semiconductor optical amplifier which amplifies said combination optical signal and emits an amplified optical signal including an amplified spontaneous emission (ASE) optical signal, wherein said optical converter outputs an optical pulse sequence signal from said combination optical signal via said amplified optical signal; and
a first optical splitter provided outputting said optical pulse sequence signal from said circular optical waveguide,
wherein a portion of said generated optical pulse sequence signal circulates in said circular optical waveguide to reach said first optical combiner, and said generated optical pulse sequence signal finally has a specific pulse width and a specific repetition frequency.

71. The optical pulse signal regeneration apparatus according to claim 70, wherein said optical pulse signal generating unit further comprises:
a continuous wave light source generating a continuous wave optical signal; and
an optical signal supplying unit which polarizes said continuous wave optical signal and supplies the polarized continuous wave optical signal as said input optical signal to said first optical combiner.

72. The optical pulse signal generating apparatus according to claim 71, wherein said optical pulse signal generating unit further comprises:
a removing unit provided in said circular optical waveguide and removing a remaining portion of said generated optical pulse sequence signal other than said portion.

73. The optical pulse signal regeneration apparatus according to claim 69, wherein said optical pulse signal generating unit comprises:
a circular optical waveguide in which a traveling optical signal can circulate in a direction;
a first optical combiner provided in said circular optical waveguide and inputting a first externally inputted optical signal to combine said first externally inputted optical signal and a first optical pulse sequence signal as said traveling optical signal in said circular optical waveguide to produce a first combination optical signal;
an original signal optical combiner provided in said circular optical waveguide and synthesizing said light pulse signal as an original optical signal into said circulating optical signal;
a first optical converter provided in said circular optical waveguide and converting said first combination optical signal into a second optical pulse sequence signal with a first wavelength;
a first optical splitter provided in said circular optical waveguide and outputting said second optical pulse sequence signal from said circular optical waveguide;
a second optical combiner provided in said circular optical waveguide and synthesizing a second externally inputted optical signal and said second optical pulse sequence signal as said traveling optical signal in said circular optical waveguide to produce a second combination optical signal;
a second optical converter provided in said circular optical waveguide and converting said second combination optical signal into said first optical pulse sequence signal with a second wavelength; and
a second optical splitter provided in said circular optical waveguide and outputting said first optical pulse sequence signal from said circular optical waveguide, one of said first and second optical pulse sequence signal being outputted as said optical pulse sequence signal.

74. The optical pulse signal regeneration apparatus according to claim 69, wherein said optical pulse signal generating unit comprises:
an optical waveguide in which a traveling optical signal can travel in either direction;
a total reflection mirror provided at one end of said optical waveguide;
an original signal optical combiner synthesizing said light pulse signal as an original optical signal and an external input optical signal to produce a combination optical signal and outputting said combination optical signal;
an optical circulator provided at the other end of said optical waveguide, supplying said combination optical signal to said optical waveguide as a first traveling optical signal traveling in a first direction from said optical circulator to said total reflection mirror, and outputting said optical pulse sequence signal on said optical waveguide as a second traveling optical signal traveling in a second direction from said total reflection mirror to said optical circulator;
a first optical filter passing said first traveling optical signal, and removing an amplified spontaneous emission (ASE) optical signal from said second traveling optical signal to supply to said optical circulator;
a semiconductor optical amplifier emitting an amplified spontaneous emission (ASE) optical signal, and amplifying said first and second traveling optical signals and outputting amplified optical signals including said ASE optical signals into said first and second directions;
a second optical filter passing said second traveling optical signal to said semiconductor optical amplifier, and removing said amplified spontaneous emission (ASE) optical signal from said first traveling optical signal;
a delay interferometer generating said optical pulse sequence signal from said first traveling optical signal traveling from said semiconductor optical amplifier in said first direction and said second traveling optical signal traveling from said total reflection mirror in said second direction.

75. The optical pulse signal regeneration apparatus according to claim 69, wherein said optical pulse signal generating unit comprises:
an optical waveguide in which a traveling optical signal can travel in either direction;
a total reflection mirror provided at one end of said optical waveguide;
an original signal optical combiner synthesizing said light pulse signal as an original optical signal into said optical waveguide;
an optical circulator provided at the other end of said optical waveguide, supplying an external input optical signal to said optical waveguide as a first traveling optical signal traveling in a first direction from said optical circulator to said total reflection mirror, and outputting said optical pulse sequence signal on said optical waveguide as a second traveling optical signal traveling in a second direction from said total reflection mirror to said optical circulator;
a first optical filter passing said first traveling optical signal, and removing an amplified spontaneous emission (ASE) optical signal from said second traveling optical signal to supply to said optical circulator;
a semiconductor optical amplifier emitting an amplified spontaneous emission (ASE) optical signal, and amplifying said first and second traveling optical signals and outputting amplified optical signals including said ASE optical signals into said first and second directions;
a second optical filter passing said second traveling optical signal to said semiconductor optical amplifier, and removing said amplified spontaneous emission (ASE) optical signal from said first traveling optical signal;
a delay interferometer generating said optical pulse sequence signal from said first traveling optical signal traveling from said semiconductor optical amplifier in said first direction and said second traveling optical signal traveling from said total reflection mirror in said second direction.

76. The optical pulse signal regeneration apparatus according to claim 69, wherein said optical pulse signal generating unit comprises:
a first optical waveguide in which a traveling optical signal can travel;
a circular optical waveguide in which a circulating optical signal can circulate in a direction;
a semiconductor optical amplifier provided in said first optical waveguide and amplifying an input optical signal traveling in a first direction to said circular optical waveguide to emit a first amplified optical signal including an amplified spontaneous emission (ASE) optical signal, and an output optical signal traveling in a second direction from said circular optical waveguide to emit a second amplified optical signal including an amplified spontaneous emission (ASE) optical signal,
a first optical circulator connected to said first optical waveguide and said circular optical waveguide and outputting said first amplified optical signal to said circular optical waveguide as said circulating optical signal and outputting said circulating optical signal to said first optical waveguide as said output optical signal;
a first delay interferometer provided in said circular optical waveguide and generating an optical pulse signal from said circulating optical signal;
a first optical filter provided in said circular optical waveguide and filtering said optical pulse signal to generate said optical pulse sequence signal as said circulating optical signal;
an original signal optical combiner provided in said circular optical waveguide and synthesizing said light pulse signal as an original optical signal to said circulating optical signal,
a second optical waveguide;
a second optical circulator provided in said optical waveguide in said second direction from said semiconductor optical amplifier and connected to said second optical waveguide, wherein said second optical circulator outputs said input optical signal to said semiconductor optical amplifier and said second amplified optical signal to said second optical waveguide; and
a second optical filter provided in said second optical waveguide and filtering said second amplified optical signal to produce said optical pulse sequence signal.

77. The optical pulse signal regeneration apparatus according to claim 69, wherein said optical pulse signal generating unit comprises:
a first optical waveguide in which a traveling optical signal can travel;
a circular optical waveguide in which a circulating optical signal can circulate in a direction;
a semiconductor optical amplifier provided in said first optical waveguide and amplifying an input optical signal traveling in a first direction to said circular optical waveguide to emit a first amplified optical signal including an amplified spontaneous emission (ASE) optical signal, and an output optical signal traveling in a second direction from said circular optical waveguide to emit a second amplified optical signal including an amplified spontaneous emission (ASE) optical signal,
a first optical circulator connected to said first optical waveguide and said circular optical waveguide and outputting said first amplified optical signal to said circular optical waveguide as said circulating optical signal and outputting said circulating optical signal to said first optical waveguide as said output optical signal;
a first delay interferometer provided in said circular optical waveguide and generating an optical pulse signal from said circulating optical signal;
a first optical filter provided in said circular optical waveguide and filtering said optical pulse signal to generate said optical pulse sequence signal as said circulating optical signal;
an original signal optical combiner provided in said circular optical waveguide and synthesizing said light pulse signal as an original optical signal to said circulating optical signal; and
an optical splitter provided in said circular optical waveguide and taking out said optical pulse sequence signal from said circular optical waveguide.

78. An optical pulse signal demultiplexing apparatus comprising:
a delay delaying an input light pulse signal which is subjected to time division multiplexing of 1/n (n is an integer);
an optical pulse signal generating unit generating an optical pulse sequence signal from said input light pulse signal, said optical pulse sequence signal having a frequency n times more than a frequency of said light pulse signal; and
an optical gate gating said delayed light pulse signal using said optical pulse sequence signal as a control signal.

79. The optical pulse signal demultiplexing apparatus according to claim 78, wherein said optical pulse signal generating unit comprises:
a circular optical waveguide in which a circulating optical signal can circulate in a direction;
a first optical combiner provided in said circular optical waveguide and inputting an externally inputted optical signal to combine said externally inputted optical signal and said circulating optical signal in said circular optical waveguide to produce a combination optical signal;
an original signal optical combiner provided in said circular optical waveguide and synthesizing said light pulse signal as an original optical signal to said circulating optical signal;
an optical converter provided in said circular optical waveguide and having a semiconductor optical amplifier which amplifies said combination optical signal and emits an amplified optical signal including an amplified spontaneous emission (ASE) optical signal, wherein said optical converter outputs an optical pulse sequence signal from said combination optical signal via said amplified optical signal;
a first optical splitter provided outputting said optical pulse sequence signal from said circular optical waveguide,
wherein a portion of said generated optical pulse sequence signal circulates in said circular optical waveguide to reach said first optical combiner, and said generated optical pulse sequence signal finally has a specific pulse width and a specific repetition frequency, and
wherein said optical converter includes said first delay interferometer provided in said circular optical waveguide and generating said optical pulse signal from said amplified optical signal outputted from said semiconductor optical amplifier, and
said first delay interferometer has a delay time said n times more than said frequency of said original optical signal.

80. The optical pulse signal demultiplexing apparatus according to claim 78, wherein said optical pulse signal generating unit comprises:
a circular optical waveguide in which a traveling optical signal can circulate in a direction;
a first optical combiner provided in said circular optical waveguide and inputting a first externally inputted optical signal to combine said first externally inputted optical signal and a first optical pulse sequence signal as said traveling optical signal in said circular optical waveguide to produce a first combination optical signal;
an original signal optical combiner provided in said circular optical waveguide and synthesizing said light pulse signal as an original optical signal into said circulating optical signal;
a first optical converter provided in said circular optical waveguide and converting said first combination optical signal into a second optical pulse sequence signal with a first wavelength;
a first optical splitter provided in said circular optical waveguide and outputting said second optical pulse sequence signal from said circular optical waveguide;
a second optical combiner provided in said circular optical waveguide and synthesizing a second externally inputted optical signal and said second optical pulse sequence signal as said traveling optical signal in said circular optical waveguide to produce a second combination optical signal;
a second optical converter provided in said circular optical waveguide and converting said second combination optical signal into said first optical pulse sequence signal with a second wavelength; and
a second optical splitter provided in said circular optical waveguide and outputting said first optical pulse sequence signal from said circular optical waveguide, one of said first and second optical pulse sequence signal being outputted as said optical pulse sequence signal, and
wherein said first optical converter includes said first delay interferometer provided in said circular optical waveguide and generating said first optical pulse signal from said first amplified optical signal outputted from said first semiconductor optical amplifier, said first delay interferometer has a delay time said n times more than a frequency of said original optical signal,
said second optical converter includes said second delay interferometer provided in said circular optical waveguide and generating said second optical pulse signal from said second amplified optical signal outputted from said second semiconductor optical amplifier, and
said second delay interferometer has a delay time said n times more than said frequency of said original optical signal.

81. The optical pulse signal demultiplexing apparatus according to claim 78, wherein said optical pulse signal generating unit comprises:
an optical waveguide in which a traveling optical signal can travel in either direction;
a total reflection mirror provided at one end of said optical waveguide;
an original signal optical combiner synthesizing said light pulse signal as an original optical signal and an external input optical signal to produce a combination optical signal and outputting said combination optical signal;
an optical circulator provided at the other end of said optical waveguide, supplying said combination optical signal to said optical waveguide as a first traveling optical signal traveling in a first direction from said optical circulator to said total reflection mirror, and outputting said optical pulse sequence signal on said optical waveguide as a second traveling optical signal traveling in a second direction from said total reflection mirror to said optical circulator;
a first optical filter passing said first traveling optical signal, and removing an amplified spontaneous emission (ASE) optical signal from said second traveling optical signal to supply to said optical circulator;
a semiconductor optical amplifier emitting an amplified spontaneous emission (ASE) optical signal, and amplifying said first and second traveling optical signals and outputting amplified optical signals including said ASE optical signals into said first and second directions;
a second optical filter passing said second traveling optical signal to said semiconductor optical amplifier, and removing said amplified spontaneous emission (ASE) optical signal from said first traveling optical signal;
a delay interferometer generating said optical pulse sequence signal from said first traveling optical signal traveling from said semiconductor optical amplifier in said first direction and said second traveling optical signal traveling from said total reflection mirror in said second direction, wherein said delay interferometer has a delay time said n times more than said frequency of said original optical signal.

82. The optical pulse signal demultiplexing apparatus according to claim 78, wherein said optical pulse signal generating unit comprises:
an optical waveguide in which a traveling optical signal can travel in either direction;
a total reflection mirror provided at one end of said optical waveguide;
an original signal optical combiner synthesizing said light pulse signal as an original optical signal into said optical waveguide;
an optical circulator provided at the other end of said optical waveguide, supplying an external input optical signal to said optical waveguide as a first traveling optical signal traveling in a first direction from said optical circulator to said total reflection mirror, and outputting said optical pulse sequence signal on said optical waveguide as a second traveling optical signal traveling in a second direction from said total reflection mirror to said optical circulator;
a first optical filter passing said first traveling optical signal, and removing an amplified spontaneous emission (ASE) optical signal from said second traveling optical signal to supply to said optical circulator;
a semiconductor optical amplifier emitting an amplified spontaneous emission (ASE) optical signal, and amplifying said first and second traveling optical signals and outputting amplified optical signals including said ASE optical signals into said first and second directions;
a second optical filter passing said second traveling optical signal to said semiconductor optical amplifier, and removing said amplified spontaneous emission (ASE) optical signal from said first traveling optical signal;
a delay interferometer generating said optical pulse sequence signal from said first traveling optical signal traveling from said semiconductor optical amplifier in said first direction and said second traveling optical signal traveling from said total reflection mirror in said second direction, wherein said delay interferometer has a delay time said n times more than said frequency of said original optical signal.

83. The optical pulse signal demultiplexing apparatus according to claim 78, wherein said optical pulse signal generating unit comprises:
a first optical waveguide in which a traveling optical signal can travel;
a circular optical waveguide in which a circulating optical signal can circulate in a direction;
a semiconductor optical amplifier provided in said first optical waveguide and amplifying an input optical signal traveling in a first direction to said circular optical waveguide to emit a first amplified optical signal including an amplified spontaneous emission (ASE) optical signal, and an output optical signal traveling in a second direction from said circular optical waveguide to emit a second amplified optical signal including an amplified spontaneous emission (ASE) optical signal,
a first optical circulator connected to said first optical waveguide and said circular optical waveguide and outputting said first amplified optical signal to said circular optical waveguide as said circulating optical signal and outputting said circulating optical signal to said first optical waveguide as said output optical signal;
a first delay interferometer provided in said circular optical waveguide and generating an optical pulse signal from said circulating optical signal, wherein said first delay interferometer has a delay time said n times more than said frequency of said original optical signal;
a first optical filter provided in said circular optical waveguide and filtering said optical pulse signal to generate said optical pulse sequence signal as said circulating optical signal;
an original signal optical combiner provided in said circular optical waveguide and synthesizing said light pulse signal as an original optical signal to said circulating optical signal, a second optical waveguide;
a second optical circulator provided in said optical waveguide in said second direction from said semiconductor optical amplifier and connected to said second optical waveguide, wherein said second optical circulator outputs said input optical signal to said semiconductor optical amplifier and said second amplified optical signal to said second optical waveguide; and
a second optical filter provided in said second optical waveguide and filtering said second amplified optical signal to produce said optical pulse sequence signal.

84. The optical pulse signal demultiplexing apparatus according to claim 78, wherein said optical pulse signal generating unit comprises:
a first optical waveguide in which a traveling optical signal can travel;
a circular optical waveguide in which a circulating optical signal can circulate in a direction;
a semiconductor optical amplifier provided in said first optical waveguide and amplifying an input optical signal traveling in a first direction to said circular optical waveguide to emit a first amplified optical signal including an amplified spontaneous emission (ASE) optical signal, and an output optical signal traveling in a second direction from said circular optical waveguide to emit a second amplified optical signal including an amplified spontaneous emission (ASE) optical signal,
a first optical circulator connected to said first optical waveguide and said circular optical waveguide and outputting said first amplified optical signal to said circular optical waveguide as said circulating optical signal and outputting said circulating optical signal to said first optical waveguide as said output optical signal;
a first delay interferometer provided in said circular optical waveguide and generating an optical pulse signal from said circulating optical signal, wherein said first delay interferometer has a delay time said n times more than said frequency of said original optical signal;
a first optical filter provided in said circular optical waveguide and filtering said optical pulse signal to generate said optical pulse sequence signal as said circulating optical signal;
an original signal optical combiner provided in said circular optical waveguide and synthesizing said light pulse signal as an original optical signal to said circulating optical signal; and
an optical splitter provided in said circular optical waveguide and taking out said optical pulse sequence signal from said circular optical waveguide.

85. An optical pulse signal expanding apparatus comprising:
a delay delaying an input light pulse signal which is subjected to time division multiplexing of 1/n (n is an integer);
a first optical pulse signal generating unit generating a first light pulse sequence signal from said input light pulse signal, said first light pulse sequence signal having a frequency n times more than a frequency of said light pulse signal;
a second optical pulse signal generating unit generating a second light pulse sequence signal from said first light pulse sequence signal, said second light pulse sequence signal having a frequency m (m is an integer) times more than a frequency of said first light pulse sequence signal; and
an optical expanding unit expanding said delayed light pulse signal in units of m bits using said first and second pulse sequence signals.

86. The optical pulse signal expanding apparatus according to claim 85, wherein said optical expanding apparatus is mach-zehnder type delay optical circuit.

87. The optical pulse signal expanding apparatus according to claim 85, wherein said first optical pulse signal generating unit comprises:
a circular optical waveguide in which a circulating optical signal can circulate in a direction;
a first optical combiner provided in said circular optical waveguide and inputting said light pulse signal to combine said light pulse signal and said circulating optical signal in said circular optical waveguide to produce a combination optical signal;
an original signal optical combiner provided in said circular optical waveguide and synthesizing said input light pulse signal as an original optical signal to said circulating optical signal;
an optical converter provided in said circular optical waveguide and having a semiconductor optical amplifier which amplifies said combination optical signal and emits an amplified optical signal including an amplified spontaneous emission (ASE) optical signal, wherein said optical converter outputs an optical pulse sequence signal from said combination optical signal via said amplified optical signal;
a first optical splitter provided outputting said optical pulse sequence signal as said first light pulse sequence signal from said circular optical waveguide,
wherein a portion of said generated optical pulse sequence signal circulates in said circular optical waveguide to reach said first optical combiner, and said generated optical pulse sequence signal finally has a specific pulse width and a specific repetition frequency, and
wherein said optical converter includes said first delay interferometer provided in said circular optical waveguide and generating said optical pulse signal from said amplified optical signal outputted from said semiconductor optical amplifier, and
said first delay interferometer has a delay time n times more than said frequency of said original optical signal.

88. The optical pulse signal expanding apparatus according to claim 81, wherein said first optical pulse signal generating unit comprises:
a circular optical waveguide in which a traveling optical signal can circulate in a direction;
a first optical combiner provided in said circular optical waveguide and inputting a first externally inputted optical signal to combine said first externally inputted optical signal and a first optical pulse sequence signal as said traveling optical signal in said circular optical waveguide to produce a first combination optical signal;
an original signal optical combiner provided in said circular optical waveguide and synthesizing said light pulse signal as an original optical signal into said circulating optical signal;
a first optical converter provided in said circular optical waveguide and converting said first combination optical signal into a second optical pulse sequence signal with a first wavelength;
a first optical splitter provided in said circular optical waveguide and outputting said second optical pulse sequence signal from said circular optical waveguide;
a second optical combiner provided in said circular optical waveguide and synthesizing a second externally inputted optical signal and said second optical pulse sequence signal as said traveling optical signal in said circular optical waveguide to produce a second combination optical signal;
a second optical converter provided in said circular optical waveguide and converting said second combination optical signal into said first optical pulse sequence signal with a second wavelength; and
a second optical splitter provided in said circular optical waveguide and outputting said first optical pulse sequence signal from said circular optical waveguide, one of said first and second optical pulse sequence signal being outputted as said first light pulse sequence signal, and
wherein said first optical converter includes said first delay interferometer provided in said circular optical waveguide and generating said first optical pulse signal from said first amplified optical signal outputted from said first semiconductor optical amplifier,
said first delay interferometer has a delay time said n times more than a frequency of said original optical signal,
said second optical converter includes said second delay interferometer provided in said circular optical waveguide and generating said second optical pulse signal from said second amplified optical signal outputted from said second semiconductor optical amplifier, and
said second delay interferometer has a delay time said n times more than said frequency of said original optical signal.

89. The optical pulse signal expanding apparatus according to claim 85, wherein said first optical pulse signal generating unit comprises:
an optical waveguide in which a traveling optical signal can travel in either direction;
a total reflection mirror provided at one end of said optical waveguide;
an original signal optical combiner synthesizing said light pulse signal as an original optical signal and an external input optical signal to produce a combination optical signal and outputting said combination optical signal;
an optical circulator provided at the other end of said optical waveguide, supplying said combination optical signal to said optical waveguide as a first traveling optical signal traveling in a first direction from said optical circulator to said total reflection mirror, and outputting said optical pulse sequence signal on said optical waveguide as a second traveling optical signal traveling in a second direction from said total reflection mirror to said optical circulator, said optical pulse sequence signal being said first light pulse sequence signal;
a first optical filter passing said first traveling optical signal, and removing an amplified spontaneous emission (ASE) optical signal from said second traveling optical signal to supply to said optical circulator;
a semiconductor optical amplifier emitting an amplified spontaneous emission (ASE) optical signal, and amplifying said first and second traveling optical signals and outputting amplified optical signals including said ASE optical signals into said first and second directions;
a second optical filter passing said second traveling optical signal to said semiconductor optical amplifier, and removing said amplified spontaneous emission (ASE) optical signal from said first traveling optical signal; and
a delay interferometer generating said optical pulse sequence signal from said first traveling optical signal traveling from said semiconductor optical amplifier in said first direction and said second traveling optical signal traveling from said total reflection mirror in said second direction, wherein said delay interferometer has a delay time said n times more than said frequency of said original optical signal.

90. The optical pulse signal expanding apparatus according to claim 85, wherein said first optical pulse signal generating unit comprises:
an optical waveguide in which a traveling optical signal can travel in either direction;
a total reflection mirror provided at one end of said optical waveguide;
an original signal optical combiner synthesizing said light pulse signal as an original optical signal into said optical waveguide;
an optical circulator provided at the other end of said optical waveguide, supplying an external input optical signal to said optical waveguide as a first traveling optical signal traveling in a first direction from said optical circulator to said total reflection mirror, and outputting said optical pulse sequence signal on said optical waveguide as a second traveling optical signal traveling in a second direction from said total reflection mirror to said optical circulator, said optical pulse sequence signal being said first light pulse sequence signal;
a first optical filter passing said first traveling optical signal, and removing an amplified spontaneous emission (ASE) optical signal from said second traveling optical signal to supply to said optical circulator;
a semiconductor optical amplifier emitting an amplified spontaneous emission (ASE) optical signal, and amplifying said first and second traveling optical signals and outputting amplified optical signals including said ASE optical signals into said first and second directions;
a second optical filter passing said second traveling optical signal to said semiconductor optical amplifier, and removing said amplified spontaneous emission (ASE) optical signal from said first traveling optical signal;
a delay interferometer generating said optical pulse sequence signal from said first traveling optical signal traveling from said semiconductor optical amplifier in said first direction and said second traveling optical signal traveling from said total reflection mirror in said second direction, wherein said delay interferometer has a delay time said n times more than said frequency of said original optical signal.

91. The optical pulse signal expanding apparatus according to claim 85, wherein said first optical pulse signal generating unit comprises:
a first optical waveguide in which a traveling optical signal can travel;
a circular optical waveguide in which a circulating optical signal can circulate in a direction;
a semiconductor optical amplifier provided in said first optical waveguide and amplifying an input optical signal traveling in a first direction to said circular optical waveguide to emit a first amplified optical signal including an amplified spontaneous emission (ASE) optical signal, and an output optical signal traveling in a second direction from said circular optical waveguide to emit a second amplified optical signal including an amplified spontaneous emission (ASE) optical signal,
a first optical circulator connected to said first optical waveguide and said circular optical waveguide and outputting said first amplified optical signal to said circular optical waveguide as said circulating optical signal and outputting said circulating optical signal to said first optical waveguide as said output optical signal;
a first delay interferometer provided in said circular optical waveguide and generating an optical pulse signal from said circulating optical signal, wherein said first delay interferometer has a delay time said n times more than said frequency of said original optical signal;
a first optical filter provided in said circular optical waveguide and filtering said optical pulse signal to generate said optical pulse sequence signal as said circulating optical signal;
an original signal optical combiner provided in said circular optical waveguide and synthesizing said light pulse signal as an original optical signal to said circulating optical signal, a second optical waveguide;
a second optical circulator provided in said optical waveguide in said second direction from said semiconductor optical amplifier and connected to said second optical waveguide, wherein said second optical circulator outputs said input optical signal to said semiconductor optical amplifier and said second amplified optical signal to said second optical waveguide; and
a second optical filter provided in said second optical waveguide and filtering said second amplified optical signal to produce said optical pulse sequence signal as said first light pulse sequence signal.

92. The optical pulse signal expanding apparatus according to claim 85, wherein said first optical pulse signal generating unit comprises:
a first optical waveguide in which a traveling optical signal can travel;
a circular optical waveguide in which a circulating optical signal can circulate in a direction;
a semiconductor optical amplifier provided in said first optical waveguide and amplifying an input optical signal traveling in a first direction to said circular optical waveguide to emit a first amplified optical signal including an amplified spontaneous emission (ASE) optical signal, and an output optical signal traveling in a second direction from said circular optical waveguide to emit a second amplified optical signal including an amplified spontaneous emission (ASE) optical signal,
a first optical circulator connected to said first optical waveguide and said circular optical waveguide and outputting said first amplified optical signal to said circular optical waveguide as said circulating optical signal and outputting said circulating optical signal to said first optical waveguide as said output optical signal;
a first delay interferometer provided in said circular optical waveguide and generating an optical pulse signal from said circulating optical signal, wherein said first delay interferometer has a delay time said n times more than said frequency of said original optical signal;
a first optical filter provided in said circular optical waveguide and filtering said optical pulse signal to generate said optical pulse sequence signal as said circulating optical signal;
an original signal optical combiner provided in said circular optical waveguide and synthesizing said light pulse signal as an original optical signal to said circulating optical signal; and
an optical splitter provided in said circular optical waveguide and taking out said optical pulse sequence signal as said first light pulse sequence signal from said circular optical waveguide.

93. The optical pulse signal expanding apparatus according to claim 85, wherein said second optical pulse signal generating unit comprises:
a circular optical waveguide in which a circulating optical signal can circulate in a direction;
a first optical combiner provided in said circular optical waveguide and inputting an externally inputted optical signal to combine said externally inputted optical signal and said circulating optical signal in said circular optical waveguide to produce a combination optical signal;
an original signal optical combiner provided in said circular optical waveguide and synthesizing said first light pulse sequence signal to said circulating optical signal;
an optical converter provided in said circular optical waveguide and having a semiconductor optical amplifier which amplifies said combination optical signal and emits an amplified optical signal including an amplified spontaneous emission (ASE) optical signal, wherein said optical converter outputs an optical pulse sequence signal from said combination optical signal via said amplified optical signal;
a first optical splitter provided outputting said optical pulse sequence signal as said second light pulse sequence signal from said circular optical waveguide,
wherein a portion of said generated optical pulse sequence signal circulates in said circular optical waveguide to reach said first optical combiner, and said generated optical pulse sequence signal finally has a specific pulse width and a specific repetition frequency, and
wherein said optical converter includes said first delay interferometer provided in said circular optical waveguide and generating said optical pulse signal from said amplified optical signal outputted from said semiconductor optical amplifier, and said first delay interferometer has a delay time m times more than said frequency of said original optical signal.

94. The optical pulse signal expanding apparatus according to claim 85, wherein said second optical pulse signal generating unit comprises:
a circular optical waveguide in which a traveling optical signal can circulate in a direction;
a first optical combiner provided in said circular optical waveguide and inputting a first externally inputted optical signal to combine said first externally inputted optical signal and a first optical pulse sequence signal as said traveling optical signal in said circular optical waveguide to produce a first combination optical signal;
an original signal optical combiner provided in said circular optical waveguide and synthesizing said second light pulse sequence signal as an original optical signal into said circulating optical signal;
a first optical converter provided in said circular optical waveguide and converting said first combination optical signal into a second optical pulse sequence signal with a first wavelength;
a first optical splitter provided in said circular optical waveguide and outputting said second optical pulse sequence signal from said circular optical waveguide;
a second optical combiner provided in said circular optical waveguide and synthesizing a second externally inputted optical signal and said second optical pulse sequence signal as said traveling optical signal in said circular optical waveguide to produce a second combination optical signal;
a second optical converter provided in said circular optical waveguide and converting said second combination optical signal into said first optical pulse sequence signal with a second wavelength; and
a second optical splitter provided in said circular optical waveguide and outputting said first optical pulse sequence signal from said circular optical waveguide, one of said first and second optical pulse sequence signal being outputted as said second light pulse sequence signal, and
wherein said first optical converter includes said first delay interferometer provided in said circular optical waveguide and generating said first optical pulse signal from said first amplified optical signal outputted from said first semiconductor optical amplifier,
said first delay interferometer has a delay time said m times more than a frequency of said original optical signal,
said second optical converter includes said second delay interferometer provided in said circular optical waveguide and generating said second optical pulse signal from said second amplified optical signal outputted from said second semiconductor optical amplifier, and
said second delay interferometer has a delay time said m times more than said frequency of said original optical signal.

95. The optical pulse signal expanding apparatus according to claim 85, wherein said second optical pulse signal generating unit comprises:
an optical waveguide in which a traveling optical signal can travel in either direction;
a total reflection mirror provided at one end of said optical waveguide;
an original signal optical combiner synthesizing said second light pulse sequence signal as an original optical signal and an external input optical signal to produce a combination optical signal and outputting said combination optical signal;
an optical circulator provided at the other end of said optical waveguide, supplying said combination optical signal to said optical waveguide as a first traveling optical signal traveling in a first direction from said optical circulator to said total reflection mirror, and outputting said optical pulse sequence signal on said optical waveguide as a second traveling optical signal traveling in a second direction from said total reflection mirror to said optical circulator, said optical pulse sequence signal being said second light pulse sequence signal;
a first optical filter passing said first traveling optical signal, and removing an amplified spontaneous emission (ASE) optical signal from said second traveling optical signal to supply to said optical circulator;
a semiconductor optical amplifier emitting an amplified spontaneous emission (ASE) optical signal, and amplifying said first and second traveling optical signals and outputting amplified optical signals including said ASE optical signals into said first and second directions;
a second optical filter passing said second traveling optical signal to said semiconductor optical amplifier, and removing said amplified spontaneous emission (ASE) optical signal from said first traveling optical signal; and
a delay interferometer generating said optical pulse sequence signal from said first traveling optical signal traveling from said semiconductor optical amplifier in said first direction and said second traveling optical signal traveling from said total reflection mirror in said second direction, wherein said delay interferometer has a delay time said m times more than said frequency of said original optical signal.

96. The optical pulse signal expanding apparatus according to claim 85, wherein said second optical pulse signal generating unit comprises:
an optical waveguide in which a traveling optical signal can travel in either direction;
a total reflection mirror provided at one end of said optical waveguide;
an original signal optical combiner synthesizing said second light pulse sequence signal as an original optical signal into said optical waveguide;
an optical circulator provided at the other end of said optical waveguide, supplying an external input optical signal to said optical waveguide as a first traveling optical signal traveling in a first direction from said optical circulator to said total reflection mirror, and outputting said optical pulse sequence signal on said optical waveguide as a second traveling optical signal traveling in a second direction from said total reflection mirror to said optical circulator, said optical pulse sequence signal being said second light pulse sequence signal;
a first optical filter passing said first traveling optical signal, and removing an amplified spontaneous emission (ASE) optical signal from said second traveling optical signal to supply to said optical circulator;
a semiconductor optical amplifier emitting an amplified spontaneous emission (ASE) optical signal, and amplifying said first and second traveling optical signals and outputting amplified optical signals including said ASE optical signals into said first and second directions;
a second optical filter passing said second traveling optical signal to said semiconductor optical amplifier, and removing said amplified spontaneous emission (ASE) optical signal from said first traveling optical signal;
a delay interferometer generating said optical pulse sequence signal from said first traveling optical signal traveling from said semiconductor optical amplifier in said first direction and said second traveling optical signal traveling from said total reflection mirror in said second direction, wherein said delay interferometer has a delay time said m times more than said frequency of said original optical signal.

97. The optical pulse signal expanding apparatus according to claim 85, wherein said second optical pulse signal generating unit comprises:
a first optical waveguide in which a traveling optical signal can travel;
a circular optical waveguide in which a circulating optical signal can circulate in a direction;
a semiconductor optical amplifier provided in said first optical waveguide and amplifying an input optical signal traveling in a first direction to said circular optical waveguide to emit a first amplified optical signal including an amplified spontaneous emission (ASE) optical signal, and an output optical signal traveling in a second direction from said circular optical waveguide to emit a second amplified optical signal including an amplified spontaneous emission (ASE) optical signal,
a first optical circulator connected to said first optical waveguide and said circular optical waveguide and outputting said first amplified optical signal to said circular optical waveguide as said circulating optical signal and outputting said circulating optical signal to said first optical waveguide as said output optical signal;
a first delay interferometer provided in said circular optical waveguide and generating an optical pulse signal from said circulating optical signal, wherein said first delay interferometer has a delay time said m times more than said frequency of said original optical signal;
a first optical filter provided in said circular optical waveguide and filtering said optical pulse signal to generate said optical pulse sequence signal as said circulating optical signal;
an original signal optical combiner provided in said circular optical waveguide and synthesizing said first light pulse sequence signal as an original optical signal to said circulating optical signal, a second optical waveguide;
a second optical circulator provided in said optical waveguide in said second direction from said semiconductor optical amplifier and connected to said second optical waveguide, wherein said second optical circulator outputs said input optical signal to said semiconductor optical amplifier and said second amplified optical signal to said second optical waveguide; and
a second optical filter provided in said second optical waveguide and filtering said second amplified optical signal to produce said optical pulse sequence signal as said second light pulse sequence signal.

98. The optical pulse signal expanding apparatus according to claim 85, wherein said second optical pulse signal generating unit comprises:
a first optical waveguide in which a traveling optical signal can travel;
a circular optical waveguide in which a circulating optical signal can circulate in a direction;
a semiconductor optical amplifier provided in said first optical waveguide and amplifying an input optical signal traveling in a first direction to said circular optical waveguide to emit a first amplified optical signal including an amplified spontaneous emission (ASE) optical signal, and an output optical signal traveling in a second direction from said circular optical waveguide to emit a second amplified optical signal including an amplified spontaneous emission (ASE) optical signal,
a first optical circulator connected to said first optical waveguide and said circular optical waveguide and outputting said first amplified optical signal to said circular optical waveguide as said circulating optical signal and outputting said circulating optical signal to said first optical waveguide as said output optical signal;
a first delay interferometer provided in said circular optical waveguide and generating an optical pulse signal from said circulating optical signal, wherein said first delay interferometer has a delay time said n times more than said frequency of said original optical signal;
a first optical filter provided in said circular optical waveguide and filtering said optical pulse signal to generate said optical pulse sequence signal as said circulating optical signal;
an original signal optical combiner provided in said circular optical waveguide and synthesizing said first light pulse sequence signal as an original optical signal to said circulating optical signal; and
an optical splitter provided in said circular optical waveguide and taking out said optical pulse sequence signal as said second light pulse sequence signal from said circular optical waveguide.
